(19) United States
(12) Patent Application Publication
(10) Pub. No.: US 2023/0373158 A1
(43) Pub. Date: Nov. 23, 2023

(54) METHOD AND APPARATUS FOR DIGITAL FABRICATION AND STRUCTURE MADE USING THE SAME

(71) Applicant: TRIO LABS, INC., Morrisville, NC (US)

(72) Inventors: Adam T. C. STEEGE, Durham, NC (US); Ken G. PURCHASE, Morrisville, NC (US); Eric Edward ADAMS, Pittsboro, NC (US)

(21) Appl. No.: 18/248,029

(22) PCT Filed: Oct. 8, 2021
(86) PCT No.: PCT/US2021/054293

§ 371 Date: Apr. 5, 2023

Related U.S. Application Data
(63) Continuation-in-part of application No. 17/438,853, filed on Sep. 13, 2021.
(60) Provisional application No. 63/089,405, filed on Oct. 8, 2020.
(60) Provisional application No. 62/817,431, filed on Mar. 12, 2019.

(51) Int. Cl. B29C 64/165; B29C 64/291; B29C 64/393; B29C 64/245; B33Y 10/00; B33Y 50/02

(52) U.S. Cl. CPC B29C 64/165; B29C 64/291; B29C 64/393; B29C 64/245; B33Y 10/00; B33Y 50/02

(57) ABSTRACT

A fabrication device includes a build surface to receive layers of material for production of a 3-dimensional solid representation of a digital model and an imaging component to bind respective portions of the build material into cross sections representative of portions of data contained in the digital model. The device can include a system to recirculate and/or homogenize material prior to use in the fabrication process. The device can include a system for controlling the density of the printed part. An exemplary object made by the fabrication device can include a powder composite component using any of a variety of powder materials. The exemplary object can be further post-processed to produce a high precision metal or ceramic component. The fabrication device can include a selective deposition unit for selectively depositing a supplemental build material at high resolution. The fabrication device can include an imaging unit with extended usage life.

### CROSS-REFERENCE TO RELATED APPLICATIONS

This application claims priority to U.S. provisional patent application, Ser. No. 63/089,405, filed on Oct. 8, 2020. This application is a continuation-in-part of co-pending U.S. patent application Ser. No. 17/438,853, filed on Sep. 13, 2021, which is a national stage application of Patent Cooperation Treaty (PCT) patent application PCT/US2020/021378, filed on Mar. 6, 2020, which claims priority to U.S. provisional patent application, Ser. No. 62/817,431, filed on Mar. 12, 2019. Priority to the provisional and non-provisional patent applications is expressly claimed, and the disclosure of the provisional and non-provisional patent applications is hereby incorporated herein by reference in its entirety and for all purposes.

### TECHNICAL FIELD

The disclosed embodiments relate generally to solid freeform fabrication of objects and more particularly, but not exclusively, to methods and apparatuses for digital fabrication of high density objects using dynamic density control.

### BACKGROUND

Additive manufacturing (AM), also known as solid freeform fabrication (SFF), 3D printing (3DP), direct digital manufacturing (DDM), and solid imaging, has increasingly become a widely adopted method of prototyping both visually demonstrative and functional parts. In some instances, this has become a cost effective means for production manufacturing as well. A wide variety of means for producing components based on digital models exist, and all have reduced the time and cost required for a complete design cycle, which has improved the pace of innovation in many industries.

Generally, SFF is accomplished in a layerwise fashion, where a digital model is split into horizontal slices, and each slice is produced as a 2D image on a build surface. The sequential fabrication of these slices produces an aggregate collection of thin layers which collectively compose the 3 dimensional object represented by the digital model. In contrast to traditional fabrication techniques, such as Computer Numerically Controlled (CNC) machining, injection molding, and other means, SFF has markedly reduced production time and cost, and as such has been widely adopted for research and development purposes where low volume production with traditional means would be exceedingly expensive. Additionally, SFF devices generally require less expertise to operate when compared to CNC machines. The cost of individual parts produced from CNC machines is generally higher, owing to longer setup times and higher costs of machine operation. CNC-produced parts will often have stronger and more detailed features than SFF-produced parts, which may make them desirable for some applications. Until SFF techniques can produce parts with the resolution and functionality of CNC-produced parts, the usage of SFF in part production will remain constrained.

Powder Injection Molding (PIM) is a mass production technique which has been widely adopted as a means of producing high precision components in materials which would not traditionally be possible with other molding methods. A powder is blended with a resin binder to form an injection feedstock, which is injected into a mold, similar to plastic injection molding. The part produced is a powder composite part, called a “green” part. The green part is subjected to a process called debinding, in which most of the binder is removed. The resulting part is called a “brown” part. This brown part is then subjected to thermal treatment to cause the powder particles to sinter together. The part shrinks during this process, and voids between the powder particles are removed. They final result is a part with near full density. Further post-processing may be utilized to achieve over 99.5% density, depending on the composition of the powder feedstock that was utilized.

Some of the most common techniques for SFF include stereolithography (SLA), selective deposition modeling (SDM), fused deposition modeling (FDM), and selective laser sintering (SLS). These approaches vary in the type of materials they can use, the manner in which layers are created, and the subsequent resolution and quality of parts produced. Typically, layers are produced in a bulk material deposition method, or in a selective material deposition method. In techniques that employ a bulk deposition method for layer production, layer imaging is typically accomplished by a thermal, chemical, or an optical process. There is one technology, binder jetting, which utilizes inkjet print heads to deposit binder into a powder bed to produce a part similar to the previously described green part in a PIM process. This green part can be post-processed in the same manner to produce a final component. Unfortunately, due to imperfections in the process of producing the green part, the final components produced through this process often fail to meet tolerances for high precision applications, particularly when it comes to surface finish. Additionally, the precision and speed of the binder jetting process is limited.

The limitation of existing techniques for SFF poses restrictions on the structures that can be made via SFF. Some microscale medical devices cannot be made with SFF in a cost-effective manner, or cannot be made with SFF at all. Further, improvement of existing medical devices cannot be made because fabrication techniques are not available to implement those improvements.

### SUMMARY

In accordance with a first aspect disclosed herein, there is set forth a method for making a three-dimensional object, including:
homogenizing a build material including a blend of a powder material and a photopolymer resin;
depositing the build material on a build platform; and
selectively processing the build material to form the three-dimensional object.

In some embodiments of the disclosed method, the homogenizing is during the depositing, within a settling time prior to the depositing, or a combination thereof.

In some embodiments of the disclosed method, the selectively processing includes at least partially curing at least a portion of the build material via irradiation.

In some embodiments of the disclosed method, the build material is densified after being deposited on the build platform.

In some embodiments of the disclosed method, the build material is densified by removing at least part of the photopolymer resin via differential pressure.

In some embodiments of the disclosed method, the depositing includes using a slot die to produce one of more layers of the build material.

In some embodiments of the disclosed method, the slot die is modified to increase uniformity of one layer of the layers over a wider range of deviations in layer flatness of a previously-deposited layer of the layers.

In some embodiments of the disclosed method, modifying of the slot die includes enlarging a stable bead region of the slot die.

In some embodiments of the disclosed method, the depositing includes producing a layer of the build material;
the selectively processing includes at least partially curing at least a portion of
the build material via irradiation, wherein the build material includes a photosensitive component that changes state under the irradiation; and
repeating the depositing and the selectively processing to form the three-dimensional object.

In some embodiments of the disclosed method, the state change includes a color change that is detected to validate the curing.

In accordance with another aspect disclosed herein, there is set forth method for making a three-dimensional object, including:
depositing a build material on a build platform;
densifying the build material; and
selectively processing the build material to form the three-dimensional object.

In some embodiments of the disclosed method, said depositing includes depositing a layer of the build material on the build platform;
the densifying includes densifying the layer of the build material;
the selectively processing includes selectively processing the layer of the build material; and
the method further includes repeating the depositing, the densifying, and the selectively processing of one or more layers of the build material stacked on the layer to form the three-dimensional object.

In some embodiments of the disclosed method, the build material includes a blend of a powder material and a carrier fluid.

In some embodiments of the disclosed method, the depositing includes depositing the build material via slot die coating.

In some embodiments of the disclosed method, the depositing includes depositing the build material via blade coating.

In some embodiments of the disclosed method, the depositing includes depositing the build material via patch coating.

In some embodiments of the disclosed method, the densifying includes increasing a loading density of the powder material in the build material.

In some embodiments of the disclosed method, the densifying includes removing at least a portion of the carrier fluid from the build material.

In some embodiments of the disclosed method, the removing includes suctioning at least the portion of the carrier fluid from the build material via the build platform.

In some embodiments of the disclosed method, the removing includes removing at least the portion of the carrier fluid from the build material via applying ultrasound to the build platform.

In some embodiments of the disclosed method, the removing includes thermally evaporating at least the portion of the carrier fluid from the build material.

In some embodiments of the disclosed method, the carrier fluid includes a filler material and a backbone material, wherein the removing includes removing at least a portion of only the filler material.

In some embodiments of the disclosed method, removing includes removing at least the portion of the filler material via evaporation.

In some embodiments of the disclosed method, the method further including, before the selectively processing, settling the powder material via applying ultrasound to the build platform.

In some embodiments of the disclosed method, the build material includes a foam defining a plurality of bubbles therein.

In some embodiments of the disclosed method, the densifying includes collapsing at least some of the bubbles in the foam.

In some embodiments of the disclosed method, the collapsing includes applying suction to the build material via the build platform.

In some embodiments of the disclosed method, the collapsing includes applying ultrasound agitation to the build material.

In some embodiments of the disclosed method, the collapsing includes applying heat to the build material.

In some embodiments of the disclosed method, the densifying includes applying a densification fluid to the build material, the densification fluid reacting with the carrier fluid to produce a gas product and reducing a fluid volume in the build material.

In some embodiments of the disclosed method, the carrier fluid includes a photopolymer resin and the selectively processing includes at least partially curing at least a portion of the build material via irradiation.

In some embodiments of the disclosed method, the at least partially curing includes irradiating the build material in accordance with a two-dimensional slice of a digital model of the three-dimensional object.

In some embodiments of the disclosed method, the selectively processing includes depositing a supplemental build material on at least one target area of the build material.

In some embodiments of the disclosed method, the densifying includes densifying the build material such that the build material remains substantially wet after densification.

In some embodiments of the disclosed method, the densifying includes densifying the build material such that the build material defines a plurality of voids therein and the powder material remains wet after densification.

In some embodiments of the disclosed method, the supplemental build material is adapted to enable a curing reaction, solidification reaction, or a combination thereof, for binding the powder material at the target area.

In some embodiments of the disclosed method, the target area is in accordance with a two-dimensional slice of a digital model of the three-dimensional object.

In some embodiments of the disclosed method, the supplemental build material is adapted to enable a photocuring reaction for binding the powder material at the target area.

In some embodiments of the disclosed method, the selectively processing includes irradiating the build material in a non-selective manner.

In some embodiments of the disclosed method, the supplemental build material includes a photocurable resin.

In some embodiments of the disclosed method, the supplemental build material and the carrier fluid collectively provide a photocurable resin including a backbone resin and a photoinitiator.

In some embodiments of the disclosed method, the supplemental build material is adapted to enable a thermal curing reaction for binding the powder material at the target area.

In some embodiments of the disclosed method, the selectively processing includes heating the build material in a non-selective manner.

In some embodiments of the disclosed method, the supplemental build material includes a thermally curable resin.

In some embodiments of the disclosed method, the supplemental build material and the carrier fluid collectively provide a thermally curable resin including a backbone resin and a thermal initiator.

In some embodiments of the disclosed method, the supplemental build material is adapted to enable a passive curing reaction for binding the powder material at the target area.

In some embodiments of the disclosed method, the supplemental build material includes a passively-curable resin.

In some embodiments of the disclosed method, the supplemental build material and the carrier fluid collectively provide a passively-curable resin including a backbone resin and a thermal initiator.

In some embodiments of the disclosed method, the supplemental build material includes a wax that is molten during deposition and solidifies upon cooling at least via heat absorption by the carrier fluid.

In some embodiments of the disclosed method, the supplemental build material includes a monomer that is molten during deposition and cures upon deposition via photocuring, thermal curing, passive curing, or a combination thereof.

In some embodiments of the disclosed method, the supplemental build material is adapted to inhibit a curing reaction and the carrier fluid includes a curable material.

In some embodiments of the disclosed method, the target area is in accordance with a complementary image of a two-dimensional slice of a digital model of the three-dimensional object.

In some embodiments of the disclosed method, the supplemental build material is adapted to inhibit a photocuring reaction, and the carrier fluid includes a photocurable material.

In some embodiments of the disclosed method, the selectively processing includes irradiating the build material in a non-selective manner.

In some embodiments of the disclosed method, the supplemental build material includes a sintering inhibitor and the method further includes sintering the powder material after the selectively processing.

In some embodiments of the disclosed method, the target area is in accordance with a two-dimensional slice of a digital model of a support surface layer that is between the three-dimensional object and a support structure.

In accordance with another aspect disclosed herein, there is set forth a system for making a three-dimensional object, including means for executing the disclosed method.

In accordance with another aspect disclosed herein, there is set forth an apparatus for making a three-dimensional object, including:
a build platform;
a deposition module configured to translate across the build platform and deposit a layer of a build material on the build platform or a previously deposited layer;
a material delivery unit in communication with the deposition module; and
a reservoir for containing the build material and in communication with the material delivery unit, the material delivery unit being configured to homogenize the build material in the reservoir, to feed the build material from the reservoir to the deposition module, or a combination thereof; and
a projection module for at least partially curing at least a portion of the deposited layer, to define one layer of the three-dimensional object.

In some embodiments of the disclosed apparatus, the material delivery unit includes at least one circulation pump for feeding the build material from the reservoir to the deposition module.

In some embodiments of the disclosed apparatus, the material delivery unit includes one or more homogenization pumps for continuously homogenizing the build material in the reservoir.

In some embodiments of the disclosed apparatus, the build platform and the reservoir are positioned such that the reservoir receives the build material exiting from the deposition module, the build material draining from sides of the build platform, or a combination thereof.

In some embodiments of the disclosed apparatus, the build platform includes a build platform working surface defining a plurality of pores.

In some embodiments of the disclosed apparatus, the build material includes a blend of a powder material and a photopolymer resin, the photopolymer resin of the deposited layer of the build material being at least partially removed via the plurality of pores such that the layer is densified.

In accordance with another aspect disclosed herein, there is set forth a method for making a solid freeform fabrication system, including:
establishing a build platform;
constructing a build material unit for depositing a build material to the build platform; and
building a selective processing unit for selectively processing the build material to form a three-dimensional object.

In some embodiments of the disclosed method,
the build material unit is configured to deposit a layer of the build material on the build platform and densify the layer of the build material;
the selective processing unit is configured to selectively process the layer of the build material; and
the build material unit and the selective processing unit are configured to collectively and repeatedly perform depositing, densifying, and selectively processing of one or more layers of the build material stacked on the layer to form the three-dimensional object.

In some embodiments of the disclosed method, the build material includes a blend of a powder material and a carrier fluid.

In some embodiments of the disclosed method, the build material unit is coupled with the build platform and configured to remove at least a portion of the carrier fluid from the build material via the build platform.

In some embodiments of the disclosed method, the carrier fluid includes a photopolymer resin and the selectively processing unit is configured to at least partially cure at least a portion of the build material via irradiation.

In accordance with another aspect disclosed herein, there is set forth a system for making a solid freeform fabrication system, including means for executing the disclosed method.

In accordance with another aspect disclosed herein, there is set forth an apparatus for irradiating an image onto an imaging surface with high resolution, including:
an array of illumination source groups aligned in a scan direction,
   each illumination source group including an array of illumination source subsets aligned in a cross-scan direction,
   each illumination source subset including a plurality of illumination sources,
   the illumination sources within each illumination source subset being distributed in the scan direction and being shifted in the cross-scan direction by an offset distance that is greater than zero and no greater than a width of each illumination source in the cross-scan direction; and
projection optics located between the array of illumination source groups and the imaging surface and configured to project irradiation from the array of illumination source groups on the imaging surface,
the imaging surface defining an array of pixel areas thereon, each pixel area including an array of images each being imaged by at least one of the illumination sources,
the irradiation being translated in the scan direction such that the array of illumination source groups images the pixel areas, with each pixel area being entirely imaged at least by one of the illumination source subsets.

In some embodiments of the disclosed apparatus, a number of the pixel areas in the cross-scan direction is no greater than a number of the illumination source subsets in each illumination source group.

In some embodiments of the disclosed apparatus, the offset distance is equal to the width of each illumination source in the cross-scan direction.

In some embodiments of the disclosed apparatus, the offset distance is smaller than the width of each illumination source in the cross-scan direction.

In some embodiments of the disclosed apparatus, the array of illumination source groups is integrated on a micro-light-emitting-diode (microLED) chip, each illumination source including a microLED.

In some embodiments of the disclosed apparatus, the microLED chip and the projection optics simultaneously translate in the scan direction relative to the imaging surface.

In some embodiments of the disclosed apparatus, the microLED chip translates in the scan direction relative to the imaging surface and the projection optics is static relative to the imaging surface.

In some embodiments of the disclosed apparatus, the apparatus further comprising at least one refractive element configured to rotate about an axis parallel to the cross-scan direction and located between the imaging surface and the microLED chip, the refractive element being configured to translate the irradiation from the microLED chip in the scan direction.

In some embodiments of the disclosed apparatus, a selected illumination source subset includes a faulty illumination source, and an area of the imaging surface corresponding to the faulty illumination source is imaged by a non-faulty illumination source in another illumination source subset aligned with the selected illumination source subsets in the scan direction.

In accordance with another aspect disclosed herein, there is set forth a system for making a three-dimensional object, comprising:
a build material unit for depositing one or more layers of a photocurable material; and the disclosed apparatus for curing each of the layers in accordance with a slice of a digital model of the three-dimensional object.

In accordance with another aspect disclosed herein, there is set forth a method for curing a photocurable material, comprising:
irradiating the photocurable material with an array of illumination source groups aligned in a scan direction,
each illumination source group including an array of illumination source subsets aligned in a cross-scan direction,
each illumination source subset including a plurality of illumination sources,
the illumination sources within each illumination source subset being distributed in the scan direction and being shifted in the cross-scan direction by an offset distance that is greater than zero and no greater than a width of each illumination source in the cross-scan direction; and
the photocurable material defining an array of pixel areas thereon, each pixel area including an array of images each being imaged by at least one of the illumination sources; and
translating irradiation from the array of illumination source groups in the scan direction such that the array of illumination source groups images the pixel areas, with each pixel area being entirely imaged at least by one of the illumination source subsets.

In accordance with another aspect disclosed herein, there is set forth a needle for entering skin of a biological body, comprising a tip section that is porous.

In some embodiments of the disclosed needle, the tip section does not define a lumen passing through the tip section.

In some embodiments of the disclosed needle, the tip section defines a plurality of pores therein and one or more passages among the pores for a fluid to flow through the tip section.

In some embodiments of the disclosed needle, the tip section defines a plurality of pores of a size smaller than a size of a solid component of blood, such that the solid component does not pass the pores.

In some embodiments of the disclosed needle, the plurality of pores each has a diameter between 100 nanometers and 10 microns.

In accordance with another aspect disclosed herein, there is set forth a microneedle for entering skin of a biological body, comprising a tip section defining one or more pores opening in a direction perpendicular to an insertion direction of the needle during operation.

In some embodiments of the disclosed needle, each of the pores has a diameter between 100 nanometers and 50 microns, the needle is shorter than 3 mm. and the tip section has a length ranging from 10 microns to 250 microns and has a tip radius no larger than 10 microns.

In accordance with another aspect disclosed herein, there is set forth an apparatus for making a three-dimensional object, comprising:
a build platform;
a deposition module configured to deposit a plurality of layers of a build material on the build platform or previous deposited layers;
a selective processing unit for modifying at least a portion of at least some of the deposited layers, to define the three-dimensional object,
wherein the build material includes a blend of a powder material and a liquid component, the liquid component of the build material being at least partially removed from the deposited layer such that the layer is densified.

In some embodiments of the disclosed apparatus, the liquid component includes a photopolymer resin.

In some embodiments of the disclosed apparatus, the selective processing unit is configured to irradiate the photopolymer resin.

In accordance with another aspect disclosed herein, there is set forth an apparatus for making a three-dimensional object, comprising:
a build platform;
a deposition module configured to deposit a plurality of layers of a build material on the build platform or previous deposited layers;
a selective processing unit for modifying at least a portion of at least some of the deposited layers, to define the three-dimensional object,
wherein the build platform defines a build platform working surface defining a plurality of pores,
wherein the build material includes a blend of a powder material and a liquid component, the liquid component of the build material being at least partially removed from the deposited layer via the plurality of pores such that the layer is densified.

In some embodiments of the disclosed apparatus, the liquid component includes a photopolymer resin.

In some embodiments of the disclosed apparatus, the selective processing unit is configured to irradiate the photopolymer resin.

In accordance with another aspect disclosed herein, there is set forth a method for making a three-dimensional object, comprising:
making at least one part and a part tray respectively using the disclosed method;
sintering the part tray, a geometry of the sintered part tray being complementary to a geometry of the part that is before sintering;
loading the part into the part tray; and
sintering the part in the part tray.

In some embodiments of the disclosed method, the loading includes loading the part into the part tray via vacuum suction applied through the part tray.

In some embodiments of the disclosed method, the sintering the part tray includes sintering the part tray such that the sintered part tray is porous and define pores having a size smaller than a size of each of the at least one part, the vacuum suction being applied through the pores.

In some embodiments of the disclosed method,
the making includes making a plurality of parts; and
the loading includes loading the plurality of parts into the part tray simultaneously.

In accordance with another aspect disclosed herein, there is set forth a method for making a three-dimensional object, comprising:
making a tool and a part respectively using the disclosed method; and
modifying a geometry of the part using the tool.

In some embodiments of the disclosed method, the modifying includes:
submerging the tool and the part in an electrolytic solution; and
applying an electric current across the tool and the part to remove at least a portion of material from the part.

In some embodiments of the disclosed method, the making the tool includes determining, in a digital model, a geometry of the tool as complementary to one or more surfaces of a targeted geometry for the part to determine required surfaces of the tool for imparting the targeted geometry to the part.

In some embodiments of the disclosed method, the tool is porous.

In some embodiments of the disclosed method, the making the tool includes controlling a porosity of the tool via controlling a sintering temperature of the tool.

In some embodiments of the disclosed method, the tool defines pores of a size such that a geometry of the pores is not imparted to the part via the modifying, and such that the electrolytic solution flows via at least some of the pores during the modifying.

In accordance with another aspect disclosed herein, there is set forth a method for making a three-dimensional object, comprising:
making at least one part and a part tray respectively using solid freeform fabrication;
sintering the part tray, a geometry of the sintered part tray being complementary to a geometry of the part that is before sintering;
loading the part into the part tray; and
sintering the part in the part tray.

In some embodiments of the disclosed method, the loading includes loading the part into the part tray via vacuum suction applied through the part tray.

In some embodiments of the disclosed method, the sintering the part tray includes sintering the part tray such that the sintered part tray is porous and define pores having a size smaller than a size of each of the at least one part, the vacuum suction being applied through the pores.

In some embodiments of the disclosed method,
the making includes making a plurality of parts; and
the loading includes loading the plurality of parts into the part tray simultaneously.

In accordance with another aspect disclosed herein, there is set forth a method for making a three-dimensional object, comprising:
making a tool and a part each using solid freeform fabrication; and
modifying a geometry of the part using the tool.

In some embodiments of the disclosed method, the modifying includes:
submerging the tool and the part in an electrolytic solution; and
applying an electric current across the tool and the part to remove at least a portion of material from the part.

In some embodiments of the disclosed method, the making the tool includes determining, in a digital model, a geometry of the tool as complementary to one or more surfaces of a targeted geometry for the part to determine required surfaces of the tool for imparting the targeted geometry to the part.

In some embodiments of the disclosed method, the tool is porous.

In some embodiments of the disclosed method, the making the tool includes controlling a porosity of the tool via controlling a sintering temperature of the tool.

In some embodiments of the disclosed method, the tool defines pores of a size such that a geometry of the pores is not imparted to the part via the modifying, and such that the electrolytic solution flows via at least some of the pores during the modifying.

Further features of the subject invention will become more readily apparent from the following detailed description of the invention taken in conjunction with the accompanying drawings.

### BRIEF DESCRIPTION OF THE DRAWINGS

Preferred embodiments of the subject invention will be described hereinbelow with reference to the drawings, wherein

FIG. 1 is an elevated right perspective view of a machine for solid freeform fabrication according to an embodiment of the presently disclosed subject matter.

FIG. 2 is an elevated left perspective view of the machine in FIG. 1.

FIG. 3 is a sectional view of the machine in FIG. 1.

FIG. 4 is a sectional view of the machine in FIG. 2.

FIG. 5 is an elevated perspective view of a material deposition system as used in the machine in FIG. 1.

FIG. 6 is a sectional view of the material deposition system in FIG. 5.

FIG. 7 is a sectional view of a portion of the material deposition system in FIG. 5 in a first configuration.

FIG. 8 is a sectional view of a portion of the material deposition system in FIG. 5 in a second configuration.

FIG. 9 is a sectional view of a portion of the material deposition system in FIG. 5 in a third configuration.

FIG. 10 is a sectional view of a portion of the material deposition system in FIG. 5 in a fourth configuration.

FIG. 11 is a perspective view from below of a first pumping system from the machine in FIG. 1.

FIG. 12 is a perspective view from below of a second pumping system from the machine in FIG. 1.

FIG. 13 is a schematic representation of a first step of a materials handling process that may be used by the machine in FIG. 1.

FIG. 14 is a schematic representation of a second step of a materials handling process that may be used by the machine in FIG. 1.

FIG. 15 is a schematic representation of a third step of a materials handling process that may be used by the machine in FIG. 1.

FIG. 16 is an elevated perspective view of an implementation of a build platform as used in the machine in FIG. 1.

FIG. 17 is a sectional view of the build platform in FIG. 16.

FIG. 18 is an elevated perspective view of the build platform in FIG. 16 with a partially completed build.

FIG. 19 is an elevated perspective view of the build platform in FIG. 16 with a completed build.

FIG. 20 is an elevated perspective view of a first configuration of a system for treating a finished build on the build platform in FIG. 16.

FIG. 21 is a sectional view of the system in FIG. 20.

FIG. 22 is an elevated perspective view of the top section of the build platform in FIG. 16 with a completed build.

FIG. 23 is an elevated perspective view of the top section of the build platform in FIG. 16 with a completed build after the completion of a process for removing excess material.

FIG. 24 is a perspective view from below of a first configuration of a system for removing a batch of printed parts for sintering.

FIG. 25 is a perspective view from below of a second configuration of a system for removing a batch of printed parts for sintering.

FIG. 26 is a sectional view of the system in FIG. 25.

FIG. 27 is a schematic representation of a first step in a part finishing process that may utilize parts and/or tooling produced by the machine in FIG. 1.

FIG. 28 is a schematic representation of a second step in a part finishing process that may utilize parts and/or tooling produced by the machine in FIG. 1.

FIG. 29 is a schematic representation of a third step in a part finishing process that may utilize parts and/or tooling produced by the machine in FIG. 1.

FIG. 30 is an exemplary diagram illustrating a system for solid freeform fabrication of an object.

FIG. 31 is an exemplary top-level flow chart illustrating an embodiment of a method for solid freeform fabrication based on the system of FIG. 30.

FIG. 32 is an exemplary diagram illustrating an alternative embodiment of the system of FIG. 30, wherein object includes one or more layers.

FIG. 33 is an exemplary flow chart illustrating an embodiment of a method for solid freeform fabrication based on the system of FIG. 32.

FIG. 34 is an exemplary flow chart illustrating an alternative embodiment of the method for solid freeform fabrication based on the system of FIG. 32, wherein the method includes densifying build material.

FIGS. 35A and 35B are exemplary diagrams illustrating another alternative embodiment of the system of FIG. 32, wherein build material before and after applying an ultrasound unit is shown, respectively.

FIGS. 36A and 36B are exemplary diagrams illustrating another alternative embodiment of the system of FIG. 32, wherein build material before and after applying an ultrasound unit is shown, respectively, and wherein the ultrasound unit settles powder.

FIG. 37 is an exemplary diagram illustrating yet another alternative embodiment of the system of FIG. 32, wherein the system includes an evaporation unit.

FIGS. 38A-38C are exemplary diagrams illustrating an exemplary process of densifying build material in the system of FIG. 32.

FIGS. 39A and 39B are exemplary diagrams illustrating another alternative embodiment of the system of FIG. 32, wherein build material before and after applying a densification fluid is shown, respectively.

FIG. 40 is an exemplary flow chart illustrating an alternative embodiment of the method for solid freeform fabrication based on the system of FIG. 30, wherein the method is based upon irradiation.

FIG. 41 is an exemplary diagram illustrating yet another alternative embodiment of the system of FIG. 32, wherein the system includes a selective deposition unit.

FIGS. 42A and 42B are exemplary diagrams illustrating the system of FIG. 41, wherein deposition of a supplemental build material on dry and wet powder is shown, respectively.

FIG. 43 is an exemplary flow chart illustrating another alternative embodiment of the method for solid freeform fabrication based on the system of FIG. 30, wherein the method includes depositing a supplemental build material.

FIG. 44 is an exemplary diagram illustrating an alternative embodiment of the system of FIG. 41, wherein the object forms based upon a target area.

FIG. 45 is an exemplary diagram illustrating another alternative embodiment of the system of FIG. 41, wherein the object forms based upon a non-target area.

FIG. 46 is an exemplary diagram illustrating yet another alternative embodiment of the system of FIG. 41, wherein the object forms based upon a support surface layer.

FIGS. 47-56 are various detail drawings illustrating an embodiment of the system of FIG. 41.

FIG. 57 is an exemplary diagram illustrating an embodiment of a fabrication system, wherein the system includes an imaging unit.

FIG. 58 is an exemplary diagram illustrating an embodiment of the imaging unit of FIG. 57, wherein the imaging unit includes a plurality of illumination source groups.

FIG. 59 is an exemplary diagram illustrating image groups produced by the imaging unit of FIG. 58.

FIG. 60 is an exemplary diagram illustrating a pixel area produced by the imaging unit of FIG. 58.

FIG. 61 is an exemplary diagram illustrating an alternative embodiment of the imaging unit of FIG. 57, wherein the imaging unit includes a plurality of illumination source groups, wherein a size of the illumination source is different between FIG. 61 and FIG. 58.

FIG. 62 is an exemplary diagram illustrating image groups produced by the imaging unit of FIG. 58.

FIG. 63 is an exemplary diagram illustrating a pixel area produced by the imaging unit of FIG. 58.

FIG. 64 is an exemplary diagram illustrating an array of images produced by another alternative embodiment of the imaging unit of FIG. 57.

FIG. 65 is an exemplary diagram illustrating an array of images produced by yet another alternative embodiment of the imaging unit of FIG. 57, wherein a size of the image is different between FIG. 65 and FIG. 64.

FIGS. 66-70 are exemplary diagrams illustrating various embodiments of the system of FIG. 57.

FIG. 71 is an exemplary diagram illustrating an embodiment of a part made by the system of FIG. 30.

FIG. 72 is an exemplary diagram illustrating an alternative embodiment of the part of FIG. 71, wherein the part defines pores therein.

FIG. 73 is an exemplary diagram illustrating another alternative embodiment of the part of FIG. 71, wherein the part defines pores in a tip section.

FIG. 74 is an exemplary diagram illustrating an embodiment of a part made by the system of FIG. 30, wherein the part is configured to enter a blood vessel.

FIG. 75 is an exemplary diagram illustrating an alternative embodiment of the part of FIG. 74, wherein the part defines pores in a tip section.

FIG. 76 is an exemplary diagram illustrating an embodiment of a part made by the system of FIG. 30, wherein the part defines one or more pores oriented in a lateral direction.

FIG. 77 is an exemplary diagram illustrating an embodiment of a microneedle array made by the system of FIG. 30.

FIG. 78 is an exemplary diagram illustrating an embodiment of a control system for controlling the system of FIG. 30.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Embodiments described herein generally relate to devices and methods for the solid freeform fabrication of objects from a great variety of materials. Exemplary materials can include materials such as metal, plastic, ceramic, and/or composite materials comprising combinations of one or more types of material.

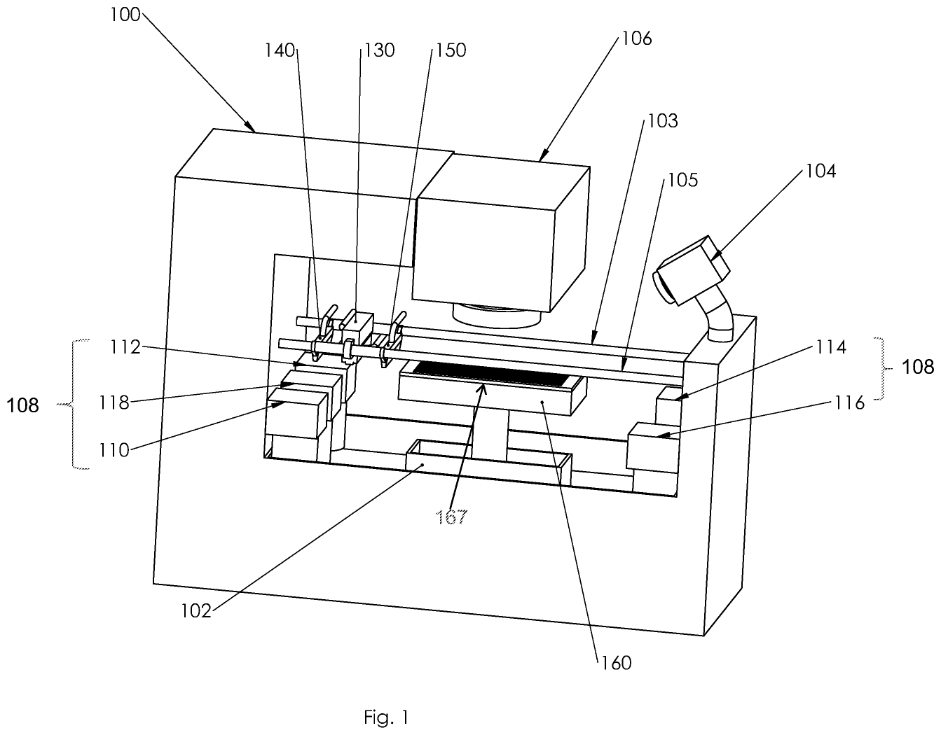

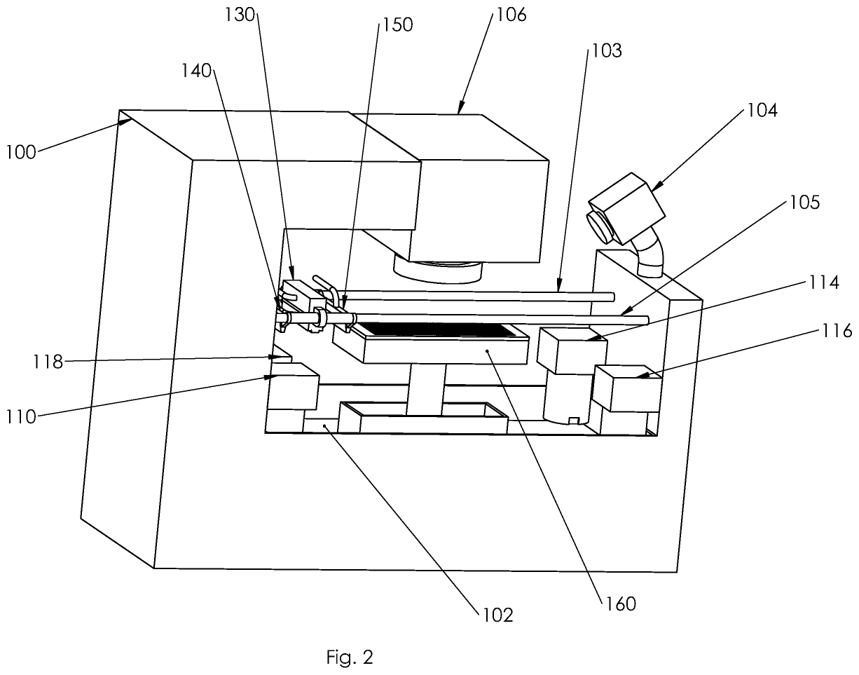

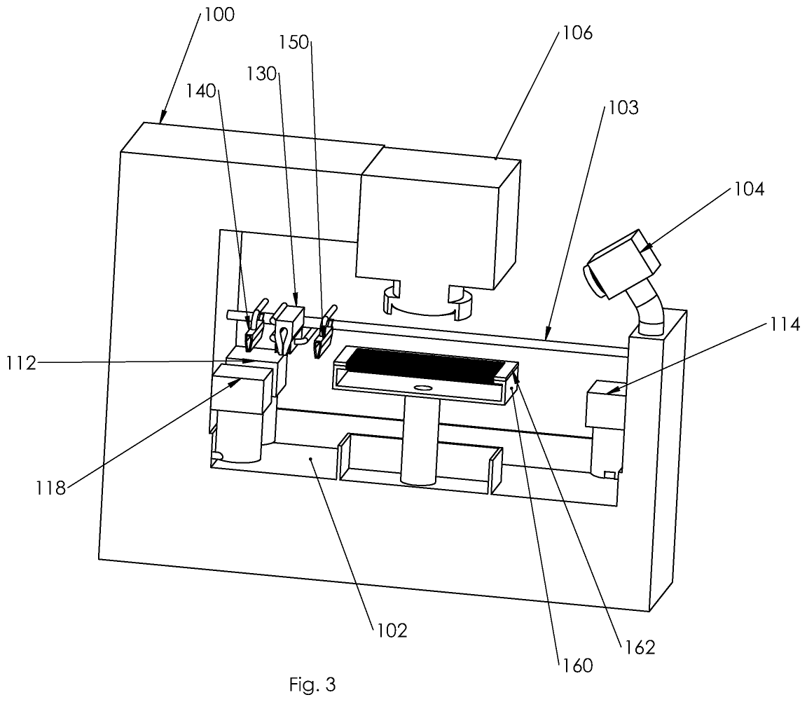

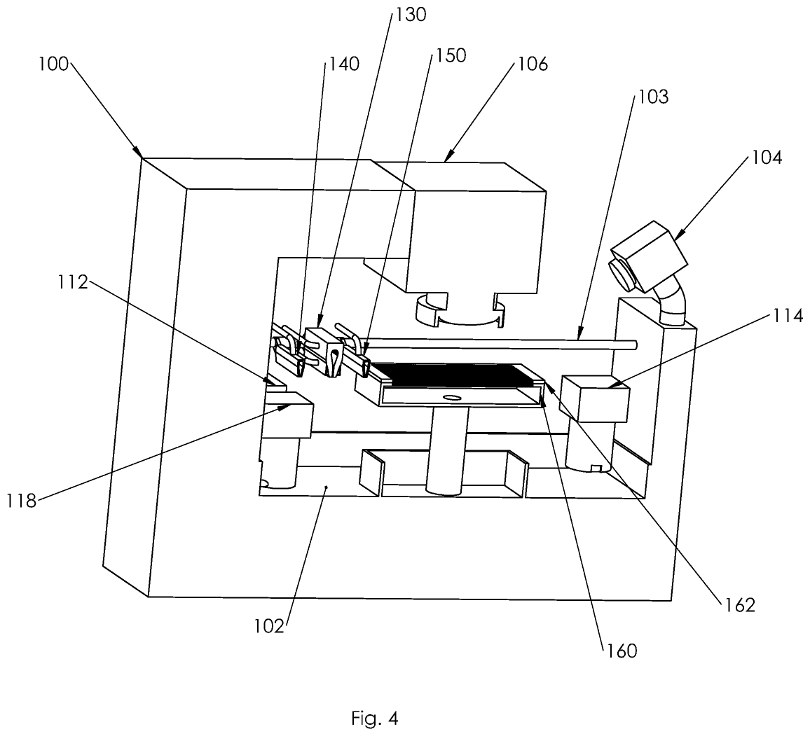

Stereolithography (SLA) fabrication utilizes photopolymer resin and a polymerizing source of radiation to produce three dimensional objects. Some approaches have been developed to use a slurry feedstock to produce powder composite parts which may then be further processed to produce solid metal or ceramic components. Many of these approaches have inherent design tradeoffs between speed and part quality. FIGS. 1-4 show a system (100) designed to overcome these restrictions.

This system can be used to process any mixture of photopolymer resin and powder. In some embodiments, the mixture can be in the form of a slurry. In some cases, a powder composite component may be produced by this method which is then post-processed to remove the polymer binder and to sinter the powder material into a solid component. The powder material can be metal or ceramic or any combination of sinterable material(s).

In an exemplary embodiment, this system includes a material deposition system (130) and, optionally, one or more air blades (140,150) for depositing material and controlling where on the build platform working surface (162) material is allowed to accumulate. In various embodiments, processes as set forth in the disclosure can be performed on an active working surface (167). The active working surface (167) can include a surface to which material is being or will be deposited. In some embodiments, the active working surface (167) can include the build platform working surface (162), for example, during deposition of the first layer. Additionally and/or alternatively, the active working surface (167) can include the outermost deposited layer, for example, when each subsequent layer after the first layer is deposited. In some embodiments, the deposition system (130) may be mounted on linear guides (103,105) to allow for linear translation of the deposition system (130) across the build platform working surface (162). In general, it is understood that any system which achieves motion of the deposition system (130) relative to the build platform working surface (162) such that material is deposited on the active working surface (167) is considered within the scope of the presently disclosed subject matter. After material is deposited, a projection module (106) is used to at least partially cure at least a portion of the deposited layer, to define one layer of a printed part or array of printed parts. This layer image may be obtained by calculated the intersection of a horizontal plane and a three-dimensional digital representation of an object. Additionally, this image may be modified to have a lattice structure, or have other support features added, including but not limited to, non-contact support features, wherein said support features are designed in the layer image(s) with a gap separating the support features from the parts being printed, as will be described in more detail in subsequent figures. It may be sufficient to utilize generally accepted methods for generating layer images, or it may be necessary to include any combination of the previously listed modifications. This process is repeated until the build is complete.

The process may be monitored by a camera (104) which may provide data for feedback in a configuration utilizing closed loop control and/or may provide data for quality control purposes. In particular, for certain photopolymer resin formulations, a color change may be observed during the curing process to control and/or validate the completeness of the curing process. For example, some resin formulations containing phosphine-based photoinitiators may convert from a transparent or light translucent yellow color to a darker yellow color during curing. In this instance, the build area may be illuminated with a particular wavelength of light that corresponds to a change in absorption by the resin during curing. The emergent light from the build area may be imaged with a camera (104) and the brightness of this wavelength measured in the camera image may be used to validate the curing process. In some embodiments, a brightness level may be measured by control software using data from the camera to determine the degree of curing that has occurred. In a control configuration, this may be used to determine when to stop the curing process after a threshold value of brightness is observed by the camera and detected by the control software. In an alternate embodiment, a brightness level may be measured and stored as quality control data. Additional metadata may be added to indicate whether this level exceeded a pre-determined minimum value to confirm that adequate curing has occurred. Further, a range of acceptable values may be compared to the brightness level observed by the camera and measured by control software to determine if the layer has been adequately cured but not over-cured.

When using the slurry of photopolymer resin and powder as a feedstock, it may be useful to homogenize the material, such as by means including but not limited to circulating, agitating, and/or stirring this material to limit the degree to which the powder material can settle out of the slurry and/or form agglomerates which can compromise the quality of a layer of material or of a printed part or array of parts as a whole. While the use of dispersed powders in slurries is common in industry, it is worth noting that many slurries use nanoparticles which may be incorporated into a stable suspension which does not require constant homogenization to maintain material quality and uniformity. In many cases of additive manufacturing, larger (for example, with diameter ranging from 0.5 micron to 50 microns) and denser particles (for example, metals and/or ceramic) may be used, which makes it much more difficult to create a stable suspension. Exemplary particles used in various embodiments can range from 1.5 grams per cubic centimeter (g/cm³) to 20 g/cm³ or from 1.5 g/cm³ to 25 g/cm³. In a suspension there may be a settling time that represents the time (for example, 30 seconds) from when a homogenization process stops until the slurry or suspension is no longer homogenized enough to be dispensed to form a layer of acceptable quality. By continuously homogenizing the slurry during the build process, higher quality and more repeatable results can be achieved than if all suspensions were only pre-mixed. In various embodiments, the settling time of the disclosed processes can be significantly shorter than the time to settle for many existing slurries that use nanoparticles. Exemplary settling time can range from 1 second to 5 minutes, and that makes homogenization necessary for some practical fabrication processes as disclosed. The specific settling time can depend on the size and/or density of particles and property of the fluid (such as viscosity). For example, the settling time can be shorter when the fluid viscosity is lower and can be longer when the fluid viscosity is higher. For example, the settling time for a metal material in a low viscosity fluid can be 2 seconds. In another example, settling time for various types of metal materials can be 10 seconds, 30 seconds, or 5 minutes, respectively. In another example, the settling time for a ceramic material can be 2 minutes.

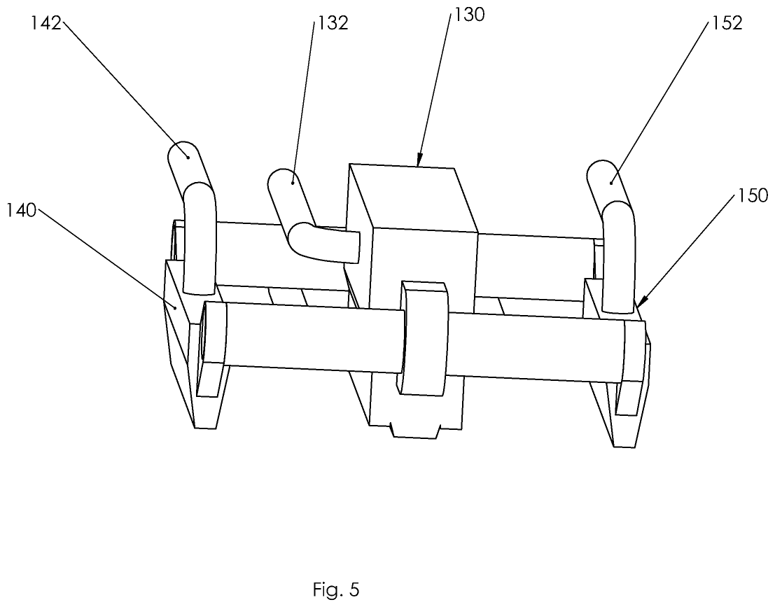

In various embodiments, continuously homogenizing can use homogenizing means without stop during the printing process. Additionally and/or alternatively, continuously homogenizing may use homogenizing means at least immediately prior to and/or during deposition of build materials, with possible pauses at other times. In some embodiments, if there are pauses in the process, the pause times between stopping homogenizing and layer deposition need to be less than the settling time. In various embodiments, this circulation can be achieved with a set of pumps (110,112,114,116,118). Four of these pumps (110,112,114,116) are homogenization pumps, while one pump (118) is used for circulation and to feed material to the deposition module (130). As will be shown in further figures, the outflow from the feed pump (118) flows through a tube (for example, an exit port 121 shown in FIG. 11) which may be connected to the inflow (for example, an input line 132 shown in FIG. 5) for the deposition module (130). While the full tubing circuit is not depicted, it may be understood from the figures that such a connection is readily achievable. During the printing process, the slurry reservoir (102) can be filled with slurry. The homogenization pumps (110,112,114,116) may be configured to homogenize slurry within their respective zones, such that inflow and outflow occur in proximity to a given pump. Additionally and/or alternatively, the homogenization pumps (110,112,114,116) can be configured to circulate the slurry around the reservoir (102) such that the outflow of one homogenization pump is directed toward the inflow of another. As will be shown in further figures, the exemplary homogenization pumps (110,112,114,116) may be hammer mill pumps, which can create a localized toroidal flow in homogenization processes. In some embodiments, additional features (not depicted) may be added to direct output flow from a pump in a particular direction, such as a shroud or other flow diversion structure as can be implemented in impeller pump systems. In some embodiments, the reservoir (102) is comprised of an inner wall, outer wall, and bottom surface, which collectively comprise an annular reservoir for receiving excess slurry from the deposition module (130) and any excess slurry that drains from the sides of the build platform (160). When the deposition module (130) is positioned over the reservoir (102), slurry can exit the deposition module (130) and fall back into the reservoir (102). If the deposition module (130) is translated across the build platform working surface (162), this will produce a layer of material for printing. An exemplary printing process may include translating the deposition module (130) across the build platform working surface (162) in one direction to produce the layer of material upon the active working surface (167), followed by processing the layer of material with the projection module (106), followed by lowering the build platform (160) by the thickness of one layer, and translating the deposition module (130) back across the build platform working surface (162) to produce another layer of material which may then be processed by the projection module (106). This configuration of pumps and style of pumps is intended to be illustrative but not restrictive; any suitable circulation and homogenization systems that provide material to a deposition module (130) are understood to be included in the present specification. In some embodiments, translation of the deposition module (130) may be achieved by any combination of linear actuator(s), rotary actuator(s) driving screw drives or belt drives, or any other method for achieving linear motion that is generally understood by those knowledgeable in the relevant art. Additionally, in some embodiments, the control of pump motors, build platform motion, and deposition module motion may be achieved through standard means. Although FIGS. 1-4 show the system (100) as including a pump system that includes the pumps (110,112,114,116,118) each with a function as set forth above for illustrated purposes only, the system (100) can implement such function(s) with a material delivery unit (108) with any suitable components and/or structures, without limitation. An exemplary material delivery unit (108) can include any suitable types of pumps, conveyors, vacuum, fan, turbine, mixer, blender, processor, and/or a combination thereof. Although FIGS. 1-4 show the system (100) as including the pumps (110,112,114,116,118) each with a function as set forth above for illustrated purposes only, the system (100) can include one pump, or any suitable number (more or fewer than five) of uniform and/or different pumps, without limitation. The functions of the pump(s) can be implemented via any configurations and/or combinations. In one example, one or more of the pumps can each provide functions of homogenization and circulation. In another example, one or more pumps can be homogenization pumps and one or more other pumps can be circulation pumps.

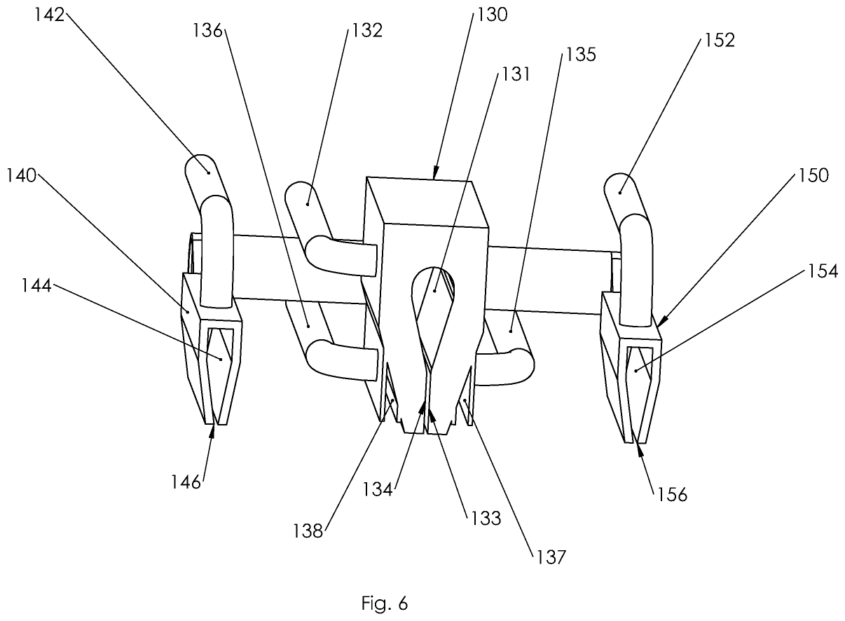

In one configuration, the deposition module (130) may be a slot die, the details of which are shown in FIGS. 5 and 6. The slot die functions by pumping slurry through an input line (132) into a central cavity (131) and out between two opposing surfaces (133,134). Two vacuum zones (137,138) may be used to improve the deposition process, as will be described in FIG. 8, by applying vacuum pressure through the right vacuum line (135) or left vacuum line (136).

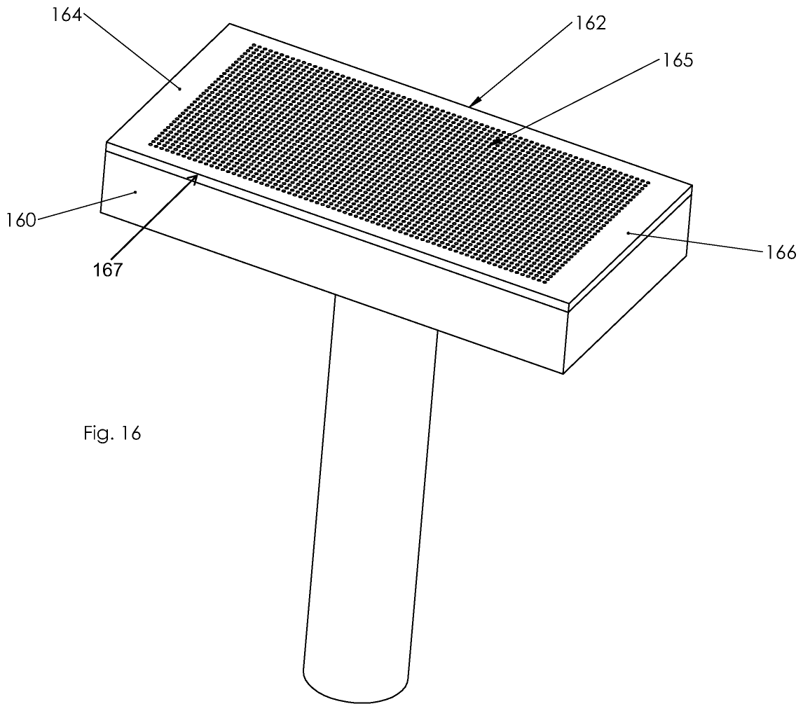

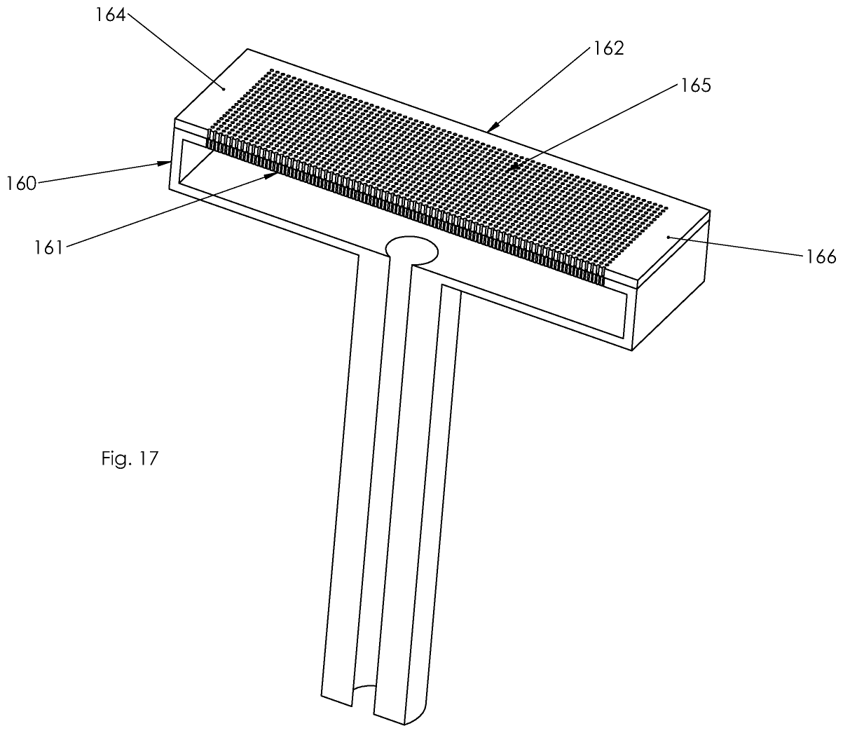

As will be further explained below, it may be desirable to limit where on the build platform working surface (162) the deposited material is allowed to accumulate. In one instance, it may be desirable to restrict deposited material from accumulating on the infeed/outfeed edges (or surfaces, or zones) (164, 166) (shown in FIGS. 16 and 17) of the build platform working surface (162). Air blades (140,150) comprised of inlet lines (142,152) feeding into central cavities (144,154) and allowing air to flow out through exit slots (146,156) may be used to blow excess material off of the build platform working surface (162) and back into the reservoir (102) for reuse on subsequent layers.

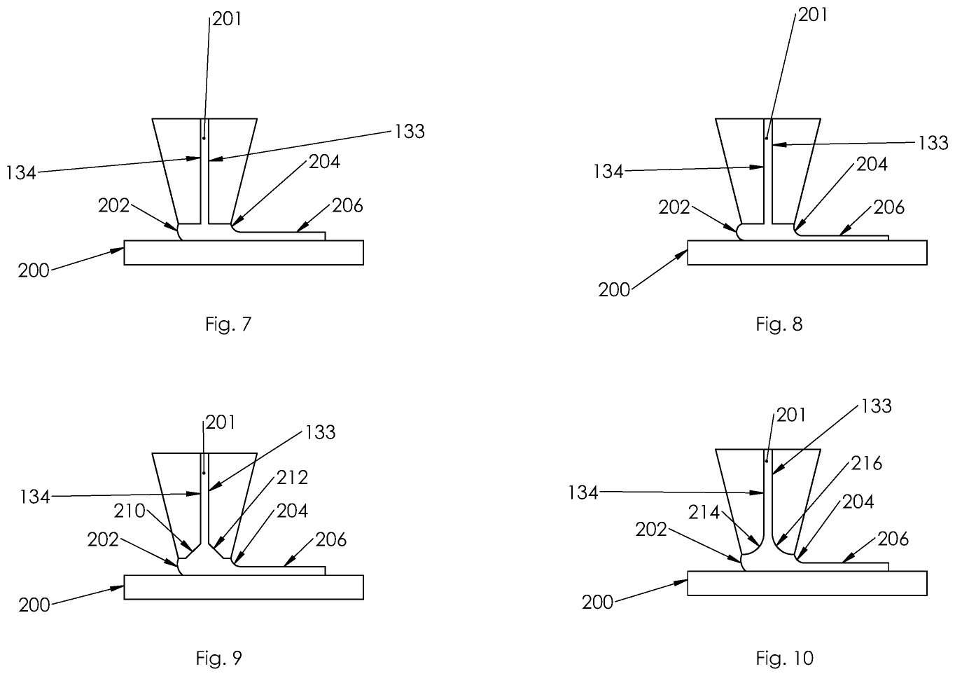

FIGS. 7-10 depict the process by which a slot die may be used in the deposition module (130) and modifications that may be made to improve the performance of such a slot die system. FIG. 7 depicts a standard slot die exit path, where slurry (201) is permitted to pass between opposing faces (133,134) of the slot die, before forming a bead with leading (202) and trailing (204) menisci which in turn produces a layer (206) of deposited material. A volume of the bead between the leading (202) and trailing (204) menisci can define a stable bead region of the bead. In this depiction and in FIGS. 8-10, the slot die is moving to the left and leaving a layer (206) of material behind it. As is understood in slot die coating, when operating conditions are fixed and the process occurs at atmospheric pressure, there is a limitation in the ratio of bead height to layer height. In this instance, the height of the bead is considered to be the height of the leading meniscus (202). This ratio may be increased, as shown in FIG. 8, by exposing the leading meniscus (202) to vacuum pressure, producing a thin layer while still maintaining high clearance between the slot die and the substrate, and lowering shear stress on the substrate. The increase in the ratio of bead height to layer height can be at least partially due to a forward shift in the bead under exposure to vacuum pressure. There is also a shift in the velocity profile within the bead, which is the primary factor in determining shear stress, as flow within the bead is typically laminar. These features are generally understood in existing applications for slot die coating, and may be advantageously applied in some embodiments. In some embodiments, vacuum pressure can be provided by the left vacuum zone (138) as shown in the previous figure.

In some embodiments, conditions (flow rate, traverse speed, etc.) may be controlled to provide a stable bead during deposition, which will in turn produce a very uniform layer (206). If, however, there are deviations in a previous layer, there can be some compensation for these deviations by virtue of the nature of the slot die deposition process. A low area on a previous layer, will lead to a larger gap between the slot die and the substrate (200) which in this instance, is the previous layer. This larger gap will draw more material from the bead and produce a thicker layer (206) which will at least partially compensate for the low area. The converse behavior will be seen with high areas. The limitation to this behavior is at least partially determined by the size of the bead; if too much material is drawn from the bead, the leading meniscus (202) will no longer be stable, and air bubbles may be incorporated into the layer (206). Conversely, if too little material is used from the bead, the leading meniscus (202) may extend too far beyond the slot die and cause wetting on the angled external surface of the slot die. This additional material may cause imperfections in the layer (206) directly and may also produce residual material that may drip onto the next layer, causing imperfections in the next layer as the slot die moves across the build platform in the opposite direction.

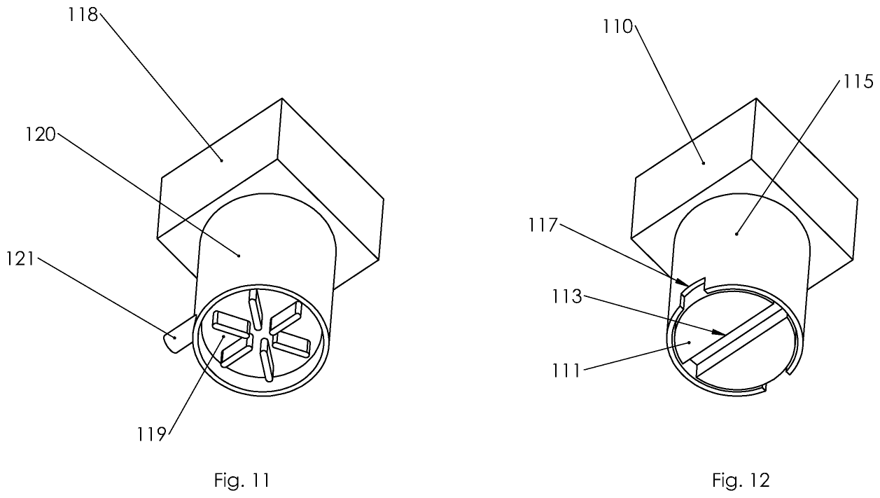

FIGS. 9 and 10 show modifications to the opposing surfaces (133,134) that define the slurry (201) flow path in order to increase the size of the bead without fundamentally altering other aspects of the deposition process in order to introduce greater deviation tolerance in the system. If the ratio of flow rate to the linear speed of the deposition module (130) (shown in FIG. 6, for example) is kept within a range that prevents excess flow from making the bead become too large, the leading meniscus (202) can be prevented from extending too far beyond the slot die and from resulting in wetting on the angled external surface of the slot die. Chamfers (210,212) or fillets (214,216) may be added to the slot die surfaces (133,134) to this end; additionally and/or alternatively, other cutout shapes may be used to produce the desired effect. The chamfers (210,212), fillets (214,216) and/or other cutout shapes formed on the slot die surfaces (133,134) can expand the size of an opening defined at end regions of the slot die surfaces (133,134) and the stable bead region can be enlarged. The inventor has discovered that the increasing bead size can increase stability and/or uniformity of deposition by the deposition module (130). Conventional slot die coating applications only coat a single layer, such as a coating on a sheet of paper to make the paper glossy, for example, or a limited number on the order of 5 or fewer of successive layers, such as multiple colors or coatings. In contrast, the disclosed system (100) (shown in FIGS. 1-4) can use slot die coating in SFF. When depositing a plurality of layers including, for example, hundreds or thousands of layers, it is important to make sure the system (100) is stable over such a high level of repetition. Therefore, by modifying the slot die to increase stability in SFF application, the system (100) solves a problem that is uniquely present in the application for SFF and that does not necessarily exist in other applications of slot die coating. Exemplary number of layers needed for making a three-dimensional object can be equal to, or on the order of, 10, 20, 50,100,200,500,1000. Such a number is significantly greater than any other techniques using slot die coating. Thus, using slot die coating in SFF can encounter unique technical problems that have not been encountered or resolved in conventional slot die coating techniques. The methods and systems as set forth in the present disclosure can solve such technical problems.

FIG. 11 depicts a circulation pump (118) which may be used to feed the deposition module (130) previously depicted. This pump (118) may contain an outer shroud (120), a rotor (119) and an exit port (121). In this configuration, this pump (118) can be an impeller pump, which may run continuously to cycle slurry through the deposition module (130). FIG. 12 depicts a homogenization pump (110) containing a shroud (115) with exit slots (117) and a rotor (111) with a pumping slot (113). In this configuration, the homogenization pump (110) can be a hammer mill, which uses centrifugal pumping motion to drive collisions between suspended particles in the slurry and the exit slots (117) of the shroud (115). This has the effect of breaking up powder agglomerates and homogenizing the slurry. Continuously circulating slurry through these pumps can aid in maintaining slurry quality and preventing settling and/or agglomeration.

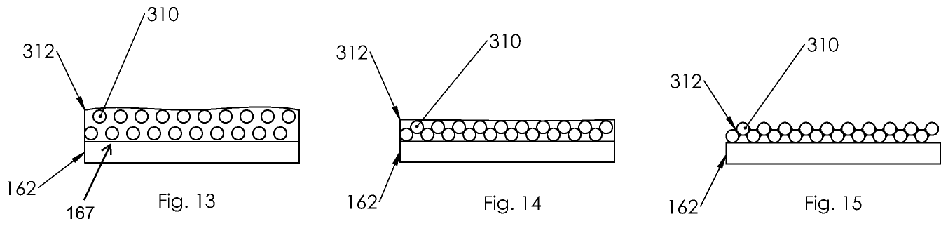

FIGS. 13-15 show a schematic representation of a material handling method that may be used in the aforementioned systems. As will be described in further figures, the build platform working surface (162) may be porous to allow fluid flow through the platform. In this configuration, a low density blend of powder (310) and resin (312) is deposited on the active working surface (167). Vacuum pressure is applied to the slurry through the porous build platform working surface (162), and if present, previously-deposited layers, to remove excess resin (312) and increase the effective powder loading density of the slurry, thus densifying the powder (310). In an extreme case, as shown in FIG. 15, all excess resin (312) may be removed such that resin (312) is only found at tangent points between powder particles (310). In the case where not all resin (312) is removed (for example, as shown in FIG. 14), layers may be imaged using a lattice structure to allow for fluid flow and fluid removal from subsequent layers. Stated somewhat differently, the layers can be imaged in accordance with a lattice pattern. Advantageously, resin in un-imaged area of a layer can be removed, such that fluid paths can be opened in the layer. If the lattice size and borders are designed appropriately, for example being mostly solid with few or no holes, the lattice can trap uncured powder within the three-dimensional part, enabling a solid part to be created by the sintering process, despite lattice having been used during exposure. In the instance depicted in FIG. 15, it can be unnecessary to use these lattice imaging techniques; fluid paths within the part can be available even when using solid curing images, because this fluid evacuation process can leave an inherently porous structure.

The value of densifying a deposited layer is that it allows for the use of a low viscosity feedstock during deposition which may be deposited rapidly, while producing a high density printed part that is highly homogenous. If a feedstock with low powder loading were used, it may not sinter properly, as there are minimum requirements for the density of a printed part to be able to achieve high density after sintering. If a feedstock with a high powder loading were used, the viscosity would be very high, and the layer deposition (and thus printing) process would be very slow. Additionally, metal powder in particular tends to settle out of a slurry rapidly, and in a layer of material with low powder loading, this can produce a printed layer with more powder in the bottom section of a layer than in the top section of a layer. This effect can impact the mechanical properties of a sintered part, producing a part that is weaker when tensile loads are applied in the vertical direction as compared with load application in any horizontal direction. Densifying the layer removes any density variation in the layer, producing isotropic sintered parts. Additionally, a higher density printed part, will shrink less during sintering, making it possible to control dimensional tolerances to a greater degree. Further, if the slurry is deposited on a porous substrate without applying vacuum pressure, the layer may densify as fluid is absorbed passively into the substrate, but such a process of densification can occur very slowly as compared to when the process is assisted by vacuum pressure. Additionally, the speed of this densification process can decrease significantly and may cease altogether as additional layers are deposited.

In some embodiments, the suction process can be controlled and/or validated by imaging with the camera (104) (shown in FIG. 1). The active working surface (167) can be illuminated (and/or irradiated) by a light source that is absorbed by the resin material and reflected by the powder material, and the emergent light can be imaged by the camera (104) to determine the relative amount of resin and powder in a given build layer. This data obtained based on imaging by the camera (104) can be used as feedback to control the level of vacuum pressure applied during densification. For instance, a very high vacuum pressure can be initially applied, and as the amount of resin in the layer decreases, the vacuum pressure can be decreased to maintain the resin level in the layer at a stable target value. In some embodiments, the maximum vacuum pressure (approximately 14.7 psi in a non-limiting example) may not necessarily be adequate to achieve layer densification at a desired rate. In this instance, it can be desirable for the entire build process to be enclosed in a hermetic container which can be pressurized to increase the effective differential pressure proximal to the active working surface (167) relative to the pressure proximal to the side of the build platform working surface (162) in the direction opposite to the active working surface (167). In various embodiments, “vacuum pressure” can be understood to mean the magnitude of applied differential pressure described herein. For example, a “high vacuum pressure” can include a high differential pressure.

FIGS. 16 and 17 show a build platform (160) with a build platform working surface (162) that may be used in the previously described systems. The build platform working surface (162) may be removable, and can have a central porous region (165) as well as infeed/outfeed surfaces (164,166). As previously described, the porous region (165) allows for the densification of slurry deposited on the build platform working surface (162) or the active working surface (167). Given that densification may not occur in the infeed/outfeed zones (164,166), this further elucidates the benefits of using air blades to remove excess material, as previously described.

The build platform (160) may also have an open cavity with a porous top surface (161). In this instance, the porous region (165) of the build platform working surface (162) may have pores that are small enough to prevent printed parts from falling through, but are large enough to allow powder to flow through, whereas the porous top surface (161) of the build platform (160) may have smaller pores that allow resin to flow through, but not powder. In some embodiments, a size (for example, a diameter) of each pore of the porous region (165) can be smaller than a size of each of the printed parts and greater than a size of the powder, whereas a size (for example, a diameter) of each pore of the porous top surface (161) can be smaller than the size of the powder. During the printing process, powder and resin can fill the pores of the build platform working surface (162) but powder will not fall into or below the build platform (160). The build platform working surface (162) with the porous region (165) can allow for the removal of the build platform working surface (162) to clean excess material (for example, the powder contained within uncured resin material) from a batch of parts and/or off of the build platform working surface (162), which will be described further in subsequent figures. During the cleaning process, excess unbound powder can fall through the build platform working surface (162), thus facilitating the cleaning process. During cleaning, only unbound powder and resin can be removed, because the pores defined in the build platform working surface (162) can be smaller than the printed parts and/or support structure. In various embodiments, the unbound powder can include the portion of the powder blended with the resin where the resin is not exposed to UV light and is not solid. The unbound powder can include the portion of the powder blended with the resin where the resin is exposed to UV light and is solid.

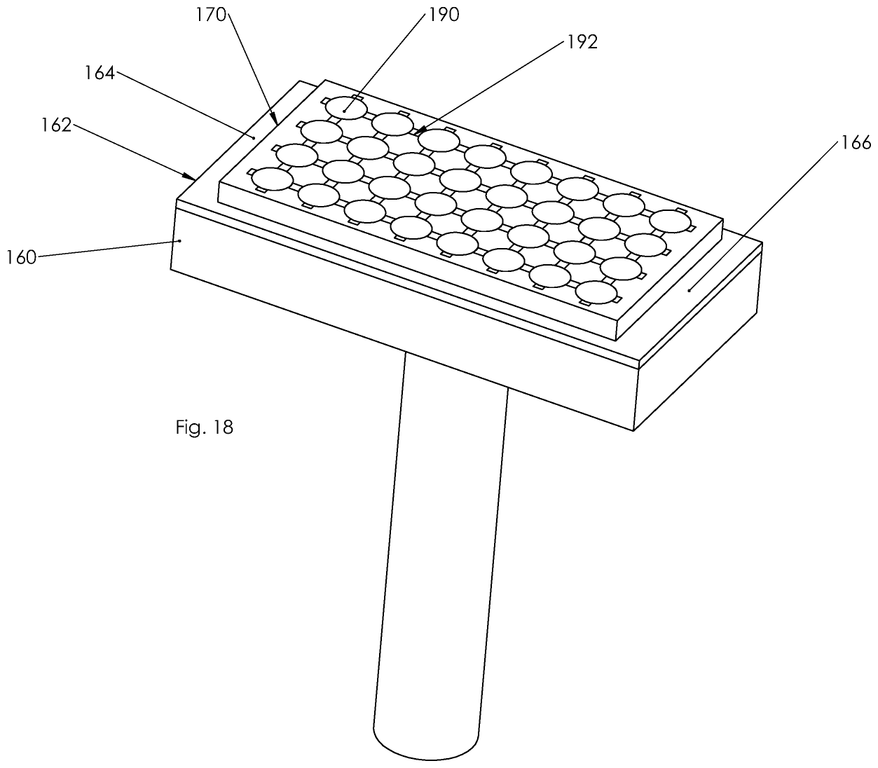

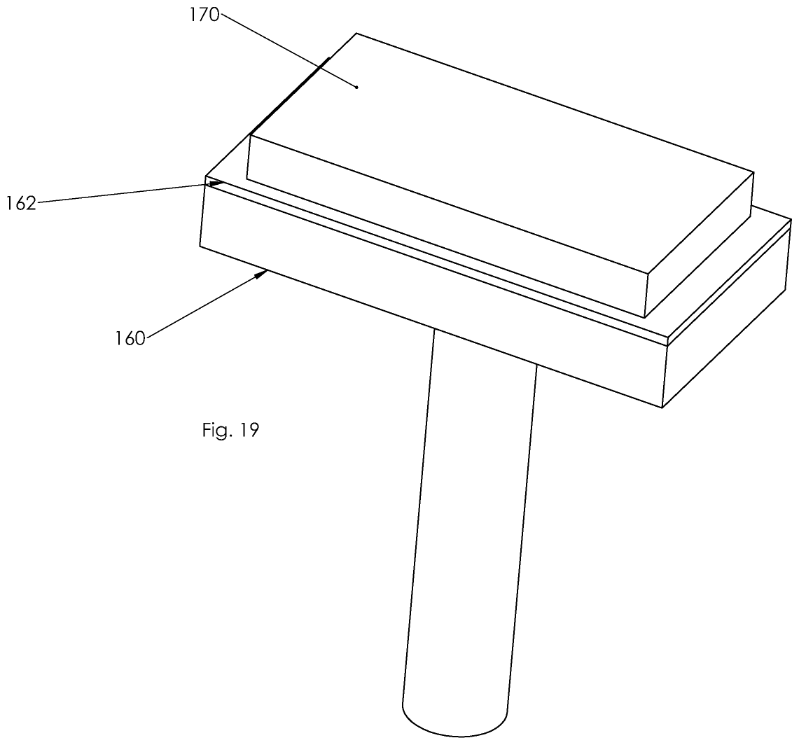

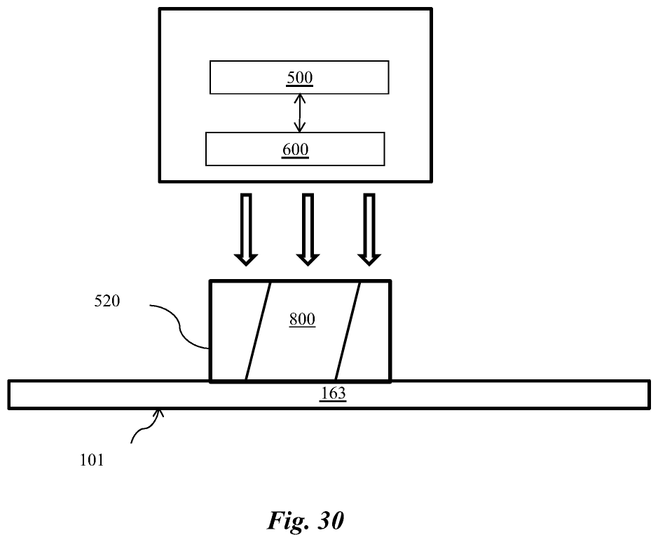

FIGS. 18 and 19 depict the build platform (160) and build platform working surface (162) during a build process. A partially finished build is shown in FIG. 18, comprising a part cake (a collection of parts and/or support structures and uncured material) (170) with partially finished parts (190) and support structure (192). In this instance, a densified build material (520) (shown in FIG. 30) (for example, deposited in the form of a slurry) can provide adequate support for the printed parts (190), and as such, the support structure (192) is not bonded to the parts (190) and does not necessarily serve the purpose of certain traditional support materials or structures. In various embodiments, being bonded can include being fixedly and/or rigidly attached, connected, or adhered. Stated somewhat differently, even if the support structure (192) can contact and/or touch the parts (190) at selected locations of the parts (190) to hold the parts (190) in place, the support structure (192) is not attached, connected, or adhered to the parts (190) in a fixed manner because there can be a gap between the parts (190) and the support structure (192) that are created during the printing process. In some embodiments, the gap can be defined by modifying the layer image(s) inputted to the projection module (106). For example, modifying the layer image(s) can include defining one or more image pixels between the support structures (192) and the parts (190). The support structure (192) can serve to maintain the positioning of the parts (190) during a post processing, possibly including a wash process and/or removal for sintering.

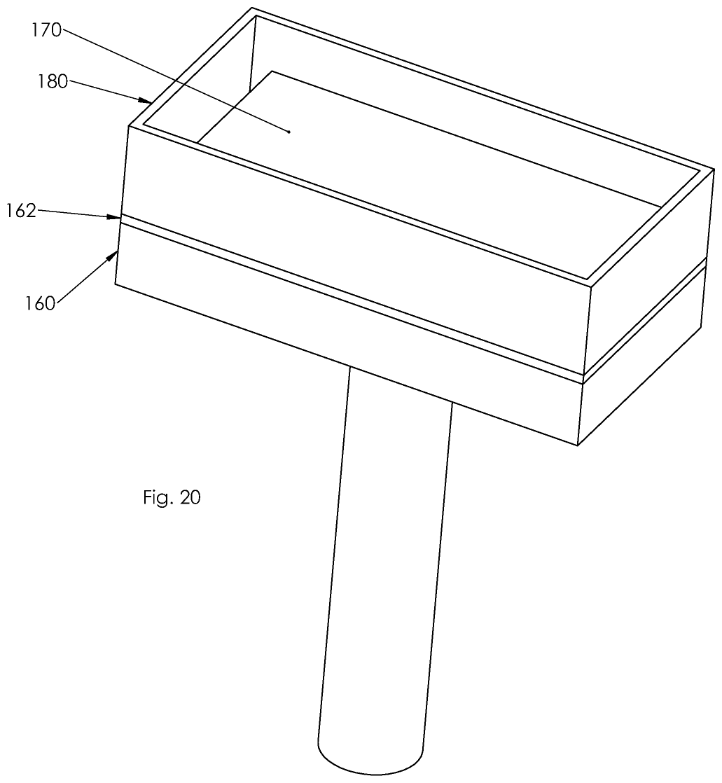

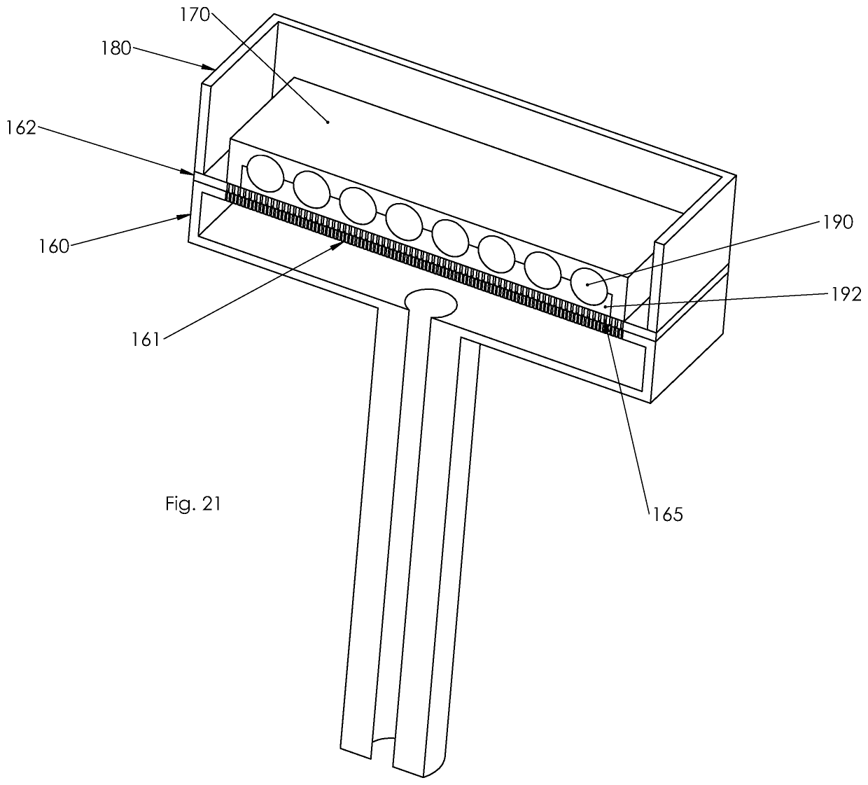

FIGS. 20 and 21 show a system and method for pre-treating a part cake (170) before any additional steps to remove excess material and sinter parts are taken. It may be advantageous to remove any uncured resin from the part cake (170) prior to further treatment, as it may help facilitate the process of fluidizing (and/or loosening) unbound powder and removing this powder. In some embodiments, the removal of the uncured resin does not necessarily result in a visible change in an appearance of the part cake (170). In this instance, a shroud (180) is placed around the part cake (170). The shroud (180) may be filled with a solvent, which may be suctioned through the part cake (170), through the same system used for layer densification during the print process. This may involve running the pre-treatment process within the printer itself, or at a separate station, which may have its own suction system, or may involve removing the build platform (160) from the printer entirely. Any and all forms of modularity involving moving the build platform working surface (162) or build platform (160) or other components within any of the aforementioned systems in order to facilitate these secondary processes are understood to be within the scope of the disclosed subject matter.

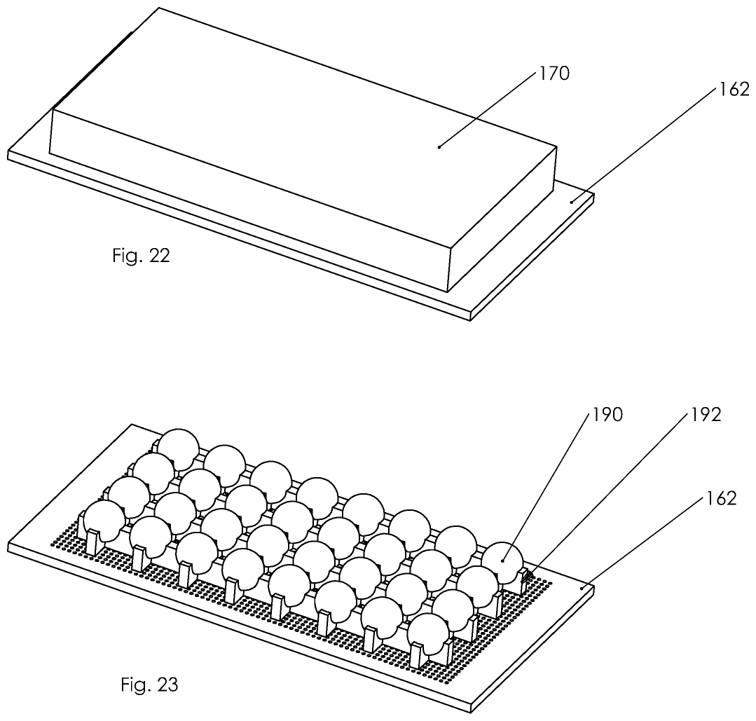

FIG. 22 depicts the build platform working surface (162) and part cake (170) removed from the printer after the completion of a build. This may be done before or after the aforementioned pre-treatment process, or may not involve the pre-treatment process. As previously mentioned, the porosity in the build platform working surface (162) may be such that powder is permitted to flow through it, but parts are still held on top of it. As such, this assembly may be placed in a cleaning bath with a cleaning solution, which may subject the part cake (170) to sonication, heat, flow of the cleaning solution induced by a pumping system, stirring, etc. in order to fluidize unbound powder and remove any excess material including the unbound powder. The end result of such a process is shown in FIG. 23, with parts (190) held in place by support structures (192) though not necessarily bonded to the support structures (192). In some embodiments, the part (190) and/or the support structure (192) can each be internally bound, but the part (190) is not bonded to the support structure (192) at any location on the part (190).

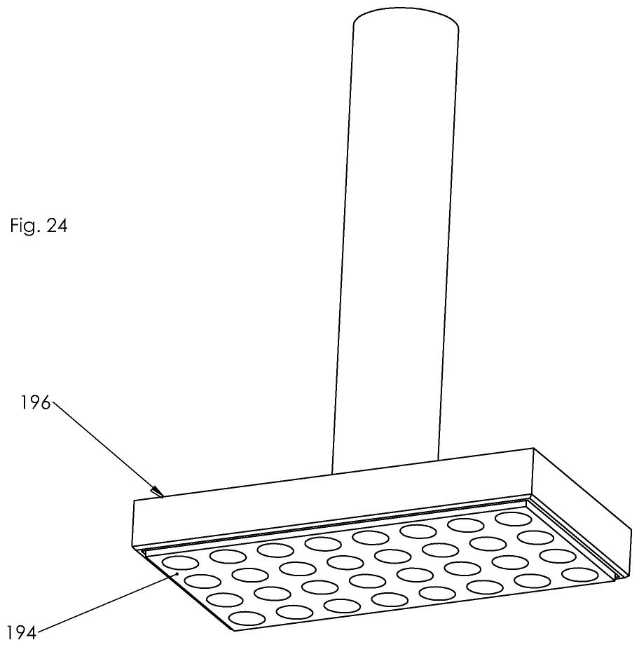

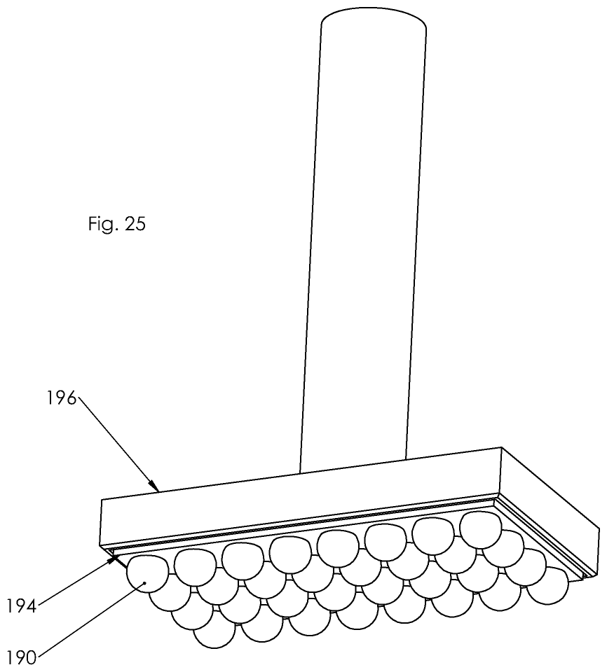

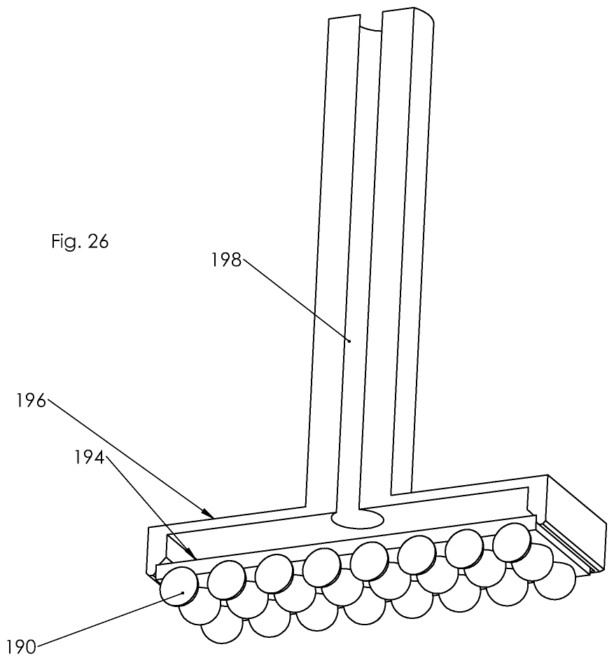

FIGS. 24-26 depict a system and method for removing parts (190) in preparation for sintering. A vacuum module (196) may have a porous ceramic tray (194) mounted within it, with geometry that matches the top of the parts (190) and provides support to those parts (190) during sintering. Vacuum suction may be applied through the part tray (194) to remove parts (190) from their support structures (192). This part tray (194) may then be inverted and loaded into a furnace for sintering. In some embodiments, parts (190) may be printed upside down (or in any other desired orientation), such that when the part tray (194) is inverted, they are in a desirable orientation for sintering. This ceramic part tray (194) may also be printed and sintered using the previously described system, with its geometry determined to be a complementary geometry to the down-facing surfaces of a part or collection of parts, after an optimal orientation of these parts for sintering has been determined. Since the sintering temperature of ceramics is significantly higher than for metal materials, a printed ceramic tray may be reused many times to run batches of metal parts. In this manner, a low cost tool may be obtained that automates part handling for production runs of metal parts, increasing the total efficiency of the process for producing metal parts through the previously described system, particularly through a reduction in labor costs. In some embodiments, the part tray (194) can define pores therein with a size smaller than a size of each of the parts (190). For example, by adjusting a sintering cycle to reduce peak temperature and/or soak time, a controlled level of porosity in the part tray (194) can be achieved. By using the porous part tray (194), a plurality of parts (190) can be loaded in the part tray (194) simultaneously. Conventionally, when parts are very small (for example, with a size on the order of millimeter), human operation is needed for loading the parts manually, and one by one, for sintering. Such operation is inefficient and prone to errors. In contrast, the disclosed method set forth above can advantageously load the parts (190) in an efficient and accurate manner. Speed and volume of manufacturing can thus be significantly improved.

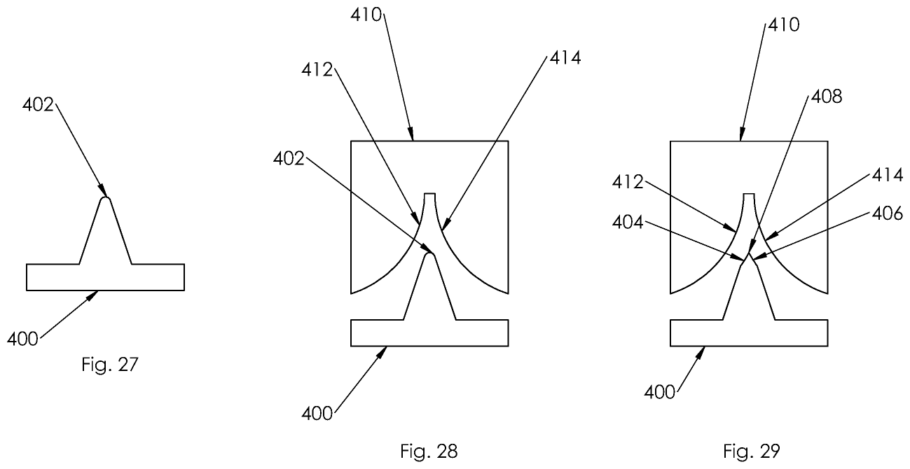

FIGS. 27-29 depict a system and method for refining specific geometries of printed parts in a manner that is scalable and cost effective. In some instances, it may be desirable to produce parts that have sharp points or edges, and these points or edges may be in areas that are not readily reachable with standard sharpening methods, or there may be a large number of such areas that require refinement, such that traditional methods would not be cost effective when there is a need for a high quantity of parts to be produced. In this instance, traditional methods may be replaced by electrochemical machining using a printed tool (410), where the geometry of this tool (410) has been determined to sharpen all relevant features in a single process. In this instance, a part (400) with a dull point (402) is depicted. By extrapolating from the desired final geometry (404,406,408), the tool geometry (412,414) may be determined. The desired final geometry of the part (400), or a targeted geometry, can include a geometry of the part (400) that is a goal of the modifying the part (400) via the electrochemical machining. In this instance, the modified surfaces (404,406,408) are directly impacted by the portions (412,414) of the tool (410) that are closest to the part (400), which is where the current density during electrochemical machining will be highest, thus determining what material is removed. Depending on current level, the proximity of tool geometry to part geometry, and in some cases the waveform used during machining, features of the tool (410) which are further away from the part (400) can have a negligible effect on a shape of the part (400) and thus can be ignored in determining the geometry of the tool (410). This provides a straightforward method for determining tool geometry based on the feature(s) which need modification on a particular part (400). This method may be applied to many features on a part or array of parts. A printed tool (410) may be used to refine a part (400) or a plurality of parts (400) simultaneously, thus providing a method to achieve very fine geometries in a scalable and cost effective manner. In some embodiments, the part (400) can have a plurality of features that require modification. The tool (410) can be printed with a plurality of features that have a geometry complementary to a geometry of the plurality of features of the part (400), and/or have other suitable geometry, to modify all desired features of the part (400) simultaneously. This can be extrapolated to provide a method for modifying a plurality of parts (400) with a plurality of tools (410), one part (400) with a plurality of tools (410), and/or a plurality of parts (400) with a single tool (410). The geometry of the tool (410) can be automatically generated by modeling software, after a user has specified which surfaces require treatment. By modifying a plurality of parts (400) simultaneously, the process can become highly scalable and can be cost effectively implemented in high volume manufacturing.

Additionally and/or alternatively, it may be desirable to produce a porous tool (410) such that electrolytic fluid may be flowed through it to remove waste material during an electrochemical machining process. A tool (410) with pores (not shown) that are large enough to allow electrolyte flow and small enough to produce a uniform current density in the relevant region between the tool (410) and the part (400) can be suitable for this type of electrochemical machining process, because the pores can allow for optimal thermal control of the tool (410) as well as direct electrolyte flow at a working surface of the part (400) to efficiently clear away any increase in ion concentration during the machining process. In some embodiments, the pores can be less than half of the mean diameter of the powder particles, and/or can be approximately an order of magnitude smaller than the mean diameter of powder particles. Additionally and/or alternatively, the pores can be at least 50 nanometers (nm) in diameter. While it can be desirable to achieve the highest density possible when sintering a printed three-dimensional object, if porosity is desired in some embodiments, the sintering cycle may be adjusted to reduce peak temperature and soak time in order to achieve a controlled level of porosity in the final three-dimensional object. The previously described electrochemical machining process may be further improved by sintering the part (400) to maximum density, sintering the tool (410) to a lower density such that the tool (410) has a specified porosity that is high enough to allow fluid to flow through it, and flowing electrolyte through the tool (410) while applying a current to remove material from the part (400). In some embodiments, the porosity can be high such that the pores are of the size(s) as set forth above, and/or the pores internally connect to form passages and/or networks in the tool (410). In some embodiments, with the size(s) as set forth above, the pores can be sufficiently small such that the pores can have a negligible effect on the geometry of the part (400) in the electrochemical machining process. In some embodiments, the pores can be uniformly distributed through the tool (410), such that heat generated in the electrochemical machining process can be uniformly and efficiently dissipated away from the tool (410) via the pores, thus achieving uniform cooling. Additionally and/or alternatively, the increase in ion concentration in proximity to the tool (410) can be cleared away uniformly and efficiently. In contrast, any conventional tools for electrochemical machining process, even if made with openings of certain structures, cannot achieve the uniformity of porosity, and thus the effective electrochemical machining process, as accomplished by the method set forth above.

Turning to FIG. 30, an exemplary diagram of a system (101) is shown as including a build platform (163). In some embodiments, the system (101) can include the system (100) (shown in FIG. 1 for example). In some embodiments, the build platform (163) can include the build platform (160) (shown in FIGS. 1 and 17, for example). The system (101) can include a build material unit (500) and a selective processing unit (600). The build material unit (500) is configured to dispose a build material (520) on the build platform (163). An exemplary build material unit (500) can include the deposition module (130) (shown in FIG. 1), and/or any other suitable components associated with the disposing of the build material (520). An exemplary build material (520) can include the slurry (201) (shown in FIG. 7), or the blend of the powder (or powder material) (310) (shown in FIG. 13) and the resin (312) (shown in FIG. 13).

The selective processing unit (600) is configured to selectively process the build material (520) such that a portion of the build material (520) can form a three-dimensional object (800). Selective processing can include applying at least one process that modifies only a selected portion of the build material (520) such that one or more characteristics of the selected portion can be different from the characteristics of the rest of the build material (520). In one embodiment, the selective processing unit (600) can modify a photosensitive material by irradiating the selected portion. In one embodiment, the selective processing unit (600) can modify a photosensitive material by irradiating all areas except the selected portion. In one embodiment, the selective processing unit (600) can modify an ability of the selected portion to be cured, solidified, sintered, or a combination thereof. In one example, the selective processing unit (600) can modify the selected portion of the build material (520) such that the selected portion can be cured (or sintered) while the unmodified portion of the build material (520) cannot be cured (or sintered). Upon the modifying, the selected portion can form the three-dimensional object (800) after any other optional and/or suitable post-processing. In another example, the selective processing unit (600) can modify the selected portion of the build material (520) such that the selected portion cannot be cured (or sintered) while the unmodified portion of the build material (520) can be cured (or sintered). Upon the modifying, the rest of the build material (520), excluding the selected portion, can form the three-dimensional object (800) after any other optional and/or suitable post-processing. The selective processing unit (600), and/or any other suitable equipment, can apply additional process(es) as needed to achieve or complete the curing (and/or sintering).

In another embodiment, the selective processing unit (600) can modify a state of matter of the selected portion. For example, the selective processing unit (600) can cure and/or solidify at least the selected portion of the build material (520) in accordance with a shape of the three-dimensional object (800). An exemplary selective processing unit (600) can include the projection module (106) (shown in FIG. 1).

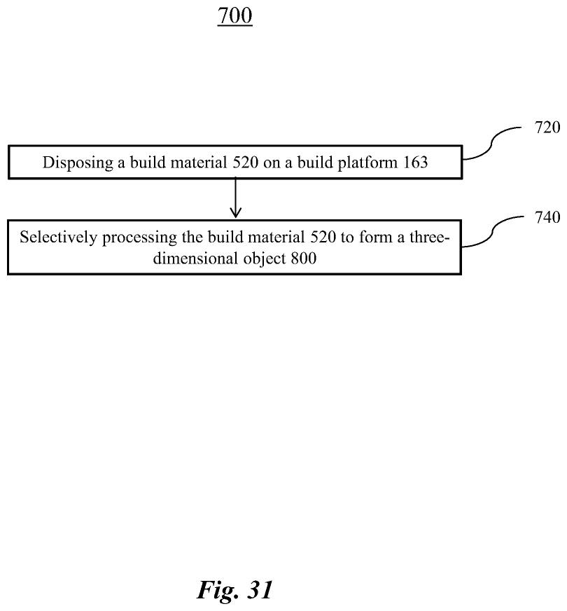

Turning to FIG. 31, an exemplary flow chart of an embodiment of a method (700) of making the three-dimensional object (800) is shown. The build material (520) can be disposed, at (720), on the build platform (163). The build material (520) can be selectively processed, at (740), to form the three-dimensional object (800).

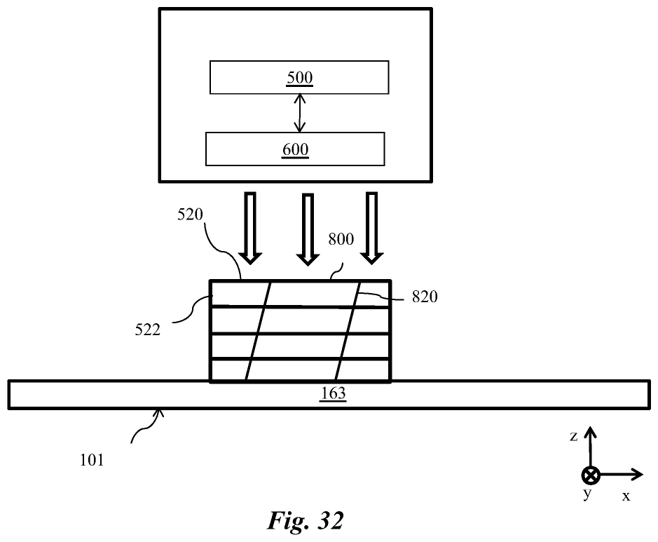

Turning to FIG. 32, the build material (520) is shown as including one or more layers (522). The layers (522) can extend in an x direction and a y direction (perpendicular to the plane of the figure) and stacked in a z direction. Each of the layers (522) can be selectively processed. In accordance with the selective processing, a portion of each of the layer (522) can form a layer (820). The layers (820) of the layers (522) can stack to form the object (800).

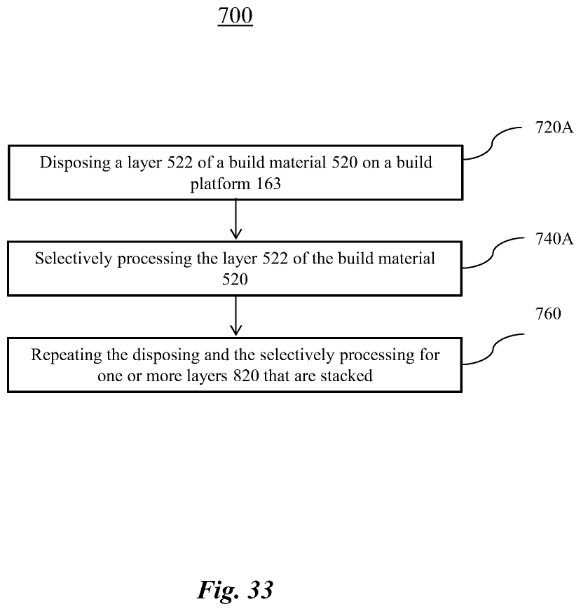

Turning to FIG. 33, an exemplary flow chart of an alternative embodiment of the method (700) is shown. A layer (522) of the build material (520) can be disposed, at (720A), on the build platform (163). The layer (522) can be an initial and/or first layer of build material (520). The layer (522) can be selectively processed, at (740A), to form a layer (820) of the three-dimensional object (800). The disposing and the selective processing can be repeated, at (760), for one or more layers 820 that are stacked. Stated somewhat differently, (760) can include repeating the disposing and the selective processing for a selected number of times, each time for a subsequent layer (522) stacking on a previous layer (522).

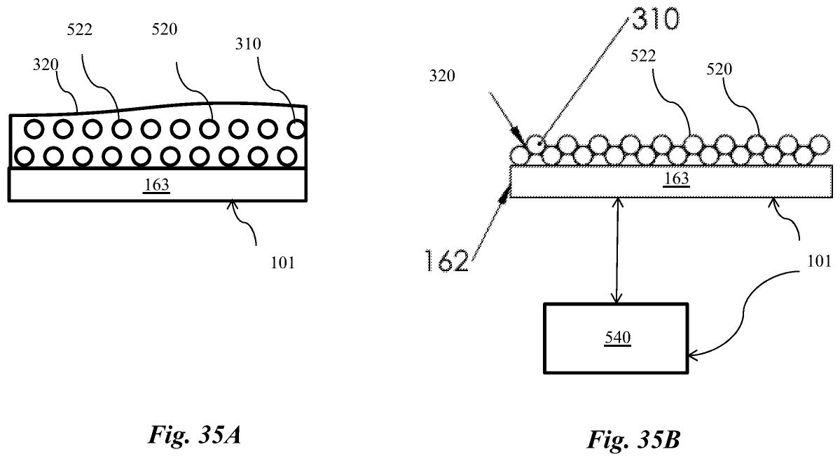

In various embodiments, the build material (520) can include a mixture and/or blend of the powder (310) (shown in FIG. 35A, for example) and a carrier fluid (320) (shown in FIG. 35A, for example). An exemplary carrier fluid (320) can include the resin (312) (shown in FIG. 13). The blend can be in the form of a slurry (201) (shown in FIG. 7, for example). In some embodiments, the build material can further include a gas (or a gas phase) composed of bubbles which can be blended with the fluid and solid components of the build material (520).

In one embodiment, the layer (522) of the build material (520) can be disposed via slot die coating.

Additionally and/or alternatively, the layer (522) of the build material (520) can be disposed via blade coating. Blade coating, particularly for various disclosed process which can involve repeating layer disposition and processing many times, may be advantageous as it has self-leveling characteristics. Stated somewhat differently, the height of the surface produced by a given layer disposition can be largely unaffected by irregularities in a prior layer.

Additionally and/or alternatively, the layer (522) of the build material (520) can be disposed via patch coating. Patch coating can include utilizing a slot die or other similar implement, wherein the flow of the build material (520) can be interrupted at selected intervals to only deposit material within a specific target area. For example, the build material (520) can be deposited over an array of sub-areas. Utilizing patch coating can limit material waste.

Additionally and/or alternatively, the layer (522) of the build material (520) can be disposed via continuous flow coating. In some embodiments, the continuous flow coating can include utilizing a slot die or other similar implement, wherein the flow of the build material (520) is not interrupted, and the build material (520) can be deposited over an entire work area.

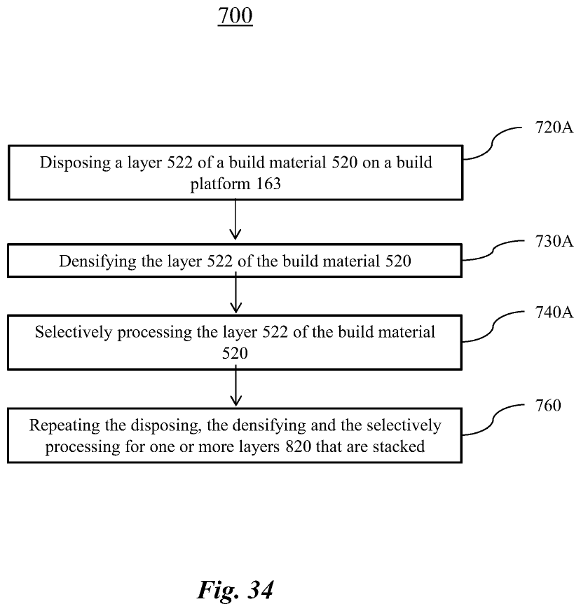

Turning to FIG. 34, an exemplary flow chart of an alternative embodiment of the method (700) is shown. The layer (522) of the build material (520) can be densified, at (730A). The densifying at (730A) can be after the disposing at (720A) and before the selectively processing at (740A). The densifying can be implemented using any suitable apparatus including, for example, the build material unit (500) (shown in FIG. 30), the selective processing unit (600) (shown in FIG. 30), the build platform (163) (shown in FIG. 30), and/or any other apparatus. The disposing, the densifying and the selective processing can be repeated, at (760). Stated somewhat differently, 760 can include repeating the disposing, the densifying and the selective processing for a selected number of times, each time for a subsequent layer (522) stacking on a previous layer (522). Although a process of forming the build material (520) or layer (522) are described using different terms such as disposing, depositing, or coating in various embodiments for illustrated purposes only, the features of process of forming the build material (520) or layer (522) are set forth via the description in each embodiment and are not limited solely by which of the terms disposing, depositing, or coating is used. In some embodiments, disposing, depositing, coating and/or other suitable terms describing forming the build material (520) or layer (522) on the active working surface (167), can be interchangeable.

The densifying can include increasing a loading density (or loading percentage) of the powder (310) (shown in FIG. 35A, for example) in the disposed layer (522). Stated somewhat differently, densifying the build material (520) can include increasing a proportion of the powder (310) in the build material (520) that is deposited. In some embodiments, the densifying can include at least partially removing the carrier fluid (320) (shown in FIG. 35A, for example) from the blend. In one embodiment, vacuum pressure and/or differential pressure can be applied to the layer (522) through the porous build platform working surface (162) (shown in FIGS. 13-15) to remove the carrier fluid (320). Stated somewhat differently, the vacuum pressure and/or differential pressure can be created between the build platform working surface (162) and the side of the build platform (163) opposite to the build platform working surface (162).

Turning to FIGS. 35A and 35B, the build material (520) before and after applying ultrasound is shown, respectively. The system (101) can include an ultrasound unit 540. In various embodiments, the ultrasound unit 540 can be integrated with, and/or coupled with, the build platform (163). The ultrasound unit 540 can generate ultrasound waves. The ultrasound unit 540 can have a direct mechanical connection with the build platform (163) via an acoustically conductive medium (not shown) such that the ultrasound waves can be transmitted to the build platform (163) to result in ultrasound agitation of the build platform (163). Exemplary acoustically conductive medium can include a solid and/or a liquid. The ultrasound unit 540 can apply ultrasound to the disposed layer (522) and densify the layer (522). The ultrasound can disintegrate the carrier fluid (320) into droplets and thus accelerate evaporation of the carrier fluid (320). By using the ultrasound unit 540, the build material (520) can be densified in a simplified manner.

Additionally and/or alternatively, the ultrasound can agitate the powder (310) and thus settle the powder (310), such that the powder (310) sinks by gravity proximally to the build platform (163) and becomes more closely packed. Uniformity of the powder (310) can thus be improved. By using the ultrasound unit 540, the powder (310) in the build material (520) can be settled in a novel manner. Uniformity of the disposed layer (522) can thus be improved. It is to be noted that ultrasound has not conventionally been used to remove fluid from a slurry to increase slurry density, or to settle powder that is deposited via the slurry.

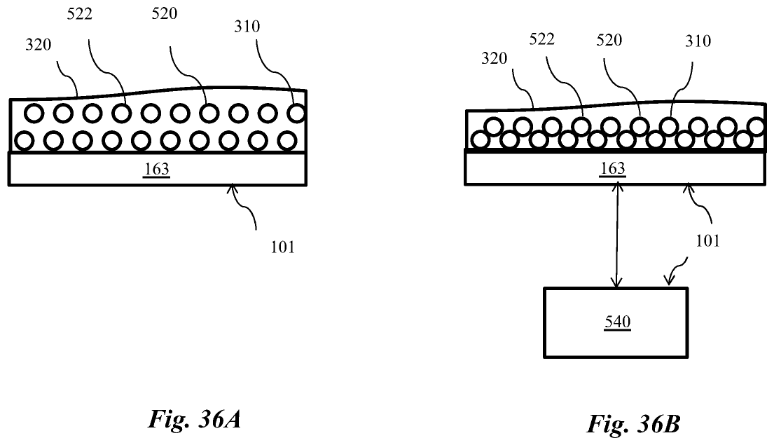

Turning to FIGS. 36A and 36B, the build material (520) before and after applying ultrasound is shown, respectively. The powder (310) is settled via the ultrasound, but the carrier fluid (320) is not necessarily significantly reduced. In various embodiments. the ultrasound can be applied for settling the powder (310) regardless of how the build material (520) is densified. For example, the carrier fluid (320) can be removed in a manner that does not necessarily use ultrasound, but the ultrasound can be applied for settling the powder (310). Advantageously, when a selected carrier fluid (320) is not easily reduced by the ultrasound, another method, such as evaporation or suction, can be applied to remove the carrier fluid (320) in a more expedited manner.

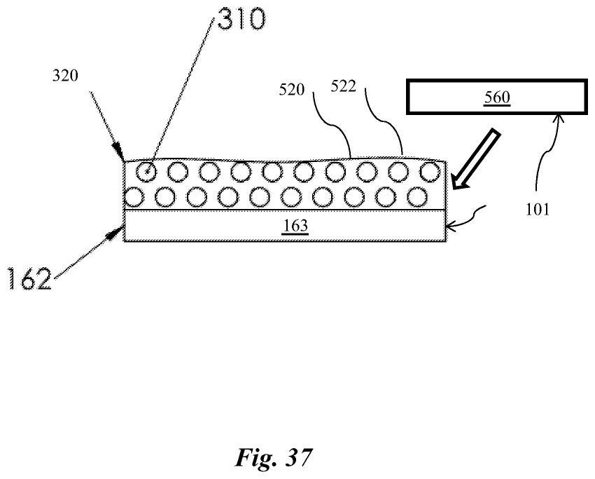

Turning to FIG. 37, the system (101) is shown as including an evaporation unit 560. The evaporation unit 560 can apply heat to the disposed layer (522) and evaporate the carrier fluid (320). The evaporation unit 560 can apply heat via conduction, convection, radiation, or a combination thereof. The radiation can include any suitable type of radiation including, for example, microwave, laser, infra-red (IR), and/or any other optical radiation. In various embodiments, the evaporation process may only be utilized to the extent that a majority of fluid is removed from the material layer, but an adequate amount is left within the layer such that it may be used during the selective processing (740) (shown in FIG. 31). In this regard, the carrier fluid (320) can serve the additional purpose of being processed selectively to define the part being built.

In one embodiment, the evaporation can be applied to a multi-component system that includes a filler and a backbone. In this embodiment, a filler material may require less energy to evaporate than a backbone material, and the backbone material may remain in the layer (522) after the evaporation process is complete. The backbone material may be further processed during the selective processing (740) to define the part being built.

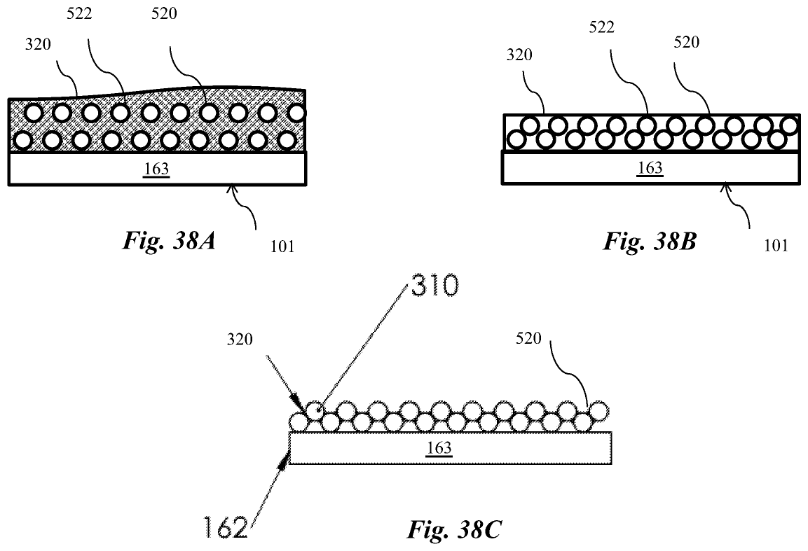

Turning to FIG. 38A, the build material (520) is shown as being a foam. Stated somewhat differently, the carrier fluid (320) can define a plurality of bubbles therein. The bubbles can be introduced into the build material (520) by adding a suitable bubble generator and/or foaming agent, churning the build material (520) via the build material unit (500) (shown in FIG. 30) prior to deposition, or a combination thereof. In one embodiment, the build material (520) can include the slurry (201) (shown in FIG. 7), so the bubbles can be introduced into the slurry (201).

Turning to FIG. 38B, the carrier fluid (320) is shown without the bubbles. In some embodiments, densifying of build material (520) can include collapsing and/or breaking down at least some of the bubbles. Upon collapsing the bubbles, air volume in the build material (520) can be reduced or eliminated, the amount of the powder (310) per unit volume of the build material (520) can be increased, and the build material (520) can be densified. In one embodiment, the bubbles can collapse by suction. For example, the suction can be applied to the build material (520) directly and/or via a low or differential pressure through the build platform (163). Stated somewhat differently, the low or differential pressure can be established between the sides of the build platform (163) that are respectively proximal to and distal from the build material (520). In another embodiment ultrasonic agitation may be applied to collapse the bubbles. In another embodiment, heat may be applied to collapse the bubbles. Additionally and/or alternatively, the bubbles can collapse naturally (that is, without suction) over a period of time. In any of these embodiments, the relative volume of air in the original build material may be high enough such that the collapsed layer has a certain amount of porosity remaining after the powder (310) has settled into a dense layer.

Turning to FIG. 38C, the carrier fluid (320) is shown as further reduced. Thus, the number and/or size of voids can increase between the powder (310) wetted by carrier fluid (320), so porosity in the build material (520) can be increased. Such reduction of the carrier fluid (320) can be implemented via any suitable densification methods as set forth above including, but not limited to, collapsing of the bubbles. Although FIGS. 38B and 38C show no bubbles for illustrative purposes only, the bubbles can exist in the carrier fluid (320) at any stage of densification even if the total amount of the bubbles is reduced.

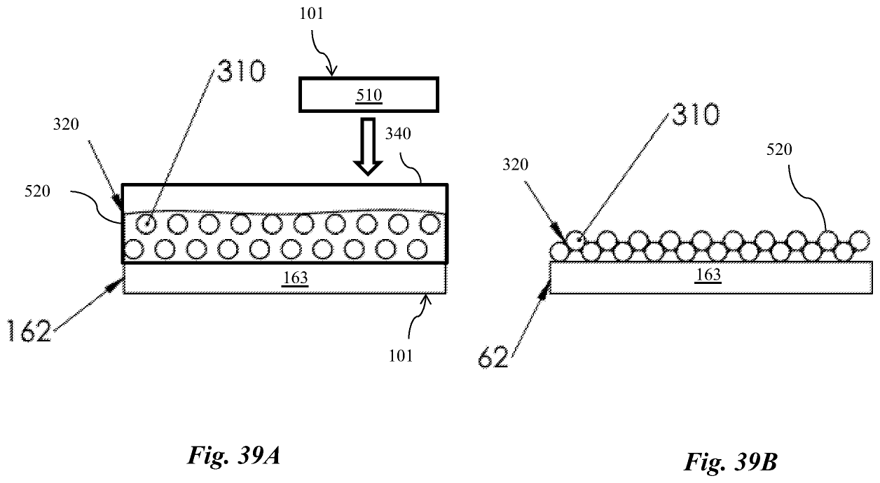

Turning to FIG. 39A, the system (101) is shown as including a densification fluid deposition unit (510). The densification fluid deposition unit (510) can apply a densification fluid (340) to the build material (520). In various embodiments, the densification fluid (340) can react with the carrier fluid (320) to produce one or more products that are in a gas state. For example, the densification fluid (340) can include an acidic component, and the carrier fluid (320) can include a carbonate, or vice versa. In various embodiments, the densification fluid (340) can be uniformly applied to the build material (520). The densification fluid (340) can be applied in any suitable manner. In one embodiment, the densification fluid (340) can be deposited via spraying. Advantageously, the layer (520) can react with the densification fluid (340) at all locations and be densified in a uniform manner. Although FIG. 39A shows the densification fluid (340) as being separated from the carrier fluid (320) for illustrative purposes only, the densification fluid (340) can be miscible with the carrier fluid (320) to chemically react with the carrier fluid (320), without limitation.

Turning to FIG. 39B, a volume of the carrier fluid (320) and the densification fluid (340) is shown as being significantly reduced, in comparison with FIG. 39A. Stated somewhat differently, upon the reaction between the densification fluid (340) and the carrier fluid (320), fluid volume in the build material (520) is reduced, the amount of the powder (310) per unit volume of the build material (520) can be increased, and the build material (520) can be densified.

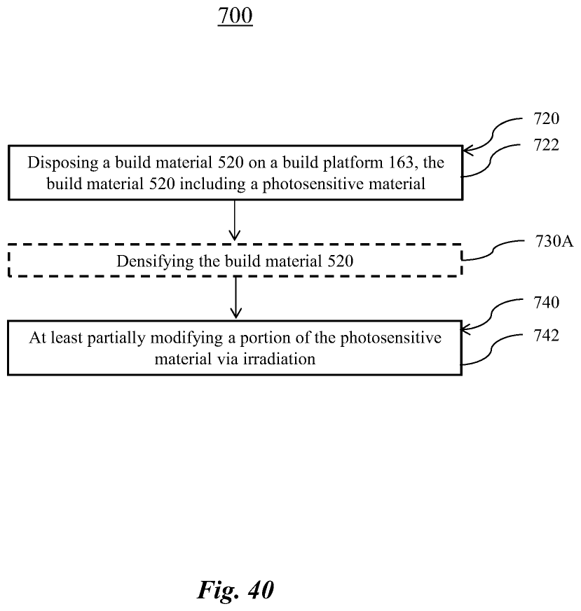

Turning to FIG. 40, an exemplary flow chart of an alternative embodiment of the method (700) is shown. The build material (520) can be disposed, at (722), on the build platform (163), and can optionally be densified using methods described herein. The build material (520) can include a photosensitive material. The photosensitive material can change its chemical composition and/or properties when exposed to electromagnetic radiation. At least a portion of the photosensitive material can be modified, at (742), via irradiation. In various embodiments, the selective processing unit (600) (shown in FIG. 30) can irradiate the photosensitive material. In one embodiment, the modified portion can form at least a part, or a layer (820) (shown in FIG. 32), of the three-dimensional object (800) (shown in FIG. 32). For example, the photosensitive material can include the resin (312) (shown in FIG. 13). The resin (312) can be cured by irradiation of UV (ultraviolet) light, for example. Thus, the portion of the resin (312) being irradiated can be solidified and form a layer (820) of the three-dimensional object (800). The build material (520) can be irradiated in accordance with a 2D image corresponding to a slice of the digital model of the three-dimensional object (800).

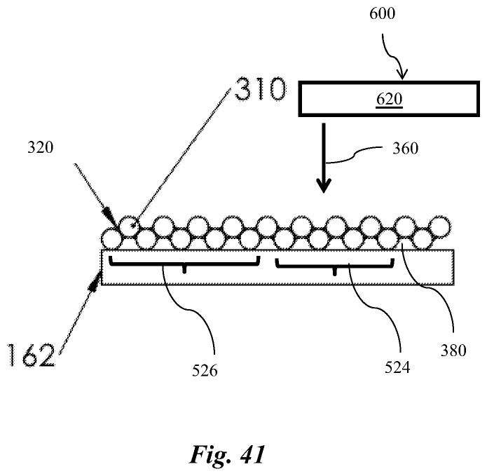

Turning to FIG. 41, the selective processing unit (600) is shown as including a selective deposition unit (620). The selective deposition unit (620) can be configured to deposit a supplemental build material (360) on one or more target areas (524) on the build material (520). Non-target areas (526) are areas of the build material (520) with no deposition of the supplemental build material (360). Properties of the target area (524) can be different from the properties of non-target area (526). An exemplary property can include ability to cure, ability to sinter, or a combination thereof. In various embodiments, the supplemental build material (360) can include a fluid. The selective deposition unit (620) can deposit the supplemental build material (360) in any suitable manner. In one embodiment, the selective deposition unit (620) can deposit the supplemental build material (360) via jetting and/or ink jetting.

The build material (520) is shown as the powder (310) wetted with the carrier fluid (320). The amount of the carrier fluid (320) can be small such that the build material (520) can define voids 380 between the particles of the powder (310). In various embodiments, the build material (520) can be densified to reduce the amount of the carrier fluid (320) to a suitable extent such that the powder (310) can be wetted with the carrier fluid (320) but define the voids 380 to accommodate more material (so as to accommodate the supplemental build material (360)). In various embodiments, the densification can be limited by a tap density of the powder (310). The tap density can be controlled by the particle size distribution and morphology of the powder (310). One goal of the densification process can be to get as close as possible to the tap density.

The resolution of the SFF can be affected by how precisely the target areas (524) can be defined by the deposition and/or wetting of the supplemental build material (360) on the build material (520). In various embodiments, the size of the droplet and the reaction kinetics of the binder activation reaction can be designed to optimize resolution, among other characteristics.

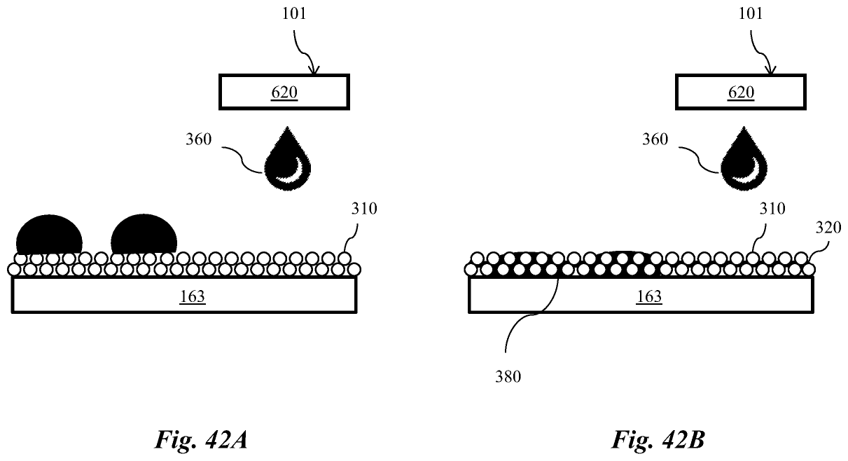

Turning to FIG. 42A, the system (101) is shown as depositing the supplemental build material (360) on the powder (310) without the carrier fluid (320). Stated somewhat differently, the powder (310) can be dry. The supplemental build material (360) is shown to form a bead on top of the powder (310) because the supplemental build material (360) does not readily wet the powder (310). As a result, it takes a certain amount of waiting time for the supplemental build material (360) to soak into the powder (310). In many SFF processes, small droplets are desired because large droplets impact the dry powder layer with force and results in cratering in the powder (310). Small droplets may also be desirable to achieve high resolution. The cratering reduces resolution of the formed 3D object and adversely impacts the density of the powder within the part as well as the uniformity of powder packing within the part. However, effects of surface tension are significant for smaller droplets and thus small droplets require a long waiting time to wet the powder (310). At least for the above reason, conventional binder jetting process is impractical for high resolution SFF.

Turning to FIG. 42B, the system (101) is shown as depositing the supplemental build material (360) on the powder (310) blended with a suitable amount of the carrier fluid (320). Stated somewhat differently, the powder (310) can be wet. The supplemental build material (360) is shown as soaking into the voids (380) promptly, in contrast to FIG. 42A. Stated somewhat differently, the carrier fluid (320) can facilitate wetting of the supplemental build material (360). As a result, it takes no waiting time, or only a short waiting time, for the supplemental build material (360) to soak into the powder (310). Therefore, the supplemental build material (360) can be deposited in very small droplets without significantly increasing soak time. Thus, high resolution of SFF can be achieved in a manufacturing process that is practical and cost effective.

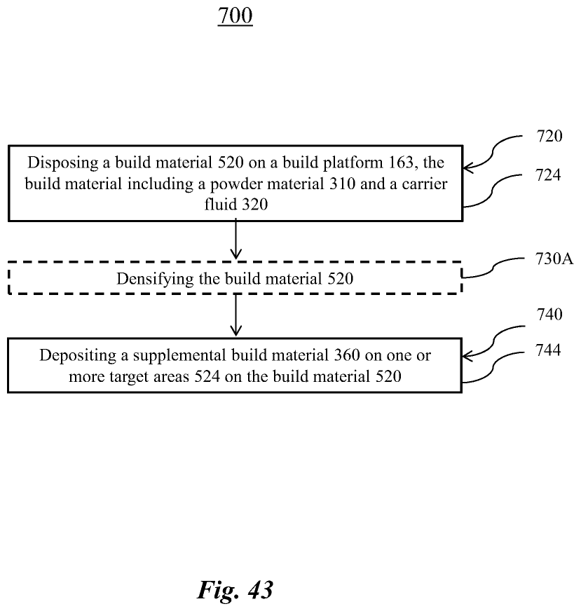

Turning to FIG. 43, an exemplary flow chart of an alternative embodiment of the method (700) is shown. The build material (520) can be disposed, at (724), on the build platform (163). The build material can include the powder material (310) and the carrier fluid (320)), and can optionally be densified using methods described herein. The supplemental build material (360) can be deposited, at (742), on one or more target areas (524) on the build material (520). Although the method (700) as set forth in FIG. 40 can achieve high resolution SFF, the high resolution is achieved via irradiation and such a method is not necessarily compatible with all kinds of the build materials (520). For example, when the powder material (310) includes certain reactive metals, such as titanium, the powder material (310) may react with the photosensitive (or photocurable) material, thus adversely affecting the sintering process. For example, most photocurable materials have some oxygen content; the oxygen can be pulled from the polymer during sintering and react with metal to form an oxide which can be damaging to the final properties of the sintered metal. In contrast, the method (700) as set forth in FIG. 43 can implement the high resolution SFF with a great variety of binder materials when there is no suitable photosensitive (or photocurable) material available for the build material (520).

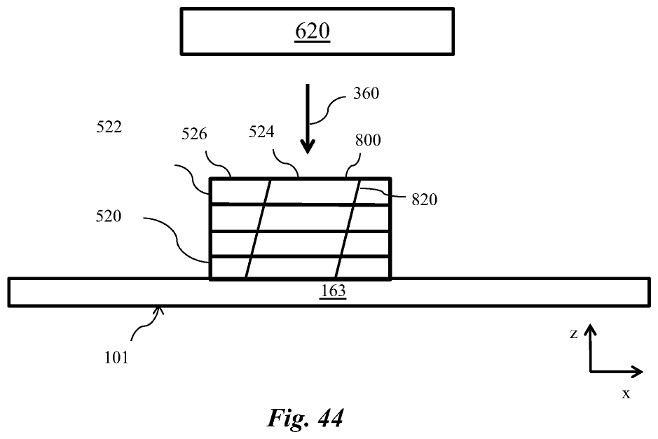

Turning to FIG. 44, the three-dimensional object (800) is shown as being formed based upon the target areas (524). In some embodiments, the supplemental build material (360) can induce and/or facilitate a curing reaction and/or state change. Examples of the supplemental build material (360) can include azo compounds or organic peroxides to facilitate thermal free radical polymerization, and/or basic aqueous solutions in the case of curing a cyanoacrylate binder. Any polymerization initiator that is appropriate for a given binder material that may be in the carrier fluid (320) is understood to be within the scope of this embodiment. Thus, the powder (310) can be bound in the target areas (524). In one embodiment, the powder (310) in the target areas (524) can form at least a part, or the layer (820), of the three-dimensional object (800). The supplemental build material (360) can be deposited in accordance with a 2D image corresponding to a slice of the digital model of the three-dimensional object (800).

In one embodiment, the curing reaction can include a photocuring reaction. The photocuring reaction can be induced by irradiation including, for example, UV light irradiation. For example, an entire layer (522) of the build material (520) can be irradiated in a non-selective manner. In one example, the supplemental build material (360) can include a photocurable resin. The photocurable resin can include a backbone resin and a photoinitiator. In another example, the supplemental build material (360) can include the backbone resin, and the carrier fluid (320) can include the photoinitiator. In yet another example, the carrier fluid (320) can include the backbone resin, and the supplemental build material (360) can include the photoinitiator. In general, in this and other embodiments, there may be a plurality of components, all of which can be needed in order to create or enable a chemical reaction and/or state change, wherein one or more of these components can be contained in the carrier fluid (320), and the remaining components can be contained in the supplemental build material (360).

In another embodiment, the curing reaction and/or state change can include a thermal curing reaction and/or state change. The thermal curing can be induced by temperature change (for example, exposure to heat). For example, an entire layer (522) of the build material (520) can be heated in a non-selective manner. In one example, the supplemental build material (360) can include a thermally curable resin. The thermally curable resin can include a backbone resin and a thermal initiator. In another example, the supplemental build material (360) can include the backbone resin, and the carrier fluid (320) can include the thermal initiator. In yet another example, the carrier fluid (320) can include the backbone resin, and the supplemental build material (360) can include the thermal initiator.

In yet another embodiment, the curing reaction can include a passive curing reaction. The passive curing reaction can occur in a suitable environment and complete within a period of time. In one example, the supplemental build material (360) can include a passively-curable resin. The passively-curable resin can include a backbone resin and an initiator. In another example, the supplemental build material (360) can include the backbone resin, and the carrier fluid (320) can include the initiator. In yet another example, the carrier fluid (320) can include the backbone resin, and the supplemental build material (360) can include the initiator. In yet another embodiment, the supplemental build material can include a binder material which is in a liquid state during deposition but which becomes solid shortly after deposition. In this embodiment, the carrier fluid (320) does not chemically interact with the supplemental build material (360). This may be achieved through the use of a supplemental build material (360) such as a wax, and/or other polymer, which can be melted within the selective deposition unit (620) and cooled upon deposition. The carrier fluid (320) may be selected to optimize its ability to absorb thermal energy from the supplemental build material (360). An exemplary carrier fluid (320) can include one or more components having a high thermal capacity. For example, the carrier fluid (320) can include water and/or oil.

In some embodiments, the supplemental build material (360) can include a binder that does not react with the carrier fluid (320). In one embodiment, the supplemental build material (360) can include a wax (and/or polymer). The build material (520) can be deposited at elevated temperature such that the wax can be in a molten state. Upon cooling, the wax can be in solid state. In one embodiment, the carrier fluid (320) can include a component capable of absorbing thermal energy from the wax, so solidification of the wax can be expedited. The wax can thus bind the powder (310).

Additionally and/or alternatively, the supplemental build material (360) can include a monomer. In one embodiment, the monomer can be solid at room temperature. An exemplary monomer can include norbornene. The build material (520) can be deposited at elevated temperature such that the monomer can be in a molten state. Upon deposition, the monomer can polymerize and/or solidify via a polymerization process including, for example, irradiation, chemical treatment and/or thermal treatment. The polymer can thus bind the powder (310) and binding strength can be increased via the polymerization. In some embodiments, the resultant polymer can decompose during sintering.

Additionally and/or alternatively, the supplemental build material (360) can be deposited in a lattice structure. Before depositing the supplemental build material (360), the fluid paths within the part can be available even when using solid curing images, because the densification process can leave an inherently porous structure. However, after deposition of the supplemental build material (360), any material binding the powder (310) may block fluid flow. Thus, the supplemental build material (360) can be deposited using the lattice structure to allow for fluid flow and fluid removal from subsequent layers.

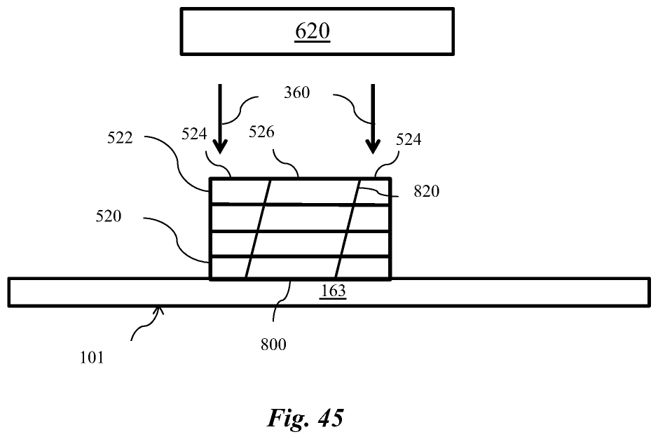

Turning to FIG. 45, the three-dimensional object (800) is shown as being formed based upon the non-target area (526). In some embodiments, the carrier fluid (320) (shown in FIG. 35A, for example) can include a curable material and the supplemental build material (360) can inhibit a curing reaction and/or state change of the curable material. An unlimiting example may include the use of an acrylate or methacrylate resin and photoinitiator as the carrier fluid (320), and a solution of any known free radical photoinhibitor as the supplemental build material (360), such as bis[2-(o-chlorophenyl)-4,5-diphenylimidazole] or other similar species which is complementary to the initiator. Thus, the powder (310) can be bound in the non-target areas (526). In one embodiment, the powder (310) in the non-target area (526) can form at least a part, or the layer (820), of the three-dimensional object (800). The supplemental build material (360) can be deposited in accordance with a complementary image of the 2D image corresponding to the slice of the digital model of the three-dimensional object (800).

In one embodiment, the curing reaction can include a photocuring reaction. The photocuring reaction can be induced by irradiation including, for example UV light irradiation. For example, an entire layer (522) of the build material (520) can be irradiated in a non-selective manner. In one example, the carrier fluid (320) can include a photocurable resin. The photocurable resin can include a backbone resin and a photoinitiator.

In another embodiment, the curing reaction can include a thermal curing reaction and/or state change. The thermal curing can be induced by temperature change (for example, exposure to heat). For example, an entire layer (522) of the build material (520) can be heated in a non-selective manner. In one example, the carrier fluid (320) can include a thermally curable resin. The thermally curable resin can include a backbone resin and a thermal initiator.

In yet another embodiment, the curing reaction can include a passive curing reaction and/or state change. The passive curing reaction can occur in a suitable environment and complete within a period of time. In one example, the carrier fluid (320) can include a passively-curable resin. The passively-curable resin can include a backbone resin and an initiator.

Additionally and/or alternatively, similar to the description set forth above, the supplemental build material (360) can be deposited in a lattice structure and/or any other suitable porous structure to allow for fluid flow and fluid removal from subsequent layers.

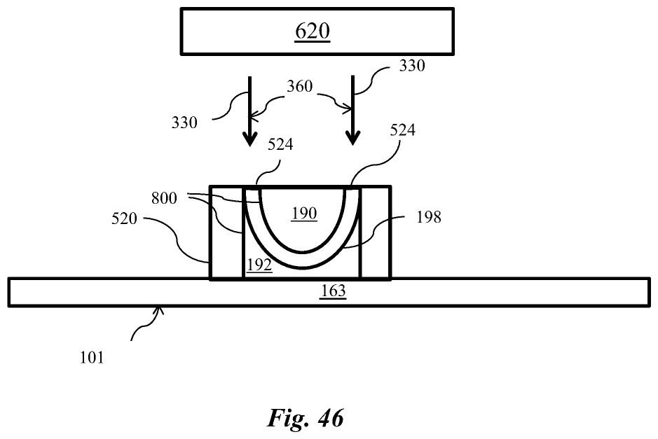

Turning to FIG. 46, the fluid deposition unit (620) is shown as depositing the supplemental build material (360) for one or more target areas (524) of each layer (522), the target areas (524) corresponding to a support surface layer (198). The support surface layer (198) can be located between the part (190) and the support structure (192). The supplemental build material (360) can include a sintering inhibitor (330). An exemplary sintering inhibitor (330) can be at least partially composed of a peroxide solution, other oxidizing agent, or other agent to inhibit sintering. The support surface layer (198) can be cured in the same manner as curing of the part (190) and/or the support structure (192). Thus, prior to sintering, the part (190) and the support structure (192) can be connected by the support surface layer (198) to ease handling. The sintering inhibitor (330) can hinder sintering of the support surface layer (198), so the part (190) is not permanently adhered to, and can be easily separated from, the support structure (192). An exemplary sintering inhibitor (330) can include hydrogen peroxide.

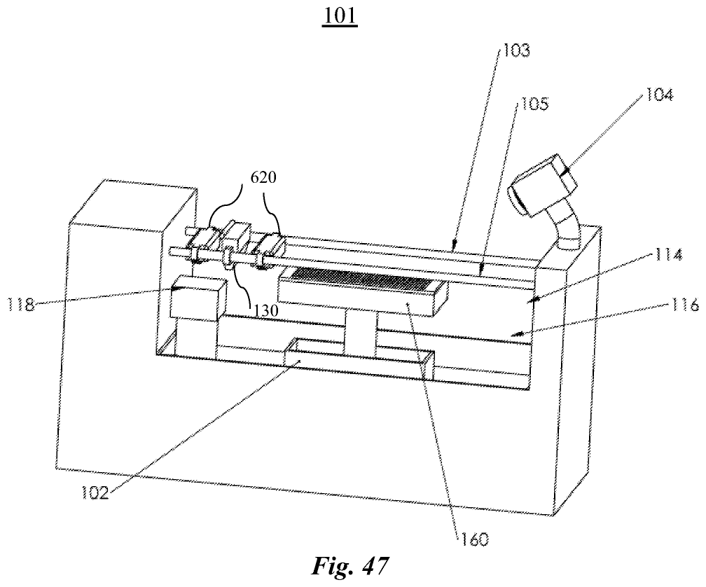

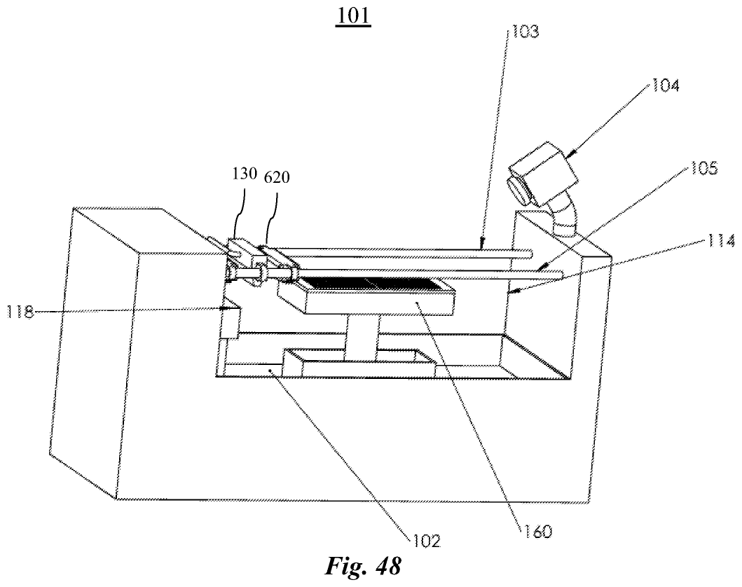

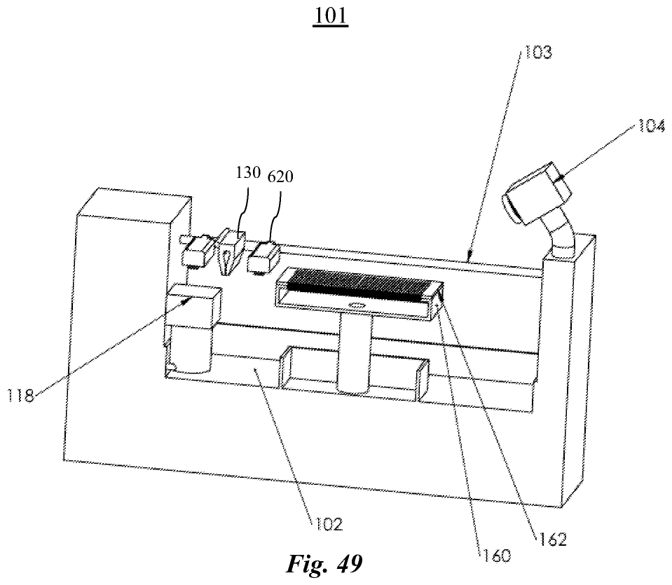

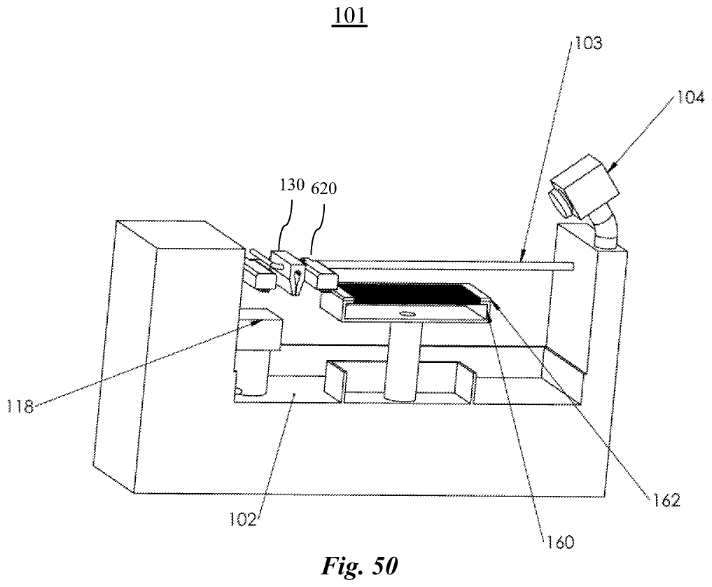

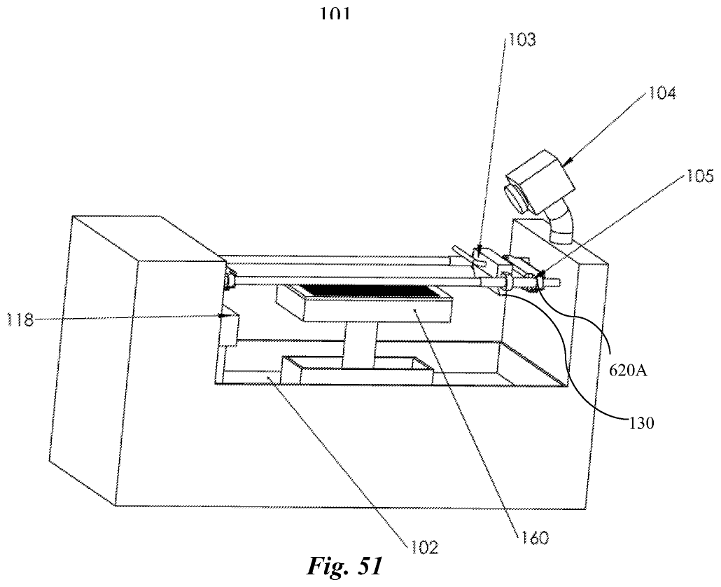

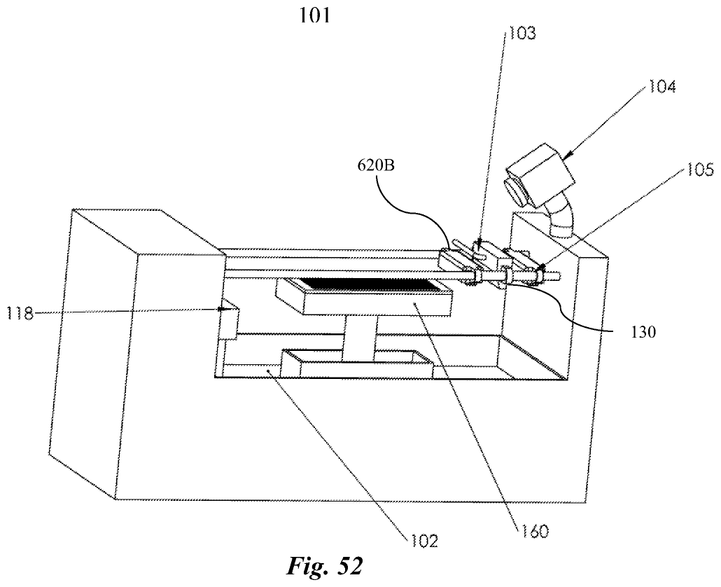

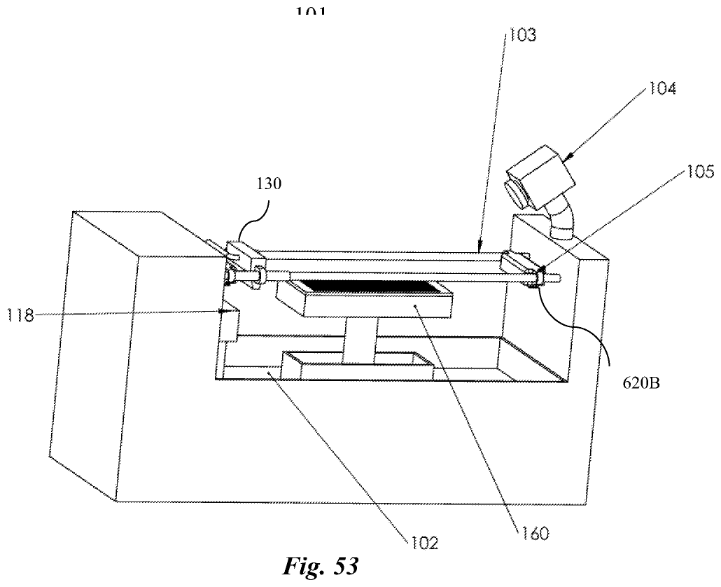

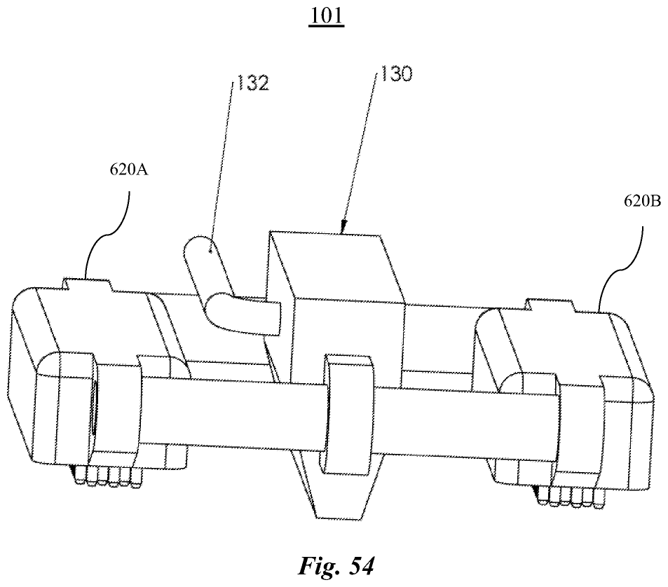

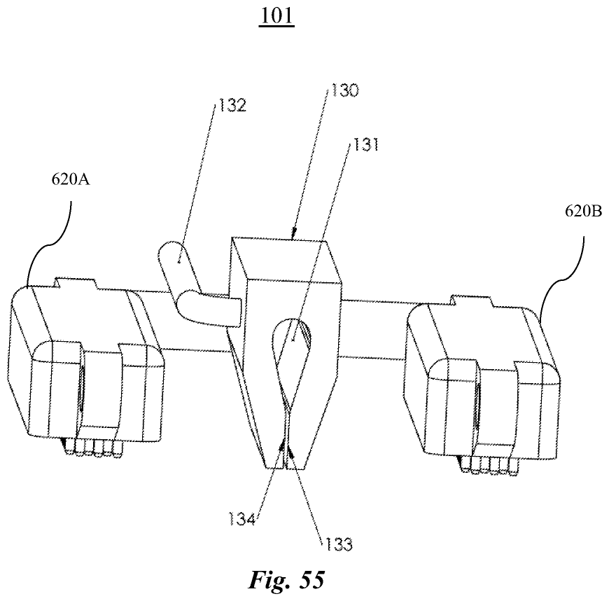

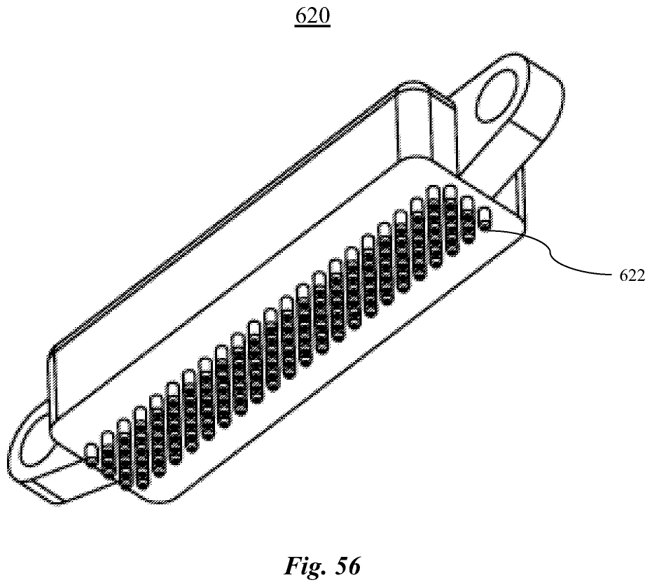

FIGS. 47-53 show detailed drawings of an exemplary system (101). FIGS. 49 and 50 are sectional views. The material deposition system (130) is shown as being positioned between two selective deposition units (620), including selective deposition units (620A), (620B). During operation, the material deposition system (130) and the selective deposition unit (620A) can scroll to the right, while the material deposition system (130) deposits one layer of the build material (520) (shown in FIG. 32). The selective deposition unit (620B) can scroll to the right while depositing the supplemental build material (360) (shown in FIG. 41). The material deposition system (130) and the selective deposition unit (620B) can scroll to the left, while the material deposition system (130) deposits a next layer of the build material (520). The selective deposition unit (620A) can scroll to the left while depositing the supplemental build material (360). The operation can repeat until all layers are deposited, with the supplemental build material (360) deposited therein as needed. Advantageously, each trip of translation can complete a layer so efficiency of SFF can improve. FIGS. 54 and 55 respectively show detailed pictorial and sectional drawings of the material deposition system (130) and the selective deposition units (620A), (620B). FIG. 56 shows a detailed drawing of the selective deposition unit (620). The selective deposition unit (620) can include an array of jetting head (or print head) (622). One skilled in the art will recognize that the material deposition system (130) and selective deposition unit(s) (620) can be moved at separate times and/or by separate motors.

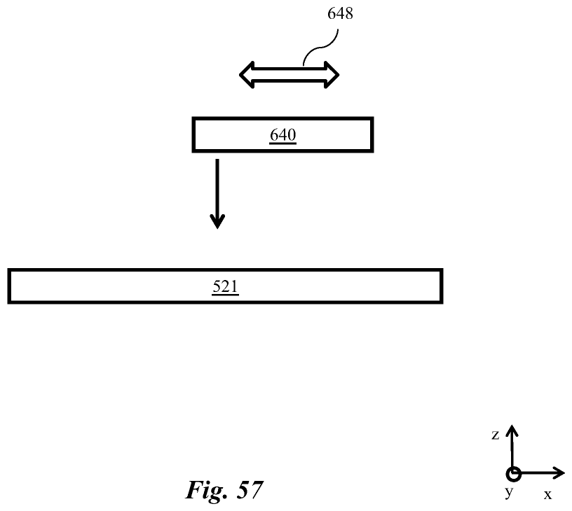

Referring back to FIG. 40, in accordance with the method (700), a state of the build material (520) can be modified via irradiation. The embodiments as illustrated in following figures show exemplary implementations of irradiation for SFF fabrication for illustrated purposes only. A person of ordinary skill in the art would understand that any other suitable types of imaging and/or irradiating systems can be implemented with the system (101) shown in figures set forth above. Exemplary types of such imaging systems can include commercial Digital Micromirror Device (DMD) imaging systems, liquid crystal display (LCD) mask, and/or the like. Irradiation may include optical illumination (and/or irradiation) of any suitable wavelength, visible or invisible, electron-beam radiation, ion-beam radiation, neutron-beam radiation, x-ray radiation, and/or other forms of radiation in which images can be formed and the irradiation suitably modify the material that is irradiated. Accordingly, although, in various embodiments, illumination is used to provide electromagnetic wave (or energy) for illustrative purposes only, any irradiation of suitable wavelength(s) can be used to provide the electromagnetic energy, without limitation. Turning to FIG. 57, an exemplary imaging unit (640) can be configured to translate above an imaging surface (521) in direction(s) (648) (or scan direction) while irradiating electromagnetic energy onto selected areas on the imaging surface (521). For illustrative purposes only, x direction can be parallel to the scan direction (648) and the y direction can be the cross-scan direction. In various embodiments, the scan direction and cross-scan direction can in any other suitable orientation relative to x and y directions. The direction (648) can include two opposite directions and/or a single direction. In various embodiments, the direction (648) can be parallel to the imaging surface (521) or the build platform working surface (162). In some embodiments, the direction (648) can be parallel to a translation direction of the build material unit (500) (shown in FIG. 30). In some embodiments, the imaging unit (640) can be at least a part of the selective processing unit (600) (shown in FIG. 30). The imaging surface (521) can include any substrate and/or material to be irradiated by the imaging unit (640). In some embodiments, the imaging surface (521) can include the active working surface (167), the build material (520) (shown in FIG. 30), a top region of the build material (520), or substantially (e.g. to a depth of 3-50 microns) of the top surface of the build material (520), or the build platform working surface (162). However, the imaging unit (640) can be implemented in any other system not limited to the system (101).

The imaging unit (640) can be moved relative to the imaging surface (521) in any suitable manner. In one embodiment, the imaging unit (640) can be within a housing (not shown) that is fixed relative to the imaging surface (521), the imaging unit (640) can be scrolled relative to the housing. In another embodiment, the imaging unit (640) can be fixed relative to the housing, and the housing can be scrolled relative to the imaging surface (521). In another embodiment, the imaging unit (640) can be moved relative to the imaging surface (521). In another embodiment, the imaging surface (521) can be moved relative to the imaging unit (640).

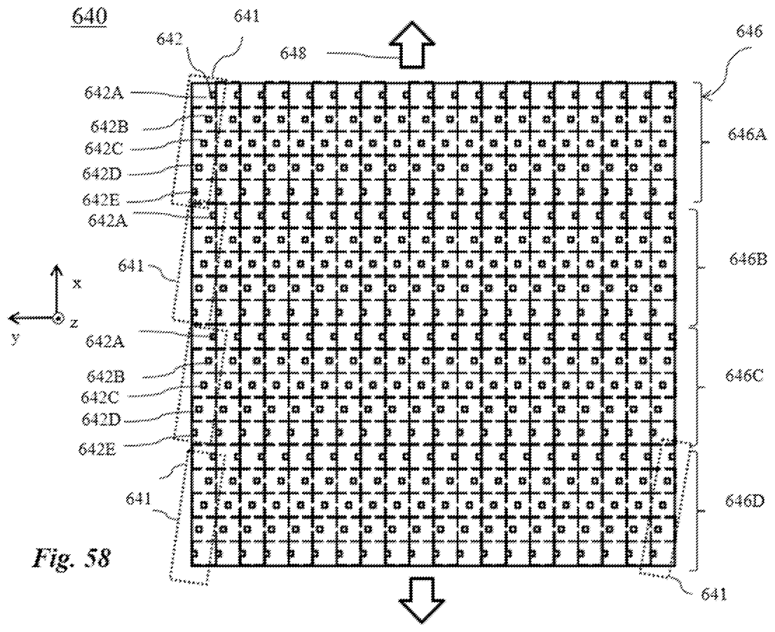

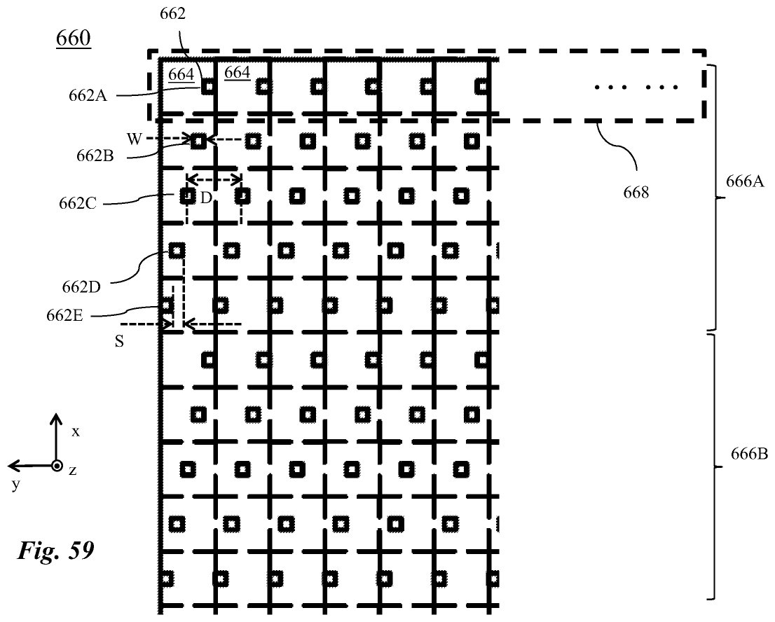

Turning to FIG. 58, a schematic diagram of the imaging unit (640) viewed against z direction is shown. The imaging unit (640) is shown as including a plurality of illumination source groups (646), shown as 646A-D. The illumination source groups (646) are shown as being distributed in x direction. In some embodiments, the illumination source groups (646) can be aligned along x direction. Each of the illumination source group (646) is shown as including an array of illumination sources (642) including, for example, illumination sources (642A)-(642E). In the example as shown, the alphabetic order of A-E can indicate the sequence of approaching the imaging surface (521). Stated somewhat differently, of a selected illumination source group (646), the illumination source (642A) can approach a given location in the x direction of the imaging surface (521) first, and the illumination source (642E) can approach said given location in the x direction of imaging surface (521) last. The array of illumination sources (642) can produce, at the imaging surface (521) (shown in FIG. 57), an array of images (662) (partially shown in FIG. 59). The array of illumination sources (642) can correspond directly to the array of images (662). Stated somewhat differently, at a given moment during operation of the imaging unit (640), each illumination source (642) that irradiates the imaging surface (521) can produce an image (662), respectively.

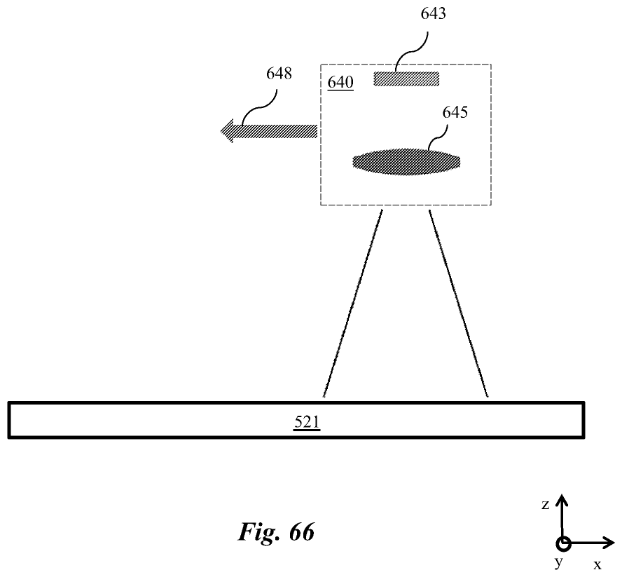

In some embodiments, the shape, dimension, and/or size of the array of illumination sources (642) and the array of images (662) can be the same. Optionally, the imaging unit (640) can include projection optics (645) (shown in FIG. 66, including optical lens(es) and/or mirrors, for example) in the illumination path to reduce and/or increase the produced images and/or distance therebetween. For example, the projection optics (645) can change the linear size of an image (662) corresponding to an illumination source (642) such that that the ratio between the linear sizes of the illumination source (642) and the corresponding image (662) can be greater or smaller than 1. Thus, although FIG. 58 shows illumination sources (642) of a selected size, spacing and shape for illustrative purposes only, the imaging unit (640) can use any other suitable arrangement and/or sizes of the illumination sources (642) and projection optics (645) for producing the array of images (662) as described in FIG. 59.

Each of the illumination source group (646) is shown as including a plurality of illumination source subsets (641) distributed along y direction. In some embodiments, the plurality of illumination source subsets (641) can be aligned along y direction. For example, specified illumination sources (642) of the selected illumination source subsets (641) (such as illumination sources (642A) of the selected illumination source subsets (641), or illumination sources (642B) of the selected illumination source subsets (641), or the like), in one illumination source group (646) can be located along a line parallel to the y direction.

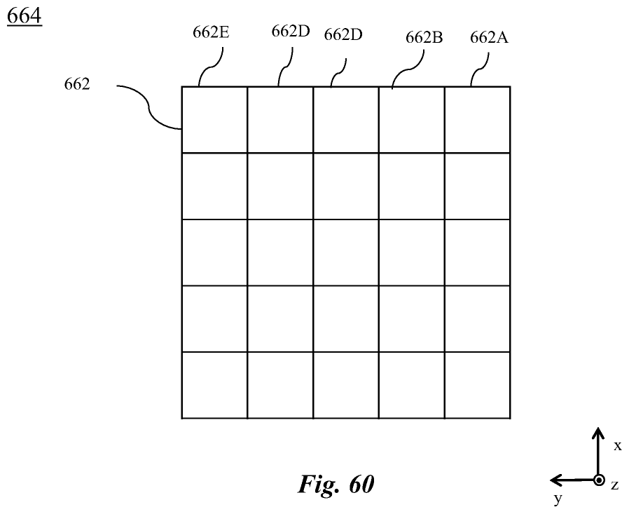

Each illumination source subset (641) includes a plurality of the illumination sources (642). For example, the illumination sources (642A)-(642E) can form one of the illumination source subsets (641). Each illumination source subset (641) is configured to, via translation of the imaging unit (640), produce the images (662) that can irradiate at least an entire pixel area (664) (for example, shown in FIG. 60). In some embodiments, the number of the illumination source subsets (641) in the illumination source groups (646) can be greater than or equal to the number of the pixel areas (664) across a width of a target area (not shown) that the imaging unit (640) irradiates, the width being measured perpendicular to the direction (648). So the target area can be imaged completely via the imaging unit (640) scrolling in one pass. In other embodiments, the number of the illumination source subsets (641) in the illumination source groups (646) can be smaller than the number of the pixel areas (664) across the width of the target area, and thus the target area can be imaged completely via the imaging unit (640) scrolling in multiple passes. In some embodiments, the illumination source groups (646) can be aligned along x direction such that a selected illumination source subset (641) from each illumination source group (646) can be located along the x direction. For example, specified illumination sources (642) of the selected illumination source subsets (641) (such as illumination sources (642A) of the selected illumination source subsets (641), or illumination sources (642B) of the selected illumination source subsets (641), or the like) from each illumination source group (646) can be located along a line parallel to the x direction.

In various embodiments, the imaging unit (640) can include a micro-light-emitting-diode (microLED) chip or array, with each illumination sources (642) including a microLED. Additionally and/or alternatively, the imaging unit (640) can include a Digital Micromirror Device (DMD) chip configured to reflect radiation from an incident light source. Additionally and/or alternatively, the imaging unit (640) can include a combination of a light source and a liquid crystal display (LCD) mask. The LCD mask can include an array of LCD lenses (or LCD apertures), with each illumination sources (642) including an LCD lens with a transparency that can be turned on and off via electronic control signals.

In some embodiments, microLED can be a preferred configuration because, when the size of the illumination sources (642) is smaller than a pitch size between adjacent illumination sources (642), microLED can limit illumination (and/or irradiation) only within the desired area of each illumination source (642). In contrast, the DMD and LCD configuration both provide illumination to areas between illumination sources (642), and that can waste some of the optical energy and unnecessarily overheating of the DMD chip or the LCD mask.

The projection optics (645) can include any suitable optical devices that alter sizes, shapes, and/or positions of incident light beam from the illumination sources (642) via any mechanism including, for example, reflection, refraction, astigmatism, and/or aberration. In some embodiments, for any selected type of illumination sources (642), the imaging unit (640) can include an array of microlenses, each microlens corresponding to a microLED, respectively, and can direct the radiation from the microLED to the imaging surface (521) or further optical devices and then the imaging surface (521), while focusing (and/or defocusing) the radiation to achieve the size of the images (662).

Turning to FIG. 59, a portion of image groups (666) produced by the illumination source groups (646) (shown in FIG. 58) are shown in in a magnified view for clarity and illustrative purposes. In the example as shown, the image groups (666A), (666B) are produced by the illumination source groups (646A), (646B) (shown in FIG. 58), respectively. The image groups (666) are shown as being distributed and aligned along x direction. The image groups (666) formed by all the illumination source group (646) can constitute a full image (660) (partially shown) after repeated exposure and relative motion in the x direction between the illumination source group (642) and the imaging surface (521).

The image group (666) can include an array of the images (662) produced by the array of illumination sources (642) (shown in FIG. 58). In this example, the images (662A)-(662E) are produced by the illumination sources (642A)-(642E) (shown in FIG. 58), respectively. The array of the images (662) is shown as including a plurality of rows (668) shown as being parallel to y direction. In a given row (668), a center-to-center distance D between two adjacent images (662) is shown as being larger than a width W of the image (662). Each of the plurality of rows (668) can be offset from an adjacent row (668) by an offset distance S greater than zero and no greater than the width W of each image (662). Thus, when the illumination sources (642) are translated in the x direction, there can be no un-illuminated gap between two images (662) having the offset therebetween (such as between images (662C), (662D), for example).

The number of the rows (668) can be selected such that the rows (668) can be sufficient to be linearly translated across a pixel area (664) (for example, shown in FIG. 60) to at least completely image the pixel area (664). Stated somewhat differently, the number of the rows (668) in the image group (666) can be equal to the number of the illumination sources (642) in an illumination source subset (641) (shown in FIG. 58). The number can be based upon the size of the image (662), the pixel area (664) and/or the offset distance S, all being in y direction. In the example as illustrated, the width W of each image (662) and the offset distance S are both ⅕ of a width of the pixel area (664). Thus, the image group (666) can include at least 5 rows (668).

In one embodiment, the spacing between adjacent rows (668) can be equal to the size of the pixel area (664) in x direction. However, the distance can be any suitable value that is greater than, or smaller than, the size of the pixel area (664) in x direction. The spacing between adjacent rows (668) in x direction can be shorter to decrease the amount of movement required for a complete image, and can decrease the size of the imaging unit (640). Larger spacing between adjacent rows (668) can increase the size of the imaging unit (640) and reduce average thermal load per unit area on the microLED chip, but can increase the amount of movement needed to complete the image. Spacing can be optimized per specific applications. By selecting timing of turning on and off the illumination sources (642), sub-pixel-length shift in the X direction can be achieved. In some embodiments, exposures do not have to be at discrete positions. The illumination sources (642) can be turned on and off while the chip moves continuously, similar to in a laser rastering system.

Turning to FIG. 60, the exemplary pixel area (664) irradiated by the illumination source subset (641) (shown in FIG. 58) via the translating movement is shown. The pixel area (664) can include a plurality of columns of the images (662), each being irradiated by the illumination sources (642A)-(642E) (shown in FIG. 58), respectively. By turning on and off the illumination sources (642A)-(642E) during translation, image resolution within the pixel area (664) can be based upon the offset distance S of the images (662).

The imaging unit (640) as set forth above in FIGS. 58-60 can be advantageous over other exposure and/or irradiation systems for at least the following reasons. An illumination source subset (641) is configured to irradiate an entire pixel area (664). Even if one of the illumination sources (642A)-(642E) is faulty (cannot emit light or cannot be turned off), corresponding illumination source(s) (642) in other illumination source group(s) (646) can be translated above pixel area (664) and provide some degree of compensation for the faulty illumination source. The example shown in FIG. 58 includes 4 illumination source groups (646) so a selected point on the imaging surface (521) (shown in FIG. 57) can be irradiated by four illumination sources (642). In the case that one illumination source cannot emit light, when it is desired to fully illuminate (and/or irradiate) the pixel area, the remaining three sources will have illuminated the pixel area to an intensity ¾ of the desired value. In the case of an illumination source that cannot be turned off, when it is desired not to illuminate a pixel area, the illumination will be ¼ of the full value. The number of redundant illumination source groups (646) can be chosen to be large enough that the effects of the faulty pixels is minimized to the point that it has no substantial detrimental effect to the exposure of the material. Such redundancy can be crucial for ensuring high yield in small scale SFF, where failure of irradiation at one location can result in a defected product. Further, even new illumination sources (642) of the imaging unit (640), such as microLEDs provided on a microLED chip, can have a certain faulty rate due to limitation of microelectronics fabrication technology, and the faulty rate increases with usage. The incorporation of the illumination source groups (646) can tolerate the faulty rate, and thus both reduce costs of illumination sources (642) by allowing imperfect sources to be used, and extend usage life of the imaging unit (640).

Although the imaging unit (640) is shown as being used for SFF for illustrative purposes only, the imaging unit (640) can be used for any suitable applications that use optical imaging. Exemplary applications can include plastics printing system (such as Stereolithography), printed circuit board (PCB) lithography, and/or any other systems that produce polymer parts using photocurable material or any other manufacturing process that uses irradiation-sensitive material(s) that need to be selectively exposed to a desired geometry.

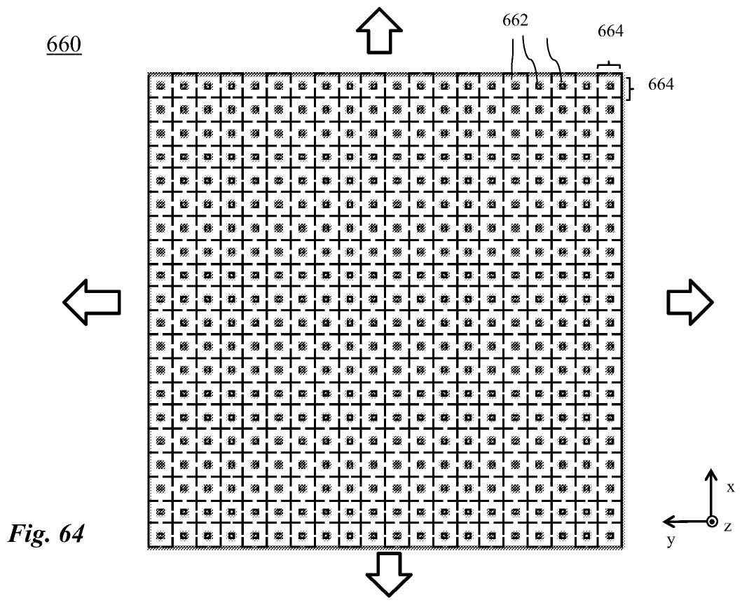

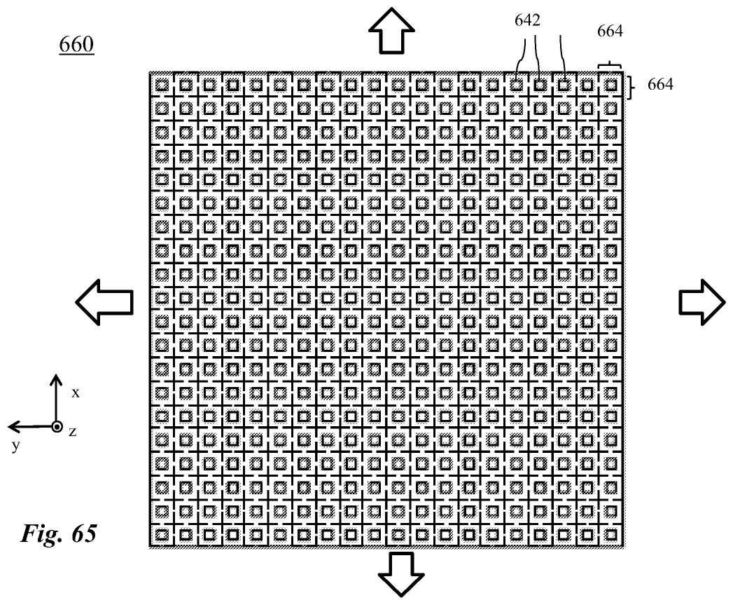

In addition, by exposing the images (662) of a small size, the imaging unit (640) can achieve a high resolution. Because only one, or some, of all images (662) is formed at one moment for each pixel area (664) at a given moment, effective pixel number for the control/drive system can be reduced, in comparison with a scenario where all the images (662) of each pixel area (664) are exposed concurrently. Stated somewhat differently, with the control/drive system of a given capability, a greater number of pixel areas (664) can be exposed, so the exposure area can be increased and productivity of SFF can be increased. Such advantages can be achieved in the imaging unit (640) even if the exposure does not require scrolling the imaging unit (640), for example, as in the examples illustrated in FIGS. 64 and 65.

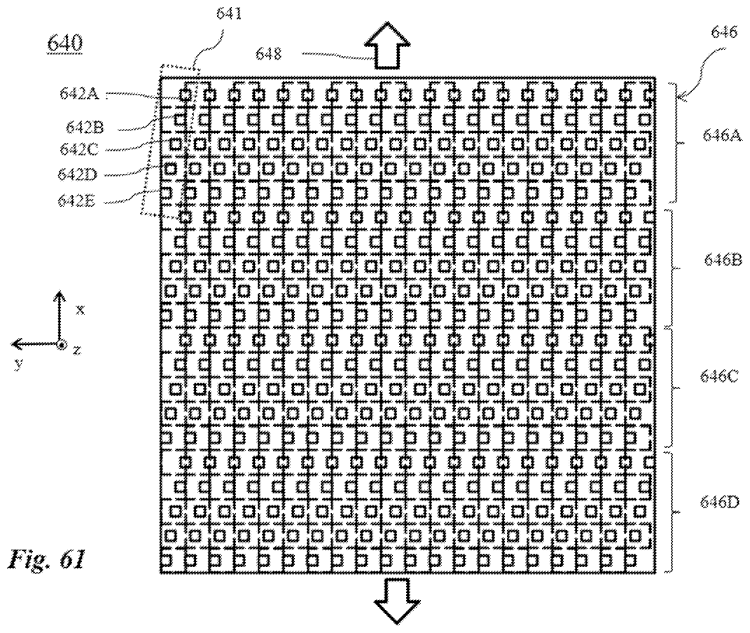

Turning to FIG. 61, another exemplary imaging unit (640) is shown. The imaging unit (640) in FIGS. 58 and 61 are similar except that size of the illumination sources (642) is greater in FIG. 61.

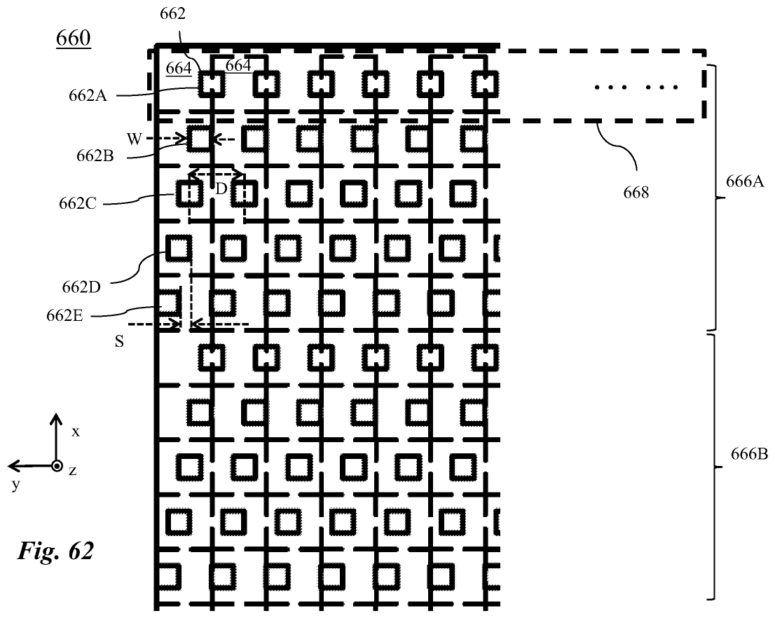

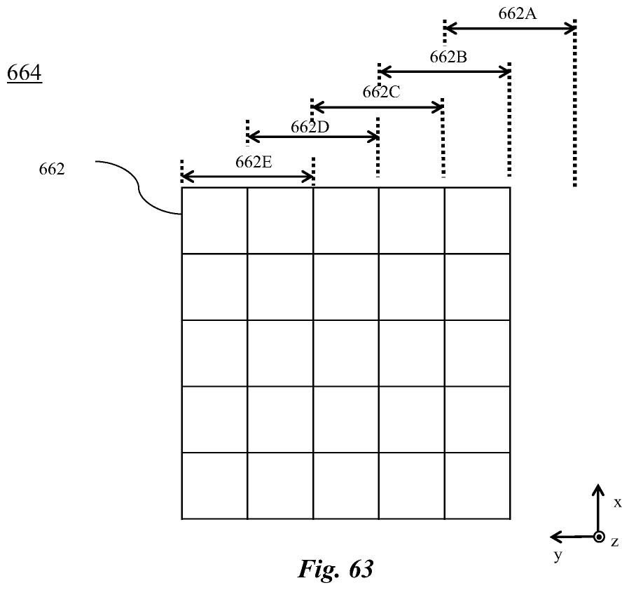

Turning to FIG. 62, a portion of the image groups (666) produced by the illumination source groups (646) (shown in FIG. 61) are shown in in a magnified view for clarity and illustrative purposes. The image groups (666) in FIGS. 59 and 62 are similar except that size of the image (662) is greater in FIG. 62. The offset distance S is shown as being smaller than the linear size (or width in y direction) of the image (662). In the example as illustrated, the width W of each image (662) is ⅖ of a width of the pixel area (664) (shown in FIG. 63) and the offset distance S is ⅕ of a width of the pixel area (664). Thus, the image group (666) can include 5 rows (668) to expose the 5 exposure positions within the pixel area (664).

Turning to FIG. 63, the exemplary pixel area (664) irradiated by the illumination source subset (641) (shown in FIG. 61) via the translating movement is shown. The pixel area (664) can include a plurality of columns of the images (662), each being irradiated by the illumination sources (642A)-(642E) (shown in FIG. 62). By turning on and off the illumination sources (642A)-(642E) during translation, image resolution within the pixel area (664) can be at least partially based upon the offset distance S (shown in FIG. 62).

Thus, the imaging unit (640) (shown in FIG. 61) can achieve a resolution that is finer than the linear size of the image (662) by introducing the offset distance S smaller than the width W of the image (662). However, a final image produced may have a gradient of optical exposure intensity at edges because the size of each image (662) is larger than the offset distance S (which can be the smallest spacing achieved). Although a sharpness of a final image can be reduced, such an imaging unit (640) can provide an advantage of increased optical power output (and thus exposure efficiency). In various embodiments, the optical power output can be increased because the areas of each image (662) and/or illumination sources (642) of FIGS. 61-63 can be greater than the areas of each image (662) and/or illumination sources (642) of FIG. 58-60. Stated somewhat differently, FIG. 61-63 can use a greater size of image (662) and utilize an offset distance S to achieve a high resolution. This increases optical power output while reducing image sharpness. Thus, depending on specific applications, the size of image (662) can be selected to achieve a trade-off between optical power output and image sharpness.

FIG. 64 shows a full image (660) produced by an alternative imaging unit (not shown), the full image (660) including an array of images (662). The image (662) can formed within a corresponding pixel area (664), and the full image (660) can be formed by shifting the image (662) in both x and y directions within the pixel area (664). The size of the image (662) is smaller than the size of the pixel area (664). So the resolution of irradiation can be based upon the size of the image (662). The shifting of the image (662) within the pixel area (664) can be achieved by projection optics (645) (shown in FIG. 66) in the illumination path including, for example, one or more rotatable refractive lenses. Additionally and/or alternatively, image shifting can be achieved by mounting the microLED array on a 2-axis motion stage (not depicted) in order to move the chip and produce a proportionate shift in the projected image.

FIG. 65 shows a full image (660) produced by another alternative imaging unit (not shown). The imaging unit as described by FIGS. 64 and 65 are similar except that size of the image (662) is greater in FIG. 65 than in FIG. 64. The image (662) can be formed within a corresponding pixel area (664), and the full image (660) can be formed by shifting the image (662) in both x and y directions within the pixel area (664) by a distance smaller than a width or length of the image (662). So the resolution of irradiation can be based upon the distance by which the image (662) is shifted. Similar to the reasons as set forth above, compared with FIG. 64, the image (660) achieved in FIG. 65 can increase optical power output while reducing image sharpness.

The imaging unit described by FIGS. 64 and 65 achieves the advantage of high resolution and greater exposure area as well. However, FIGS. 64 and 65 does not achieve the advantage of redundancy via the same motion control as described in FIGS. 58 and 61. To achieve redundancy, the imaging unit may require more motion and a greater range of motion on more axes than in the diagonal pixel system (shown in FIGS. 58 and 61). The imaging unit may use a 2-axis motion system instead of a single axis system, thus requiring the imaging unit to be bigger, more expensive, and possibly more complex to control.

Turning to FIG. 66, an exemplary implementation of the imaging unit (640) is shown. The imaging unit (640) is shown as including a chip (643) and the projection optics (645), both being static relative to each other. The chip (643) can include the illumination sources (642) incorporated thereon in an array as set forth above. An exemplary chip (643) can include a microLED chip. The chip (643) and the projection optics (645) can simultaneously translate along the direction (648) over a print area, illustrated as the imaging surface (521). The projection optics (645), shown as a single lens, may include multiple optical elements, and may include microlens array(s).

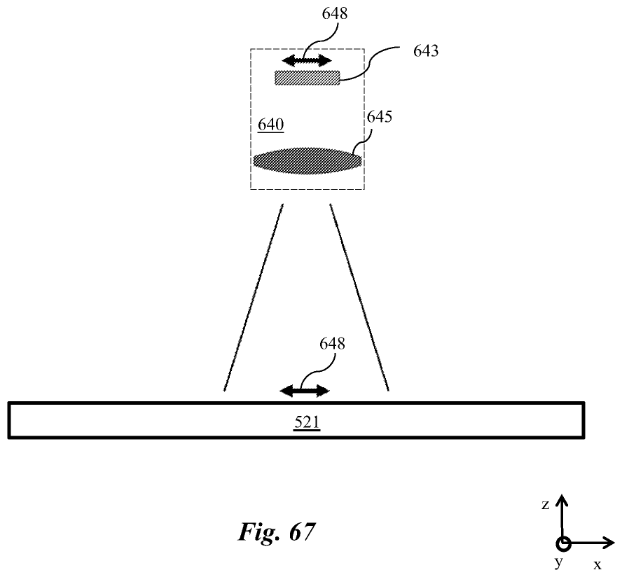

Turning to FIG. 67, an alternative exemplary implementation of the imaging unit (640) is shown. The chip (643) can be movable relative to the imaging surface (521), but other components of the imaging unit (640), such as the projection optics (645), can be static relative to the imaging surface (521). The chip (643) can translate the image by being translated back and forth within the imaging unit (640). For example, a housing of the imaging unit (640) can be static, and the chip (643) can be moved within the housing.

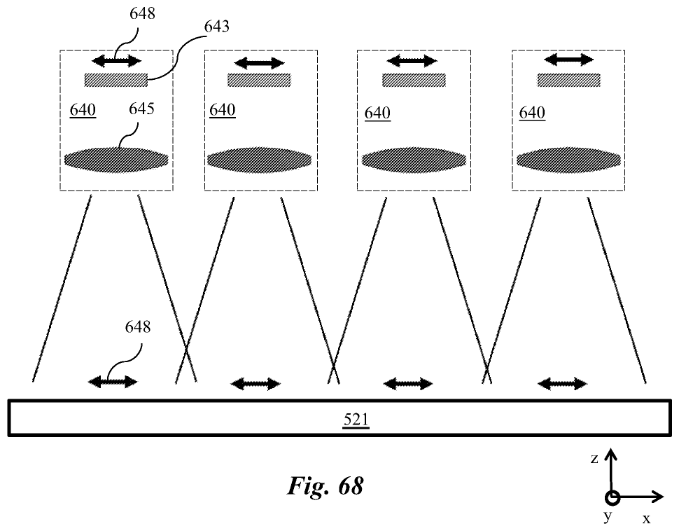

Turning to FIG. 68, an array of the imaging units (640) is shown. Each of the imaging units (640) can be similar to the example as shown in FIG. 67. The array of the imaging units (640) can cover an arbitrarily large imaging area. In many implementations, the image size can be larger than the footprint of a single imaging unit (640). Advantageously, the large imaging area can be exposed at a high efficiency.

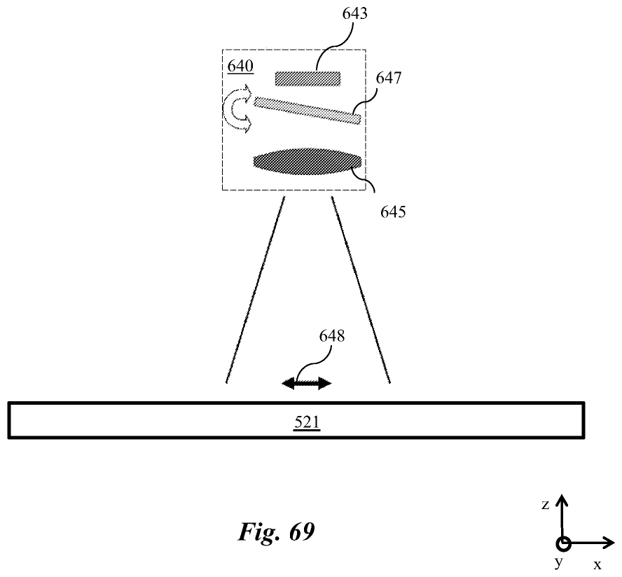

Turning to FIG. 69, another alternative exemplary implementation of the imaging unit (640) is shown. The chip (643) can be static relative to the imaging surface (521). The imaging unit (640) can include at least one refractive element (647) that can be rotated (or tilted) back and forth within the imaging unit (640). The refractive element (647) can provide a refractive window that translates the image via the rotating. Advantageously, the imaging unit (640) can achieve high precision image shifting with relatively simple and low precision mechanical controls. The refractive element (647) is shown as being located between the chip (643) and the projection optics (645). However, the refractive element (647) can be located in any suitable positions between the chip (643) and the imaging surface (521). For example, the refractive element (647) can be located between the projection optics (645) and the imaging surface (521).

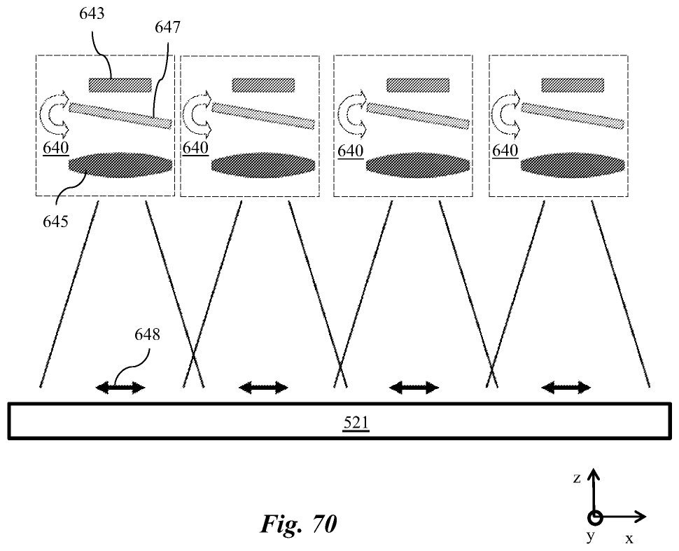

Turning to FIG. 70, an array of the imaging units (640) is shown. Each of the imaging units (640) can be similar to the example as shown in FIG. 69. The array of the imaging units (640) can cover an arbitrarily large imaging area. In many implementations, the image size can be larger than the footprint of a single imaging unit (640). Advantageously, the large imaging area can be exposed at a high efficiency.

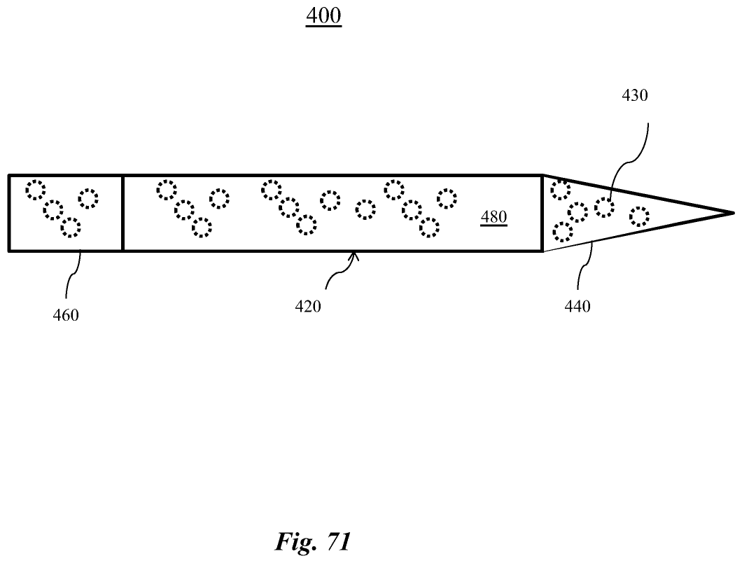

Turning to FIG. 71, an exemplary part (400) is shown. The part (400) is shown as being a needle including an elongated body (420). The needle can include any type of needle for entering skin or tissue of a biological body (for example, an animal or human). The elongated body (420) can include a tip section (440), a hub section (460), and a shaft section (480) between the tip section (440) and the hub section (460). The tip section (440) is shown as being sharp, with a cross section area smaller than a cross section area of the shaft section (480), for entering the skin. The hub section (460) can be used for attaching to a syringe barrel (and/or any other suitable devices, not shown). The syringe barrel can supply substance (not shown) to, and/or extract substance from, the biological body via the needle. The shaft section (480) can form a stem of the needle to form a distance from the tip section (440) and the hub section (460).

The tip section (440), the hub section (460), and/or the shaft section (480) can be porous. Stated somewhat differently, the tip section (440), the hub section (460), and/or the shaft section (480) can define a plurality of pores (430) therein. Conventionally, a needle has a solid external wall and defines a single straight lumen enclosed by the solid wall and passing through the entire length of the needle. In contrast, when the tip section (440) (or the hub section (460), or the shaft section (480)) defines the plurality of pores (430), the tip section (440) (or the hub section (460), or the shaft section (480)) does not necessarily define a lumen passing through the tip section (440). The pores (430) can accommodate and/or receive the substance that is transported through the needle without the need of the lumen.

In various embodiments, the pores (430) can be introduced digitally. Stated somewhat differently, the digital model of the needle can be defined with a porosity, so the part (400) made in accordance with the digital model can have the porosity. Additionally and/or alternatively, the pores (430) can be defined via adjusting the sintering cycle of the part (400) (via incomplete sintering). As set forth above, the sintering cycle may be adjusted to reduce peak temperature and soak time in order to achieve a controlled level of porosity in the final part (400). Additionally and/or alternatively, at least some of the pores (430) can be filled via any suitable methods including, for example, plating. Thus, one or more selected sections of the needle can be solid or non-porous. In one embodiment, plating only some of the pores (430) can be achieved by partial submersion of the part (400) in a plating solution.

In various embodiments, the pores (430) can have a diameter of no more than 50 microns in diameter. At 50 microns, the pores (430) do not impose significant flow restriction for most fluids. At smaller sizes (for example, under 10 microns) the pores (430) can provide the benefit of filtering out cellular media. Preferably, the diameter can have a lower limit of 100 nanometers, because even low viscosity fluid can be significantly restricted in the flow rate at that pore size.

The shaft section (480) can have a cross section of circular shape with a diameter ranging from 10 microns to 300 microns. The tip section (440) can have a length ranging from 10 microns to 250 microns, and a tip or tip edge radius no larger than 10 microns, preferably no larger than 5 microns. The needle may have a non-circular shape, in which case the maximum or minimum cross-sectional dimension may be understood to be within the constraints previously described for the diameter of a circular cross section needle. In various embodiments, the needle can be particularly useful for microneedle applications in delivery of drug or vaccine.

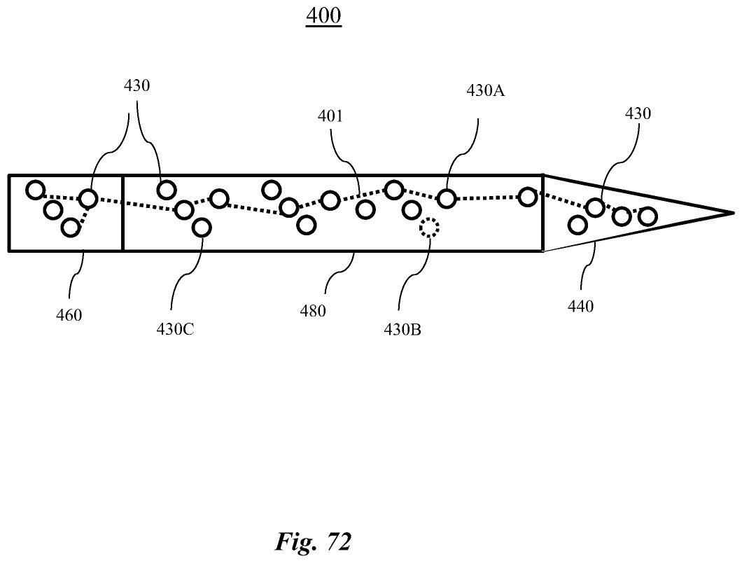

Turning to FIG. 72, the tip section (440), the hub section (460) and the shaft section (480) are shown as each defining the pores (430) therein. In one embodiment, the needle does not define the lumen passing through the entire needle. Without the lumen, the needle can be mechanically stronger. Thus, the needle can be sufficiently strong even with an increased aspect ratio (length versus diameter). Advantageously, the needle can be sharper and thinner, and can thus enter deeper in the skin and be suitable for a greater variety of medical procedures.

At least some of the pores (430) at the tip section (440), the hub section (460) and the shaft section (480) are shown as being in communication. Stated somewhat differently, one or more passages (401) can be formed among the pores (430) such that the substance (not shown) can be transported between the tip section (440) and the hub section (460) via the passages (401). The pores (430) in the shaft section (480) are shown as including the pores (430A) as a part of the passage (401).

In some embodiments, it may be desirable to isolate the substance from an external side of the shaft section (480). Thus, the pores (430) at the shaft section (480) can include one or more pores (430B) that is not open to the external side of the shaft section (480). Additionally and/or alternatively, the pores (430) at the shaft section (480) can include one or more pores (430C) that is open to the external side of the shaft section (480) but does not communicate with any of the passages (401).

Although the shaft section (480) is shown as defining the pores (430) for illustrative purposes only, the shaft section (480) can define any other structures for receiving the substance, without limitation. In one embodiment, the shaft section (480) can define the pores (430) to form the passages (401) with the pores (430) at the tip section (440) and/or the hub section (460). In another embodiment, the shaft section (480) can define one or more lumens therein.

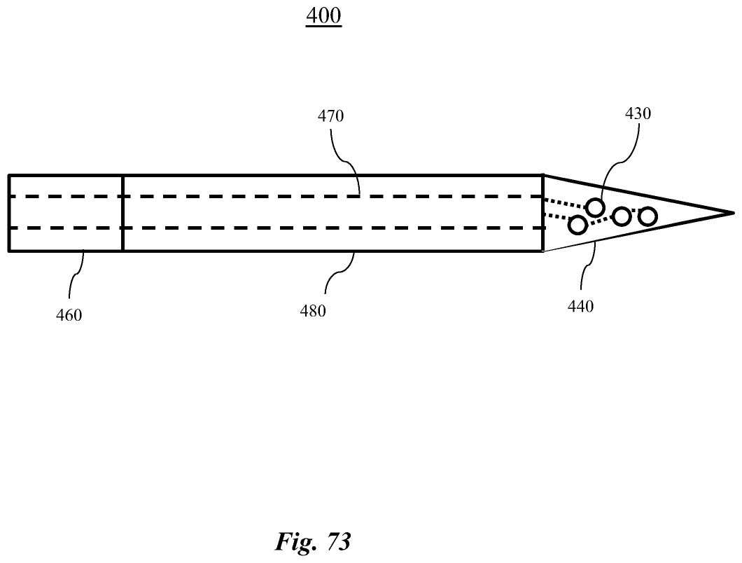

Turning to FIG. 73, the shaft section (480) and the hub section (460) are shown as defining a lumen (470) in communication with at least some of the pores (430) at the tip section (440). The lumen (470) can pass through the shaft section (480) and the hub section (460) to form a complete flow path from the pores (430) to the hub section (460). Thus, the tip section (440) does not define the lumen passing through. Without the lumen, the tip section (440) can be mechanically stronger. Thus, the tip section (440) can be sufficiently strong even with an increased aspect ratio (length versus diameter). Advantageously, the tip section (440) can be sharper and thinner, and can thus enter deeper in the skin and be suitable for a greater variety of medical procedures. Because the cross section of the needle is typically the smallest at the tip section (440), eliminating the need of the lumen at least a part of the tip section (440) can provide significant improvement even if the shaft section (480) and the hub section (460) still define the lumen (470) therein.

Although both the shaft section (480) and the hub section (460) are shown as defining the lumen (470) for illustrative purposes only, the lumen (470) can be defined within at least part of the shaft section (480), at least part of the hub section (460), and/or a part of the tip section (440), without limitation. Although both the shaft section (480) and the hub section (460) are shown as defining one lumen (470) for illustrative purposes only, one or more uniform and/or different lumens (470) can be defined in the needle, without limitation.

The needle as shown in FIG. 73 can be made by any suitable methods. In various embodiments, the pores (430) can be introduced digitally. Additionally and/or alternatively, the pores (430) can be defined via adjusting the sintering cycle of the part (400) (via incomplete sintering). At least some of the pores (430) can be filled via any suitable methods including, for example, plating. For example, the wall surrounding the lumen (470) can be made solid or non-porous via plating.

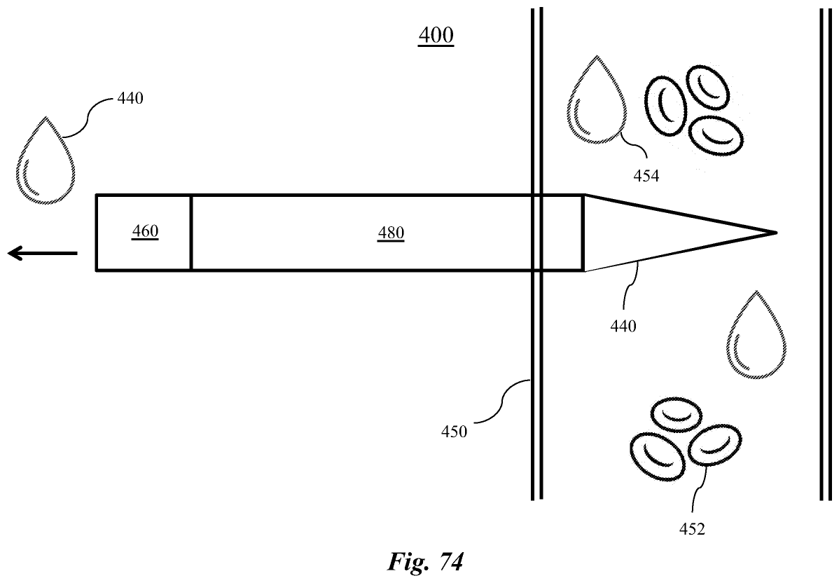

Turning to FIG. 74, another exemplary part (400) is shown. The part (400) is shown as being the needle entering a blood vessel (450) enclosing blood. The blood includes one or more solid components (452) suspended in a liquid component (454). In various embodiments, the solid component (452) can include blood cells and/or platelets. The liquid component (454) can include plasma. The tip section (440), the hub section (460) and/or the shaft section (480) can be formed with a suitable structure to filter the blood such that only the liquid component (454) exits at the hub section (460). In various medical diagnosis purposes, only the liquid component (454) needs to be sampled and the liquid component (454) has a longer shelf life than the solid component (452). Advantageously, the disclosed needle can sample the liquid component (454) in a simplified manner, extend shelf life of blood samples, and thus ease medical laboratory operations.

In various embodiments, the shaft section (480) can have a cross section of circular shape with a diameter ranging from 10 microns to 300 microns. With the diameter under 300 microns, the shaft section (480) can be smaller than a standard gage needle and approaches a size that becomes pain free. A diameter under 10 microns is not particularly useful even as a solid needle, because it gets more difficult to make a needle long enough to get past the Stratum Corneum if the diameter is under 10 microns.

The tip section (440) can have a length ranging from 10 microns to 250 microns, and a tip radius no larger than 10 microns. The needle can have a non-circular cross-sectional shape, in which case the maximum or minimum cross-sectional dimension can be ranging from 10 microns to 300 microns.

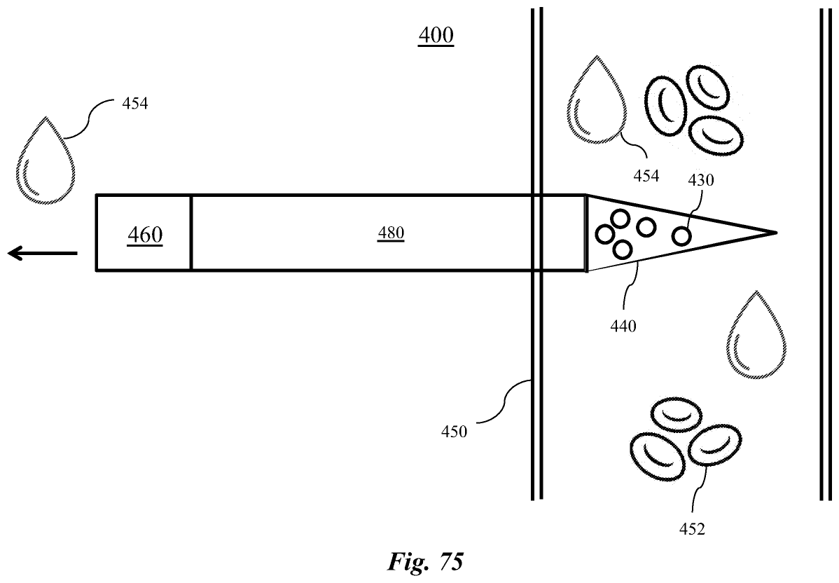

Turning to FIG. 75, the tip section (440) is shown as defining the plurality of pores (430) opening to the blood in the blood vessel (450). Each of the pores (430) can have a size that is smaller than a size of the blood cells, such that the blood cells do not enter the pores (430). The pores (430) thus can function as a filter. The pores (430) can be in communication with a suitable exit at the hub section (460) via any suitable passages, pores, lumen, and/or the like, without limitation. In various embodiments, the pores (430) can have a diameter no larger than 5 microns to function as the filter.

Although the pores (430) at the tip section (440) are shown as filtering the blood for illustrative purposes only, any part of the needle (such as the shaft section (480) and/or the hub section (460)) can be structured to filter the blood, without limitation. The disclosed needle can filter any other suitable substance from the body, without limitation. Additionally and/or alternatively, the disclosed needle can filter a substance injected from a syringe into the body. In that case, the substance can flow from the hub section (460) to the tip section (440). Thus, large or solid content can be removed, and smaller or liquid content can enter the body.

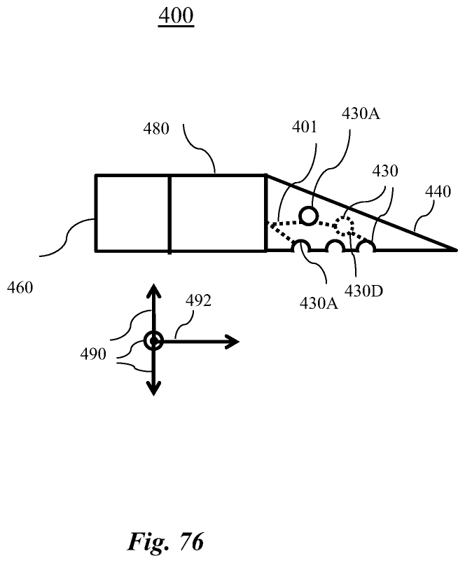

Turning to FIG. 76, the tip section (440) is shown as defining the pores (430) therein. One of more of the pores (430) can be oriented in a lateral direction (490). The lateral direction (490) can include any direction that is perpendicular to an insertion direction (492). The insertion direction (492) can be a direction of inserting the needle into the body during operation. The insertion direction (492) is shown as being parallel to the shaft section (480). A conventional needle has an aperture opening in a direction that is at least partially aligned with the insertion path of the needle. Cellular tissue and/or areolar tissue can thus clog the aperture and thus fluid cannot pass through the needle. Advantageously, the needle as set forth in FIG. 76 can define the pores (430) that are not open in the insertion path and thus clogging can be prevented. In some embodiments, the pores (430) can be in communication with a central lumen (not shown) in the tip section (440) via the passage(s) (401) in the tip section (440). In some embodiments, the passage(s) (401) can extend to a surface of the tip section (440) to form opening(s) without formation of the pores (430).

In various embodiments, the pores (430) can have a diameter of no more than 50 microns. In one embodiment, the pores (430) can have a diameter no larger than 5 microns to function as the filter. The needle can be shorter than 3 mm. The shaft section (480) can have a cross section of circular shape with a diameter ranging from 10 microns to 300 microns, and with an internal aperture or lumen (the central passageway down the axis of the shaft section (480)) smaller than 100 microns. The internal aperture less than 100 microns can allow for an overall needle size that can pass fluid readily while still being pain free. The tip section (440) can have a length ranging from 10 microns to 250 microns, and a tip radius no larger than 10 microns. The needle may have a non-circular shape, in which case the maximum or minimum cross-sectional dimension may be understood to be within the constraints previously described for the diameter of a circular cross section needle.

The pores (430) in the tip section (440) are shown as including the pores (430A) as a part of the passage (401) that can extend into the any passage and/or lumen in the shaft section (480). Thus, the pores (430) at the tip section (440) can include one or more pores (430D) that is not open to the external side of the tip section (440). In various embodiments, the shaft section (480) and/or the hub section (460) can have suitable structures as set forth in FIGS. 71-75.

Although three lateral directions 490 are shown for illustrative purposes only, the lateral direction 490 can include any direction that is in a plane perpendicular to the insertion direction 492, without limitation.

Although FIGS. 71-76 show a hub section (460), and a shaft section (480) for illustrative purposes only, the hub section (460), and/or the shaft section (480) can be optional. For example, the needle may include a hypodermic needle for reaching deeper under the skin and may need the hub section (460), and/or the shaft section (480). In another example, the needle may include a microneedle with only the tip section (440). In another example, a microneedle may taper seamlessly between sections such as a shaft and tip section, without clear delineation therebetween them.

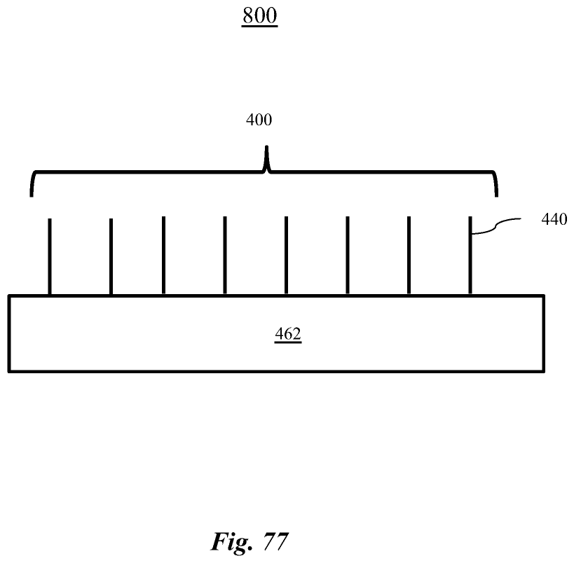

Turning to FIG. 77, the object (800) is shown as including a microneedle array. The microneedle array is shown as including a base plate (462) and a plurality of needles coupled to the base plate (462) with the tip section (440) pointing distally from the base plate (462). The base plate (462) can define a reservoir (not shown) therein that can be in communication with any pores and/or lumen in the needles. The reservoir can be used for containing fluid extracted by the needles from the body and/or fluid supplied to the needle. The needles can be any of the parts as set forth in FIGS. 71-76.

The parts 400 shown in FIGS. 71-77 can be made using the method (700) (shown in FIGS. 31, 33, 34, 40 and 43) and/or the system (101) (shown in FIG. 30). Without the method (700) or the system (101), the parts 400 are impractical or impossible to make with conventional methods or systems. Even if any of the part 400 can be possibly made by a certain conventional method or system, the cost and production time of part 400 would be too high to be manufactured in large quantities. The method (700) and/or the system (101) can advantageously make it possible to manufacture the part 400 in large quantities at low cost and high efficiency.

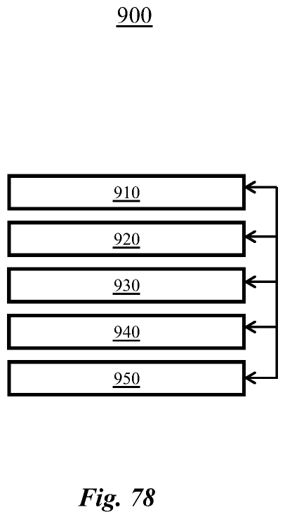

Turning to FIG. 78, a control system (900) for SFF is shown. The control system (900) can be configured for controlling the system (101) (shown in FIG. 30). The control system (900) can include a processor (910). The processor (910) can include one or more microprocessors (for example, single or multi-core processors), application-specific integrated circuits, application-specific instruction-set processors, graphics processing units, physics processing units, digital signal processing units, coprocessors, network processing units, encryption processing units, and the like.

The processor (910) can execute instructions for implementing the control system (900) and/or computerized model of the object (800) (shown in FIG. 30). In an un-limiting example, the instructions include one or more SFF software programs. Exemplary SFF software program can include G-code to control the system (101). The programs can operate to control the system (101) with multiple printing options, settings and techniques for implementing additive printing.

The programs can include a CAD and/or CAM program to generate a 3D computer model of the object (800). Additionally and/or alternatively, the 3D computer model can be imported any other conventional CAD and/or CAM programs and/or from another computer system. The 3D computer model can be solid, surface or mesh file format in an industry standard. The programs can include CAM slicing software to ‘slice’ the 3D computer model of the object (800) into layers (820) (shown in FIG. 30) and calculate a toolpath for defining each layer (820).

The programs can generate the machine code (including G-code, for example) for controlling the system (101) to print the object (800). For example, the programs can control the material deposition system (130) (shown in FIG. 1) and air blades (140,150) (shown in FIG. 1) for depositing material, the curing process via monitoring by a camera (104) (shown in FIG. 1), pump motors, build platform motion, deposition module motion, the densifying process by imaging with the camera (104), electrochemical machining process, the build material unit (500), the selective processing unit (600) and/or the imaging unit (640).

As shown in FIG. 78, the control system (900) can include one or more additional hardware components as desired. Exemplary additional hardware components include, but are not limited to, a memory (920) (alternatively referred to herein as a non-transitory computer readable medium). Exemplary memory (920) can include, for example, random access memory (RAM), static RAM, dynamic RAM, read-only memory (ROM), programmable ROM, erasable programmable ROM, electrically erasable programmable ROM, flash memory, secure digital (SD) card, and/or the like. Instructions for implementing the control system (900) and/or computerized model of the object (800) can be stored on the memory (920) to be executed by the processor (910).

Additionally and/or alternatively, the control system (900) can include a communication module (930). The communication module (930) can include any conventional hardware and software that operates to exchange data and/or instruction between the control system (900) and another computer system (not shown) using any wired and/or wireless communication methods. For example, the control system (900) can receive computer-design data corresponding to the object (800) via the communication module (930). Exemplary communication methods include, for example, radio, Wireless Fidelity (Wi-Fi), cellular, satellite, broadcasting, or a combination thereof.

Additionally and/or alternatively, the control system (900) can include a display device (940). The display device (940) can include any device that operates to present programming instructions for operating the control system (900), display the 3D computer model of the object (800), and/or present data related to the components of the system (100) and/or the system (101). Additionally and/or alternatively, the control system (900) can include one or more input/output devices (950) (for example, buttons, a keyboard, keypad, trackball), as desired.

The processor (910), the memory (920), the communication module (930), the display device (940), and/or the input/output device (950) can be configured to communicate, for example, using hardware connectors and buses and/or in a wireless manner.

Embodiments of a device for solid freeform fabrication and associated methods are herein disclosed for the production of components (e.g., plastic, metal, and ceramic parts) for a variety of applications.

In some embodiments, the SFF methods and devices disclosed herein may include a surface for receiving layers of material for production of a 3-dimensional solid representation of a digital model, a component or components for depositing the required layers of build material, and a component or components for imaging the build material into cross sections representative of data contained in a digital model. In one embodiment, the build material is composed of a particulate material and a photocurable resin material. The materials may be blended in advance of the build process, and the density of the blend may be altered during the build process to optimize the properties of the printed part.

In addition, in some embodiments, the methods and devices described below may utilize particulate material (e.g., ceramic, plastic, or metal) as one of the build materials. Parts produced from this device may be treated after the build process is complete to facilitate bonding between adjacent particles. Such treatment includes but is not limited to thermal, chemical, and pressure treatment, and combinations of these. The results of this fabrication and treatment process include but are not limited to solid metal parts, solid ceramic parts, porous metal parts, porous ceramic parts, porous plastic parts, solid composite plastic parts, and composite parts comprising one or more types of material.

Methods of production of layers of a slurry blend of powder and binder may include depositing the material via a pumping system. This deposition system can contain features to decrease the shear stress imparted to previous layers during deposition. Additionally and/or alternatively, the deposition system may contain features to increase the ability of the system to self correct for any deviations in layer flatness. Additionally and/or alternatively, the density of the deposited layer may be modified by removing a portion of the binder volume from the slurry. Additionally and/or alternatively, the slurry material may be continuously conditioned to provide for a high degree of homogeneity in the slurry material and parts produced therefrom.

Layer imaging may be achieved through several means, including but not limited to bulk imaging with a programmable light source, such as a Digital Light Processing (DLP) projector or laser imaging system.

In one aspect, a solid freeform fabrication device is provided such that objects may be produced using a photocurable resin material in accordance with digital data representative of a given three dimensional object.

In another aspect, a SFF device is provided which may produce composite objects composed of particulate material and photocurable resin material.

In another aspect, a SFF device is provided which utilizes bulk deposition techniques for production of layers of material.

In another aspect, a SFF device is provided which processes a blend of particulate material and photocurable resin material for production of composite layers of material.

In another aspect, objects produced from an SFF device may be treated thermally, chemically, or mechanically to improve internal adhesion of material components.

In another aspect, blended feedstocks may be used which are altered during the build process in order to increase particulate loading density in a printed part.

In another aspect, a feedback system may be used to validate or control an increase in particulate loading density of a deposited blended material, optionally by reading one or more brightness values from a camera that monitors the process.

In another aspect, a method is provided for determining advantageous geometries of tooling which may be used for sintering or finishing printed parts, which may in turn be produced by the same process that produced the printed parts.

Various embodiments as set forth above includes using “photopolymer resin” “photosensitive material,” “photocurable material,” “irradiation-sensitive material,” “irradiation-curable material,” and/or any other similar or related terms. Such terms can serve the same purpose in those embodiments, and can be a substance that can be modified, undergo a physical state transformation, undergo a phase transformation, and/or undergo a chemical reaction, in response to irradiation, to enable modifying of desired parts of a material in a manner as described in those embodiments. In various embodiments, the irradiation can include radiating of energy emitted and/or transmitted in the form of rays, waves (for example, electromagnetic waves), and/or particles.

The directions shown in the illustrations can be any physical direction relative to gravity. For example, the system of FIG. 30 can be oriented with the active working surface parallel to the local surface of the earth, or can be at other angles, for example, at an inclination 30 degrees from the local surface of the earth. Any use of directional words such as “up,” “down,” “above,” “below,” “over,” and “under” are understood to apply to the system with active working surface parallel to the local surface of the earth, and if the system is at other angles, these directions should be modified accordingly.

While specific combinations of systems have been depicted herein, any combination of the aforementioned subsystems may be implemented to a similar end. Any system which provides for slurry deposition, slurry densification, and irradiation, in accordance with any of the previously mentioned methods or systems, may be understood to be an embodiment of the disclosed subject matter.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1-10. (canceled)

11. A method for making a three-dimensional object, comprising:
depositing a layer of a build material on a build platform;
densifying the layer of the build material;
selectively processing the layer of the build material; and
repeating said depositing, said densifying, and said selectively processing of one or more layers of the build material stacked on the layer to form the three-dimensional object.

12. (canceled)

13. The method of claim 11, wherein the build material includes a blend of a powder material and a carrier fluid.

14. The method of claim 13, wherein said depositing includes depositing the build material via slot die coating.

15-32. (canceled)

33. The method of claim 13, wherein said selectively processing includes depositing a supplemental build material on at least one target area of the build material.

34. The method of claim 33, wherein said densifying includes densifying the build material such that the build material remains substantially wet after densification.

35. The method of claim 34, wherein said densifying includes densifying the build material such that the build material defines a plurality of voids therein and the powder material remains wet after densification.

36. The method of claim 34, wherein the supplemental build material is adapted to enable a curing reaction, solidification reaction, or a combination thereof, for binding the powder material at the target area.

37. The method of claim 36, wherein the target area is in accordance with a two-dimensional slice of a digital model of the three-dimensional object.

38. The method of claim 36, wherein the supplemental build material is adapted to enable a photocuring reaction for binding the powder material at the target area.

39. The method of claim 38, wherein said selectively processing includes irradiating the build material in a non-selective manner.

40. The method of claim 38, wherein the supplemental build material includes a photocurable resin.

41. The method of claim 38, wherein the supplemental build material and the carrier fluid collectively provide a photocurable resin including a backbone resin and a photoinitiator.

42. The method of claim 36, wherein the supplemental build material is adapted to enable a thermal curing reaction for binding the powder material at the target area.

43. The method of claim 42, wherein said selectively processing includes heating the build material in a non-selective manner.

44. The method of claim 42, wherein the supplemental build material includes a thermally curable resin.

45. The method of claim 42, wherein the supplemental build material and the carrier fluid collectively provide a thermally curable resin including a backbone resin and a thermal initiator.

46. The method of claim 36, wherein the supplemental build material is adapted to enable a passive curing reaction for binding the powder material at the target area.

47. The method of claim 46, wherein the supplemental build material includes a passively-curable resin.

48. The method of claim 46, wherein the supplemental build material and the carrier fluid collectively provide a passively-curable resin including a backbone resin and a thermal initiator.

49. The method of claim 36, wherein the supplemental build material includes a wax that is molten during deposition and solidifies upon cooling at least via heat absorption by the carrier fluid.

50. The method of claim 36, wherein the supplemental build material includes a monomer that is molten during deposition and cures upon deposition via photocuring, thermal curing, passive curing, or a combination thereof.

51. The method of claim 34, wherein the supplemental build material is adapted to inhibit a curing reaction and the carrier fluid includes a curable material.

52. The method of claim 51, wherein the target area is in accordance with a complementary image of a two-dimensional slice of a digital model of the three-dimensional object.

53. The method of claim 51, wherein the supplemental build material is adapted to inhibit a photocuring reaction, and the carrier fluid includes a photocurable material.

54. The method of claim 53, wherein said selectively processing includes irradiating the build material in a non-selective manner.

55. The method of claim 34, wherein the supplemental build material includes a sintering inhibitor and the method further includes sintering the powder material after said selectively processing.

56. The method of claim 55, wherein the target area is in accordance with a two-dimensional slice of a digital model of a support surface layer that is between the three-dimensional object and a support structure.

57-113. (canceled)
